(19) United States
(12) Patent Application Publication
(10) Pub. No.: US 2010/0299438 A1
(43) Pub. Date: Nov. 25, 2010

(54) ONLINE RESOURCE SERVER FOR ALLOWING DEVICE CONTROL AND ACCESS TO DIGITAL CONTENT TRHOUGH PLUGGABLE USER INTERFACES

(76) Inventors: Gottfried Zimmerman, Pfullingen (DE); Ishak Kang, El Cerrito, CA (US); Parikshit Thakur, Sugar Land, TX (US)

Correspondence Address: FLIESLER MEYER LLP, 650 CALIFORNIA STREET, 14TH FLOOR, SAN FRANCISCO, CA, 94108, US

(21) Appl. No.: 12/646,486

(22) Filed: Dec. 23, 2009

Related U.S. Application Data
(63) Continuation-in-part of application No. 12/357,248, filed on Jan. 21, 2009.
(60) Provisional application No. 61/140,828, filed on Dec. 24, 2008.
(60) Provisional application No. 61/022,409, filed on Jan. 21, 2008.

(51) Int. Cl. G06F 17/30; G06F 15/173

(52) U.S. Cl. 709/226; 707/769; 707/803; 707/E17.014; 707/E17.044

(57) ABSTRACT

An online Resource Server for allowing device control and access to digital content through pluggable user interfaces (PUI). In accordance with an embodiment, the system disclosed herein makes networked consumer electronics significantly easier to use for the consumer. In accordance with an embodiment, a Resource Server is provided to match an individual with a PUI that they can use as their personal interface. Also disclosed herein are algorithms and methods for providing resource query, resource retrieval, and resource matching; and an interface that can be used by a user to configure the system and resources therein.

### CLAIM OF PRIORITY

This application claims the benefit of priority to U.S. Provisional Patent Application No. 61/140,828 entitled “ONLINE RESOURCE SERVER FOR ALLOWING DEVICE CONTROL AND ACCESS TO DIGITAL CONTENT THROUGH PLUGGABLE USER INTERFACES”, filed Dec. 24, 2008; and is a continuation-in-part of U.S. patent application Ser. No. 12/357,248, titled “ONLINE RESOURCE SERVER FOR ALLOWING DEVICE CONTROL AND ACCESS TO DIGITAL CONTENT THROUGH PLUGGABLE USER INTERFACES”, filed on Jan. 21, 2009, which claims the benefit of priority to U.S. Provisional Patent Application No. 61/022,409, titled “ONLINE RESOURCE SERVER FOR ALLOWING DEVICE CONTROL AND ACCESS TO DIGITAL CONTENT THROUGH PLUGGABLE USER INTERFACES”, filed on Jan. 21, 2008; each of which applications are herein incorporated by reference.

This invention was made with government support under funding agreement number H133E030012 awarded by the Department of Education. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to remote control of devices, including entertainment devices such as music, television, multimedia, and digital content devices, and is particularly related to an online Resource Server for allowing device control and access to digital content through pluggable user interfaces.

### BACKGROUND

Users of music, television, multimedia, digital content, and other devices have become increasingly frustrated with an ecosystem that consists of too many components. In the world of entertainment, these consumers may connect devices such as DVD players, set-top boxes, amplifiers, remote controls, and television displays through a myriad of cables and wireless technologies that all need to be customized and programmed in order to function. The confusion faced by consumers is compounded when other, more critical, home systems are factored into the ecosystem, such as lighting, temperature, security and health monitoring controls. There have been some industry efforts to standardize the technical functionality of electronic equipment, for example, the development of Universal Plug and Play (UPnP). However, other technologies and specifications, such as those related to Audio/Video, are extremely verbose. As a consequence, manufacturers have generally implemented only parts of these specifications, which in turn creates functionality holes for the ecosystem. Ultimately, this makes it extremely difficult to create a user interface to operate such an ecosystem. These are some of the areas that embodiments of the present invention are designed to address.

### SUMMARY

Disclosed herein is an online Resource Server for allowing device control and access to digital content through pluggable user interfaces (PUI). In accordance with an embodiment, the system disclosed herein makes networked consumer electronics significantly easier to use for the consumer. In accordance with an embodiment, a Resource Server is provided to match an individual with a PUI that they can use as their personal interface. Also disclosed herein are algorithms and methods for providing resource query, resource retrieval, and resource matching; and an interface that can be used by a user to configure the system and resources therein.

### BRIEF DESCRIPTION OF THE FIGURES

FIG. 1 shows an illustration of a universal control hub in accordance with an embodiment.

FIG. 2 shows an illustration of an ecosystem in accordance with an embodiment.

FIG. 3 shows a method for resource retrieval in accordance with an embodiment

FIG. 4 shows a method for resource retrieval in accordance with an embodiment.

FIG. 5 shows a method for resource matching in accordance with an embodiment.

FIG. 6 shows a database structure in accordance with an embodiment.

FIGS. 7-19 show interface screens for use in accordance with an embodiment.

### DETAILED DESCRIPTION

Disclosed herein is a system and method for providing Pluggable User Interfaces (PUI), Universal Control Hubs (UCH) and an online Resource Server (RS). As described above, while there have been some industry efforts to standardize the technical functionality of electronic equipment, manufacturers have generally implemented only parts of these specifications, which in turn creates functionality holes for the ecosystem.

In accordance with an embodiment, a Resource Server is provided to match an individual with a PUI that they can use as their personal interface. Features of various embodiments of the system can also include: a system of access rights for resources; user types and their meaning; determination of mandatory and optional properties of resources; an algorithm for ranking of resources based on weights given in a resource query; registration of a PUI upon upload resulting in a unique resource name (URI); user interface socket descriptions for device classes, and extensibility of the socket descriptions through naming conventions; a universal Control Hub as a Service; an ability to allow content owners to protect their intellectual property by keeping the (protected) media over HDMI separated from the control network; an ability to track usage data and dynamically adjust the PUI without the need for user intervention; and enhanced technical support, including remote diagnostics of the consumer electronics equipment.

The PUI (also known as the “User Interface Implementation Description”) has been published by the ANSI in their 389-2005 through 393-2005 standards, and, more recently through the ISO/IEC, each of which standard specifications are herein incorporated by reference. These standards, and the UCH (a specific profile of the standards), have been promoted by the Universal Remote Console Consortium (URCC), particularly through use of its Software and Development Kit. Additional documents that describe work in this area include U.S. Pat. Nos. 6,952,836; 6,188,401; 6,990,655; 7,206,824; 6,006,332; 6,175,363; 6,658,400; and Specifications ISO/IEC 24752:2008 Universal Remote Console (5 parts); Universal Control Hub & Task-Based User Interfaces, January 2006, http://myurc.org/publications/2006-Univ-Ctrl-Hub.php; CEA-2014-A, Web-based Protocol and Framework for Remote User Interface on UPnP Networks and the Internet (Web4CE), April 2007; and IETF RFC 3986, Uniform Resource Identifier (URI): Generic Syntax, January 2005, http://www.ietf.org/rfc/rfc3986 txt; each of which are also herein incorporated by reference.

To enable an open platform for user interfaces, the standards require a market place for pluggable user interfaces and other user interface resources. In accordance with an embodiment of the present invention, systems and methods are disclosed that provide an implementation of a Resource Server that can be used with such a market place. The Resource Server in turn provides added value to all stakeholders, i.e. users, manufacturers of controlled devices, authors of pluggable user interfaces, and any third parties involved (e.g. technical support providers).

### 1. Universal Remote Console

The goal of the Universal Remote Console is that every device or service that can be accessed and controlled by any control device and user interface that fits the user's needs and preferences, using suitable input and output modalities and interaction mechanisms. In the following, the devices and services that are to be controlled are referred to as “targets”, and the control devices and their user interfaces are referred to as “universal remote consoles” (URCs).

In accordance with an embodiment, the term “Universal Remote Console (URC)” is used in two different ways: First, it is used for the control device and its user interface. Second, it denotes the overall technology and framework, as defined by the standards. In the following, we use the first meaning only, unless we explicitly invoke the broader meaning by saying “URC technology” or “URC framework”.

In order to achieve this goal of a URC controlling a target without any prior knowledge of each other, some “common understandings” need to be in place that are commonly known by the URC and target. ISO/IEC 24752-1:2008 (read: “ISO/IEC standard number 24752, part 1, published 2008”) defines the components of the URC framework and specifies these “common understandings” between them as conformance requirements for URCs and targets. These requirements for a “conforming URC” or a “conforming target” are stated in terms of high-level interaction with each other. A key part of this interaction is the sharing of control and access information through the following XML documents (as described in parts 2-5 of ISO/IEC 24752): User interface socket description, presentation template, target description, resource description.

In accordance with an embodiment, the URC framework, as defined by ISO/IEC 24752, does not pick a specific networking protocol between a URC and target. Part 1 only defines requirements for such a networking platform (called “TUN” for Target-URC-Network). The idea is that the URC related interaction could be implemented on top of existing networking platforms that support device discovery, control and eventing. However, in an existing network environment, targets and URCs have to commit to using a particular TUN implementation, in order to be interoperable with each other.

### User Interface Socket

An important requirement for a target is that it must expose its content and functions through one or multiple “user interface sockets” (or short “sockets”). A user interface socket is an abstract model of the user interface, hosting all its “ingredients” at runtime. In the URC framework, a socket consists of one or more of the following elements:

Socket variables (or short “variables”). A variable is a “socket element representing a value relevant to the target's user interface that may be varied by the target or the user”. In other words: Variables represent the dynamic “content” of a target or anything that reflects the current state of a target. Some variables can be modified by a user, some not at all, and some only under certain conditions (dependencies). The type of a variables reflects the kind of data it holds. Data types are specified based on [XML Schema Definition].

Socket commands (or short “commands”). A command is a “socket element representing a core function that a user can request a target to perform that cannot be achieved through the manipulation of the value of a single variable”. Commands represent the functions of a target that can be triggered by a user under certain conditions (dependencies). Commands may have parameters, and may have a state (telling whether an invocation is currently in progress, has succeeded or has failed).

Socket notifications (or short “notifications”). A notification is a “special state of a target in which normal operation is suspended”. Notifications are used to send a message to the user, notifying them about a change in the target's state that needs the user's attention. There are 3 categories of notifications: info, alert, and error.

Within a socket, all variables, commands and notifications have unique names. At runtime, the socket is the single place for the URC to access a target's current state, and to change that state through modification of variables, calls on commands, and acknowledgment of notifications. The URC accesses the socket elements and represents them to the user in a way that is specific to the URC. It is important to note that the socket itself does not contain any information about how to present its elements in a user interface. This is completely up to the URC. That's why we refer to the socket as an “abstract user interface”, as opposed to a “concrete user interface” that assumes specific interaction mechanisms for input and output.

The URC framework does not mandate any particular format of the socket and the data values it holds. The type of a variable, given as XSD type, is specifying its set of possible values (canonical value space), but not necessarily how these values are coded (lexical value space). The mechanism of how a URC accesses a target's socket and how the data values are coded is implementation specific and must be agreed upon between a URC and target in ways that are outside the scope of ISO/IEC 24752.

### User Interface Socket Description

In accordance with an embodiment, a target must tell a URC how its sockets look like and what their elements are, through “user interface socket descriptions” (or short “socket descriptions”). The target manufacturer is responsible to prepare socket descriptions for every socket on their target.

A socket description basically contains a list of socket variables, commands and notifications (including their names). In addition to these three element types, “socket constants” (or short “constants”) can be included to represent fixed or constant information that is known before runtime. A socket description must follow the syntax and semantics of the “socket description language”, as specified by ISO/IEC 24752-2:2008. It is a good practice to use the file extension “.uis” for socket description files. The MIME type for socket descriptions is “application/urc-uisocketdesc+xml”. As an example, the following is a simple socket description for a digital thermometer:

```
<uiSocket
  about=“http://example.com/thermometer/socket”
  id=“socket”
  xmlns=“http://myurc.org/ns/uisocketdesc”
  xmlns:uis=“http://myurc.org/ns/uisocketdesc”
  xmlns:dc=“http://purl.org/dc/elements/1.1/”
  xmlns:dcterms=“http://purl.org/dc/terms/”
  xmlns:xsd=“http://www.w3.org/2001/XMLSchema”
  xmlns:xsi=“http://www.w3.org/2001/XMLSchema-instance”
  xsi:schemaLocation=“http://myurc.org/ns/uisocketdesc
http://myurc.org/ns/uisocketdesc
    http://purl.org/dc/elements/1.1/
http://dublincore.org/schemas/xmls/qdc/2006/01/06/dc.xsd
    http://purl.org/dc/terms/
http://dublincore.org/schemas/xmls/qdc/2006/01/06/dcterms.xsd”>
  <dcterms:conformsTo>http://myurc.org/iso24752-2/2007</
  dcterms:conformsTo>
  <dc:creator>Trace R&amp;D Center</dc:creator>
  <dc:title xml:lang=“en”>User interface socket description for a digital
thermometer</dc:title>
  <dcterms:modified>2007-08-20</dcterms:modified>
  <constant id=“modelNumber” type=“xsd:double”>
    570
    <dependency>
      <relevant>false( )</relevant>
    </dependency>
  </constant>
  <variable id=“temperature” type=“xsd:double”>
    <dependency>
      <write>false( )</write>
    </dependency>
  </variable>
  <variable id=“maximum” type=“xsd:double”>
    <dependency>
      <write>false( )</write>
    </dependency>
  </variable>
  <variable id=“minimum” type=“xsd:double”>
    <dependency>
      <write>false( )</write>
    </dependency>
  </variable>
  <variable id=“scale” type=“scaleType”/>
  <command id=“reset”/>
  <notify id=“checkReset” category=“alert”>
    <dependency>
      <explicitAck> false( ) </explicitAck>
      <acknowledge>
        (uis:hasDefinedValue(‘confirmReset’) and
uis:value(‘confirmReset’) eq ‘done’)
        or (uis:hasDefinedValue(‘cancelReset’) and
uis:value(‘cancelReset’) eq ‘done’)
      </acknowledge>
    </dependency>
  </notify>
  <command id=“confirmReset” type=“uis:basicCommand”>
    <dependency>
      <relevant>uis:hasDefinedValue(‘checkReset’) and
uis:value(‘checkReset’) eq ‘active’</relevant>
      <write>uis:hasDefinedValue(‘checkReset’) and
uis:value(‘checkReset’) eq ‘active’</write>
    </dependency>
  </command>
  <command id=“cancelReset” type=“uis:basicCommand”>
    <dependency>
      <relevant>uis:hasDefinedValue(‘checkReset’) and
uis:value(‘checkReset’) eq ‘active’</relevant>
      <write>uis:hasDefinedValue(‘checkReset’) and
uis:value(‘checkReset’) eq ‘active’</write>
    </dependency>
  </command>
  <xsd:schema>
    <xsd:simpleType name=“scaleType” id=“idScaleType”>
      <xsd:restriction base=“xsd:string”>
        <xsd:enumeration value=“F”/>
        <xsd:enumeration value=“C”/>
      </xsd:restriction>
    </xsd:simpleType>
  </xsd:schema>
</uiSocket>
```

As seen in the above code, this sample socket descriptions specifies the following elements:

A constant named “modelNumber”, defining the model number of the thermometer. This constant is not intended to be presented to the user (its <relevant> dependency has the content “false()”—an XPath expression). Note that the model number is the same for all instances of thermometer, and is therefore represented as a constant rather than a variable.

A variable “temperature”, representing the current temperature as a double-precision floating point number. This variable is read-only for the user (its <write> dependency is “false()”).

A read-only variable “maximum” (same type), representing the maximum temperature.

A read-only variable “minimum” (same type), representing the minimum temperature.

A variable “scale” that assume the values “F” (for “Fahrenheit”) or “C” (for “Celsius”). Note that a set of enumerated values is assigned to this variable through the internal type definition for “scaleType” in the <schema> element at the end of the socket description. Aside from referencing internal types, variables may also reference types that are defined in external XML Schema Definition files, by using a namespace prefix for an external type name, and specifying a schema location for that namespace.

A command “reset” for resetting the maximum and minimum variables.

A notification “checkReset” of category “alert” that asks the user to confirm the execution of the reset command.

The commands “confirmReset” and “cancelReset” that let the user confirm or cancel the reset action.

In accordance with an embodiment, the socket description does not contain any strings or other information that could be used as labels for the user interface. Except for some comments and <dc:description> elements, a socket description does not contain human-readable information. Instead, a URC should get labels, help texts and other “atomic resources” from external “resource sheets”.

### Pluggable User Interfaces

Having a socket as abstract user interface, the idea is now to plug into it any concrete user interface that matches the elements in the socket. The concrete user interface would connect to one or multiple sockets in two directions: first, getting the values that reflect the current state of the target, and second, requesting changes in the target's state through variable changes and function calls. We call such a concrete user interface that connects to sockets, a “pluggable user interface” (PUI). The process of connecting a PUI's components to socket element is called “binding” or “grounding”. The URC framework imposes no constraints on PUIs in general:

PUIs can come for any platform and in any style and modality, e.g. DHTML, Java (Swing), Flash, Silverlight, VoiceXML, etc. However, in order to work with a target's socket, the PUI (or its underlying platform) needs to know how to communicate with a socket in order to retrieve values and request status modifications.

PUIs can be developed and/or provided by any party, not necessarily the maker of the target that they apply to. Thus third parties like URC manufacturers or user groups can themselves create PUIs for selected targets.

PUIs can be specific for one or multiple targets and their sockets, or generic. Specific PUIs are tailored before runtime against a specific set of target sockets (as specified in the targets' socket descriptions). Generic PUIs adapt themselves to the existing target(s) and their sockets at runtime, using the information provided by the socket descriptions.

In accordance with an embodiment, in ISO/IEC 24752-1:2008, PUIs are called “User Interface Implementation Descriptions” (or short “UIIDs”). Contrary to socket descriptions, the provision of UIIDs is optional for target manufacturers. ISO/IEC 24752-3:2008 specifies a special type of UIID, the Presentation Template (PreT), and an XML-based syntax for it. A PreT is a target-specific PUI that can bind to any number of sockets. It requires a runtime environment on the URC that can parse and interpret the PreT document, and bind it to the appropriate sockets. It is a good practice to use the file extension “.pret” for PreT files. The MIME type for PreTs is “application/urc-pret+xml”.

### User Interface Resources

As noted above, the socket and its description do not include any labels or other static components of concrete user interfaces (let's call them “atomic resources”). This is on purpose since we want to be able to easily adapt user interfaces to locales and other user preferences. Therefore we store atomic resources in external files, called “Resource Sheets”. (Actually, in some cases the resource sheet may just have a file pointer to an externally stored atomic resource). So, there can be multiple Resource Sheets for one target, each containing a different set of atomic resources for the target. For example, there may be a Resource Sheet for English labels, one for German labels, and one with graphical icons as labels.

In accordance with an embodiment, a Resource Sheet can contain a variety of atomic resources, in different modalities (text, image, video, or any other digital medium that can be stored as a file with a known MIME type). There are five pre-defined “roles” (i.e. types) for atomic resources: label; help (with categories help-purpose and help-effect); accesskey; keyword; and location.

The set of roles is extensible, i.e. you may define your own roles. However, before doing so, the consequences of introducing new roles in a resource sheet that a URC does not know should be considered—they will be useless. Unless the intention is to form a closed system, definitions of new roles should be made available to the URC community. The URC Consortium is the authority for growing the URC ecosystem, and is welcoming proposals for new roles if they are useful for a broader community, such as in the area of semantic models and descriptions for control of devices and services (“semantic tagging” of socket elements).

In accordance with an embodiment, a resource sheet must follow the syntax and semantics of the “resource sheet language”, as specified by ISO/IEC 24752-5:2008. This language is based on W3C′s Resource Description Framework (RDF) language. It is a good practice to use the file extension “.rsheet” for resource sheet files. The MIME type for resource sheets is “application/urc-ressheet+xml”. The following is an extract of a resource sheet for the digital thermometer:

```
<ResSheet
  rdf:about=“http://example.com/thermometer/rsheet.rdf”
  xmlns=“http://myurc.org/ns/res#”
  xmlns:rdf=“http://www.w3.org/1999/02/22-rdf-syntax-ns#”
  xmlns:dc=“http://purl.org/dc/elements/1.1/”
  xmlns:dcterms=“http://purl.org/dc/terms/”
  xmlns:xsi=“http://www.w3.org/2001/XMLSchema-instance”>
  <dcterms:conformsTo>http://myurc.org/iso24752-5/2007</dcterms:conformsTo>
  <dc:type>Text</dc:type>
  <dc:format>text/xml</dc:format>
  <dc:publisher>MyCorp, Inc.</dc:publisher>
  <dc:title xml:lang=“en”>Resource sheet for a digital
thermometer</dc:title>
  <dcterms:modified>2007-08-20</dcterms:modified>
  <aResDescForDomain rdf:resource=“http://example.com/thermometer/socket”/>
  <groupingForDomain rdf:resource=“http://example.com/thermometer/socket”/>
  <forLang>en</forLang>
  <!-- Description of the contained atomic resources -->
  <resItems rdf:parseType=”Collection”>
    <AResDesc
rdf:about=“http://example.com/thermometer/rsheet.rdf#temperature_label”>
      <content rdf:parseType=“Literal” xml:lang=“en”>Temperature</content>
      <useFor rdf:parseType=“Collection”>
        <Context>
          <eltRef
rdf:resource=“http://example.com/thermometer/socket#temperature”/>
          <role rdf:resource=“http://myurc.org/ns/res#label”/>
        </Context>
      </useFor>
    </AResDesc>
    <AResDesc
rdf:about=“http://example.com/thermometer/rsheet.rdf#temperature_help_hint”>
      <content rdf:parseType=“Literal” xml:lang=“en”>Current
temperature</content>
      <useFor rdf:parseType=“Collection”>
        <Context>
          <eltRef
rdf:resource=“http://example.com/thermometer/socket#temperature”/>
          <role rdf:resource=“http://myurc.org/ns/res#help-purpose”/>
        </Context>
      </useFor>
    </AResDesc>
  </resItems>
  <!-- More resource descriptions -->
</ResSheet>
```

It can be seen from the above code that a resource sheet has atomic resource descriptions (<AResDesc> elements). For each atomic resource description, there is one content (<content> element), and one or more use contexts (<Context> element). The use context describes (among other things) what socket element the atomic resource applies to (e.g. “temperature”, and what role it assumes (e.g. “label”).

In accordance with an embodiment, a resource sheet and its atomic resource descriptions each have an identifier, given via the ‘rdf:about’ attribute. This identifier must be globally unique, that means that there is no other resource in the world with the same identifier. We recommend that you make a resource sheet available for retrieval by using a resolvable URI as its identifier. Following this practice, an atomic resource description with the identifier “http://example.com/thermometer/rsheet.rdf#temperature_label” can be obtained by retrieving the resource sheet from “http://example.com/thermometer/rsheet.rdf” and then looking inside for the <AResDesc> element with the appropriate ‘rdf:about’ attribute.

The application of atomic resources are not restricted to socket elements. In fact, it is recommended to use atomic resource descriptions for pluggable user interfaces as well. Atomic resources for a PUI have precedence to atomic resources for a socket description. In practice this means that if there is a label defined for the socket element “power”, and also a label for the power button (as part of the PUI binding to the socket), the label for the power button should be used.

There is another (non-atomic) type of resource that a resource sheet can contain: grouping resources. Grouping resources define a presentation structure for socket elements. They can be used by (generic) pluggable user interfaces to build a structured user interface based on a socket description, atomic resources and grouping resources.

### Target Description

At some point, there needs to be a portal for a target to advertise its socket descriptions and resource sheets. The “Target Description” document fulfills this role, as defined in ISO/IEC 24752-4:2008. A target manufacturer must provide exactly one target description for its target device or service. It is implementation-specific how a target makes its target description available to the URCs in a network.

In accordance with an embodiment, a target description must follow the syntax and semantics of the “target description language”, as specified by ISO/IEC 24752-4:2008. It is a good practice to use the file extension “.td” for target description files. The MIME type for resource sheets is “application/urc-targetdesc+xml”. Basically, a target description provides pointers to a target's socket descriptions, and accompanying resource sheets. It may also contain pointers to external sources of resources, such as resource services. However, pointers to resource sheets and other resources are merely recommendations provided by the target manufacturer. AURC is free to look for supplemental resources at any other place it might know of, including resources that are built into the URC. The following is a simple target description for the digital thermometer [ISO/IEC 24752-4:2008]:

```
<target
  about=“http://example.com/thermometer”
  id=“target”
  hidden=“false”
  xmlns=“http://myurc.org/ns/targetdesc”
  xmlns:ext=“http://example.com/ext”
  xmlns:dc=“http://purl.org/dc/elements/1.1/”
  xmlns:dcterms=“http://purl.org/dc/terms/”
  xmlns:xsi=“http://www.w3.org/2001/XMLSchema-instance”
  xsi:schemaLocation=“http://myurc.org/ns/targetdeschttp://myurc.org/ns/targetdesc
    http://purl.org/dc/elements/1.1/http://dublincore.org/schemas/xmls/qdc/
2006/01/06/dc.xsd
    http://purl.org/dc/terms/http://dublincore.org/schemas/xmls/qdc/2006/01/
06/dcterms.xsd”>
  <dcterms:conformsTo>http://myurc.org/iso24752-4/2007</dcterms:conformsTo>
  <dc:creator>Trace R&amp;D Center</dc:creator>
  <dc:title xml:lang=“en”>Target description for a
digitalthermometer</dc:title>
  <dcterms:modified>2006-04-10</dcterms:modified>
  <locator type=“audio” id=“audio-locator”/>
  <locator type=“visual” id=“visual-locator”/>
  <locator type=“other” id=“irPing”>
    <extension>
      <!-- The content of <extension> is not specified by this standard-->
      <ext:IRPing type=“ext:basicIR”/>
    </extension>
  </locator>
  <socket id=“socket” name=“http://example.com/thermometer/socket”>
    <socketDescriptionLocalAt>socket/socketdescription.xml</socketDescriptionLocalAt>
    <categorytaxonomyName=“http://www.unspsc.org”>41.11.22.00</category>
  </socket>
  <rdf:RDF xmlns:rdf=“http://www.w3.org/1999/02/22-rdf-syntax-
ns#”xmlns:res=“http://myurc.org/ns/res#”>
    <!--Description of the root resource directory-->
    <res:ResDir>
      <res:dirItems rdf:parseType=“Collection”>
        <!-- Reference to resource sheet with English text labels for
socket.-->
        <res:ResSheetrdf:about=“http://example.com/thermometer/rsheet-
en.rdf”>
          <res:forLang>en</res:forLang>
          <dcterms:conformsTo>http://myurc.org/iso24752-
5/2007</dcterms:conformsTo>
          <res:localAt>rsheet-en.rdf</res:localAt>
          <dc:type>Text</dc:type>
          <res:aResDescForDomainrdf:resource=“http://example.com/thermometer/
socket”/>
          <res:groupingForDomainrdf:resource=“http://example.com/thermometer/
socket”/>
        </res:ResSheet>
        <!-- Description of a UIID that is a presentation template for
the digital thermometer. -->
        <res:UiidDesc
rdf:about=“http://example.com/thermometer/pret.xml”>
          <dcterms:conformsTo>http://myurc.org/iso24752-
5/2007</dcterms:conformsTo>
          <res:forSocket
rdf:resource=“http://example.com/thermometer/socket”/>
          <res:localAt>pret.xml</res:localAt>
          <dc:publisher>MyCorp, Inc.</dc:publisher>
        </res:UiidDesc>
        <!-- Description of a resource service that provides text labels
for the thermometer's socket. -->
        <res:ResSvcDesc rdf:about=“http://myurc.org/resservice.wsdl”>
          <res:forLang>en</res:forLang>
          <res:aResDescForDomain
rdf:resource=“http://example.com/thermometer/socket”/>
          <dc:type>Text</dc:type>
          <res:role rdf:resource=“http://myurc.org/ns/res#label”/>
        </res:ResSvcDesc>
        <!-- Reference to another resource directory with references to
resource sheets that contains labels, help texts,
          access keys, and keywords for the socket in different
languages. Also it contains a grouping for the socket. -->
        <res:ResDir>
          <res:forLang/>
          <res:localAt>resdir-misc.rdf</res:localAt>
          <res:aResDescForDomain
rdf:resource=“http://example.com/thermometer/socket”/>
          <res:groupingForDomain
rdf:resource=“http://example.com/thermometer/socket”/>
        </res:ResDir>
      </res:dirItems>
    </res:ResDir>
  </rdf:RDF>
</target>
```

As shown in the above example, the ‘about’ attribute on <target> gives the target a globally unique identifier. It is good practice to make a web page available for the target under the target's identifier. The <locator> elements identify locators of the target, physical functions that can help a user find and identify a target (like beeping or flashing). This may be important for targets located in public environments (e.g. elevator). The <socket> element identifies a socket on the target, and points to the pertaining socket description. The <res:ResDir> element contains the “resource directory”, a (possibly nested) list of pointers to resource sheets, UIIDs, and external resource services.

### Universal Control Hub

Today, there is a growing number of networked devices and services at home, at work, in schools and in public places. However, these devices and services are using different networking platforms and technologies, including UPnP/DLNA, CHAIN, OSGi, Web-based protocols such as UDDI, WSDL and SOAP, and many proprietary technologies. There seems to be no chance to get all manufacturers of these devices and services together to agree first to adopt the URC standards, and second to use a specific Target-URC Networking protocol for communication between URCs and targets. Instead, a different solution must be sought that can harvest the benefits of the URC standards, and works with existing devices and services available on the market. In accordance with an embodiment, a universal control hub can help address these topics.

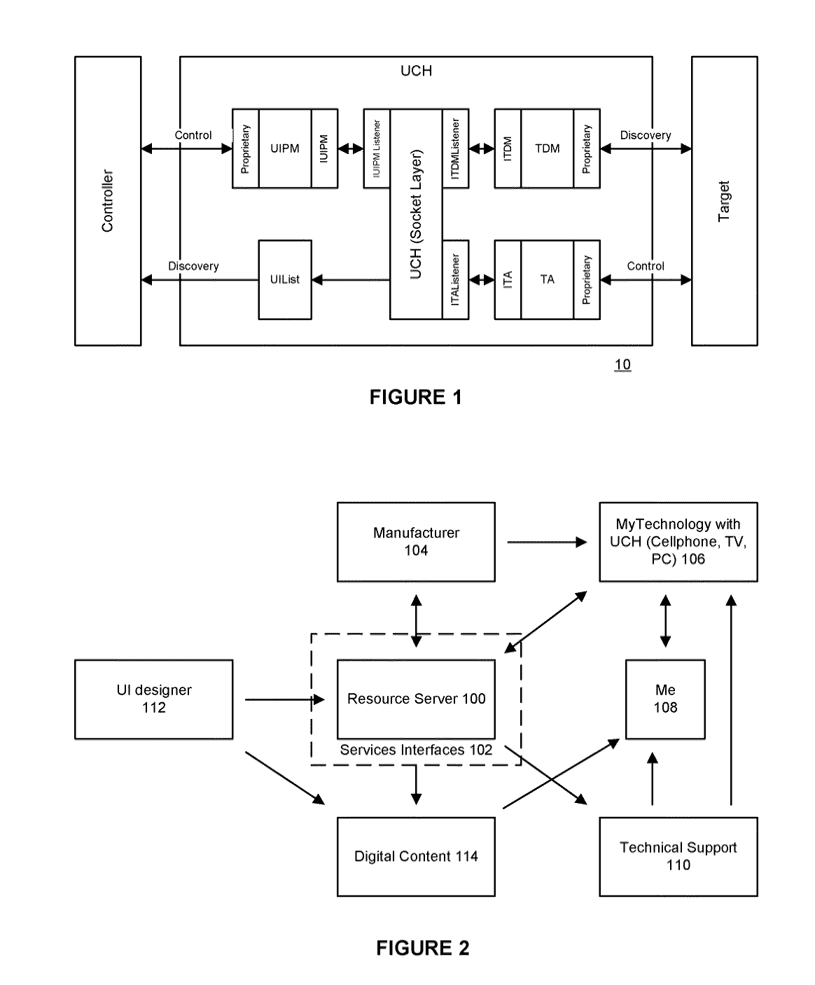

FIG. 1 shows an illustration of a universal control hub 10 in accordance with an embodiment. The Universal Control Hub (UCH) is a profiling of the URC standards that implements standard-conforming targets and URCs “in a box”, and providing connection points to existing targets and controllers that are not URC-compatible. In accordance with an embodiment, the UCH is a middleware that establishes a control connection between non-compliant controller and non-compliant target devices/services that would otherwise not understand each other. The UCH is designed to be extremely extensible and scalable with regard to diverse targets and controllers. By using the mechanisms as defined in ISO/IEC 24752, it provides an open platform for pluggable user interfaces that are based upon user interface sockets.

In accordance with an embodiment, in the UCH architecture, any network-enabled device/software can be used as “controller”. Also, the “Target” is a network-enabled device or service that can be remotely controlled via any networking platform. Note that this is different from a “conforming target”, as defined by ISO/IEC 24752-1:2008. The “conforming UCH” and “conforming” targets are virtually folded into the UCH and its components.

In accordance with an embodiment, the UCH discovers a target through a Target Discovery Manager (TDM), and controls it and receives events from it through a Target Adapter (TA). To a controller, the UCH makes itself discoverable through the UIList, an extended UPnP RemoteUI mechanism. The UCH communicates with a controller for the purpose of target control through a User Interface Protocol Module (UIPM). By connecting to controllers and targets through these device and network-specific adapters, the UCH talks to them in their native language. Acting as a middleware, the UCH then translates the communication with targets and controllers into the “URC language”, exposing the targets and their functions as sockets that the controllers can access. Thus the UCH bridges between non-conforming controllers and non-conforming targets, fulfilling the URC requirements on behalf of them. Since the whole URC system is now contained in a box, the TUN (Target-URC Network) is also contained in the box, degraded as function calls between the socket layer and a TDM/TA. The messages of this TUN are described as a set of two APIs.

There are many middleware products existing that bridge between controllers and targets in a similar way. What is unique for the UCH is that it uses a standard approach for the translation between targets and controllers, thus opening a way for third parties to make their pluggable user interfaces and accompanying resources available to the UCH after installation. The UCH constitutes an open platform for control interfaces that uses the mechanisms defined in the URC framework to allow for pluggable user interfaces and supplemental resources dynamically at runtime.

Moreover, the UCH architecture is designed to be extensible for new targets and controllers. Except for the core UCH (socket layer), its components (blue boxes: UIPMs, TDMs and TAs) are embedded into the UCH through well-defined APIs (red vertical boxes attached to the components). Any party can develop such components, and a UCH can load them at runtime. This mechanism is extremely powerful in conjunction with a resource server (see below). Then new targets and new controllers can be integrated into a local UCH system on the fly, by downloading the appropriate components from the resource server.

### URC-HTTP Protocol

In the UCH architecture, a UIPM is responsible for presenting one or multiple sockets to the user through a user interface that is rendered on a controller. In some cases, controllers and their software themselves might have knowledge about the URC technology, in particular about sockets and their resources. (These controllers are “conformant URCs”, as defined by ISO/IEC 24752-1:2008.) They might want to get direct access to a target's socket and pertaining atomic resources, in order to build a suitable user interface based on the socket elements and their values.

In accordance with an embodiment, the URC-HTTP protocol facilitates direct access for a controller to the sockets running in a UCH. This protocol defines HTTP-based messaging for a controller accessing the sockets on a UCH and its functions. An optional TCP/IP-based update channel is also defined.

Aside from being used as a user interface protocol in the UCH context, any “conforming target” (in the meaning of ISO/IEC 24752-1:2008) may employ the URC-HTTP protocol as a TUN (Target-URC Network). Any URC with URC-HTTP support would then be able to control it. This is a special case of the UCH architecture, in which the UCH and the target are merged into one unit, and only one UIPM is implemented (for the URC-HTTP protocol). This may be of particular interest to target manufacturers that want to make their products compliant to ISO/IEC 24752-1:2008 by incorporating an existing UCH implementation into their targets.

The URC-HTTP protocol is designed to be usable by clients running in Web browsers, such as scripts and plugins. For example, with the Webclient JavaScript Library, controller interfaces for specific targets can be easily written in DHTML.

### Resource Server

So far, the URC technology has been described as a framework that enables pluggable user interfaces and supplemental UI resources in a local network. The real power of the URC technology comes about when pluggable user interfaces, resources and UCH components are shared among users through a marketplace, and a system for executing such a marketplace, referred to herein as a “resource server”.

FIG. 2 shows an illustration of an ecosystem in accordance with an embodiment of the invention. In accordance with an embodiment, the user interface resources in the ecosystem can be contributed by the manufacturer of the controlled devices, by the manufacturer of the controllers, by the user, or by any third party. Traditional methods have been fragmented and device-specific. The proposed system recognizes that people (users, customers, etc.) should not have to focus on how their devices are configured, or which buttons on which device to press; but rather should be allowed to focus on what task they intend to accomplish. Traditionally, the user could hire a professional expert to sell, install, and program their equipment, but it is prohibitively expensive for most people to do this.

In accordance with an embodiment, the Resource Server is configured to match an individual with a PUI that they can use as their personal interface. This can be accomplished by using a combination of one or more of the following features, which are also described in further detail below:

1. A system of access rights for resources: read, write, query and retrieval flags for owners, groups, others.
2. User types and their meaning: query restricted, user restricted, group restricted, not restricted, admin.
3. Determination of mandatory and optional properties of resources based on MIME type (or some equivalent resource property specifying its type).
4. An algorithm for ranking of resources based on weights given in a resource query.
5. Registration of a PUI upon upload resulting in a unique resource name (URI), for example as a Digital Object Identifier (DOI) type URI. Alternatively, the provider of a pluggable user interface may assign any resource URI as a global identifier for the PUI.
6. User interface socket descriptions for device classes, and extensibility of the socket descriptions through naming conventions.
7. The ability to provide the Universal Control Hub as a Service.
8. The ability to allow content owners to protect their intellectual property by keeping the (protected) media over HDMI separated from the control network, as a method to blend Digital Rights Management (DRM) with control interoperability.
9. The Resource Server tracks usage data and can dynamically adjust the PUI without the need for user intervention.
10. Technical support (including remote diagnostics) of the consumer electronics equipment can be facilitated by usage parameters known by the UCH, such as the user interface socket name (URI), the names (URI) of involved PUIs and other resources, and the names (URIs) of the target devices connected to the UCH.

As shown in FIG. 2, in accordance with an embodiment, the Resource Server 100 can be implemented on one or more general purpose or specialized digital computers or microprocessors. The Resource Server provides one or more interfaces 102 by which a variety of entities can communicate with the resource server. A Manufacturer 104 can embed URC technology either in a controller device (for example, into their cell phone or mobile device, their television, or large display), or in any other device 106 connected to the home network (for example, a set-top box or a networked attached storage device) of an end User 108. Device manufacturers are interested in building brand loyalty and a positive customer experience. In accordance with an embodiment, using the Resource Server, the system can report real-time usage statistics to the manufacturers or other parties in the value chain. For example, if the user is experiencing difficulty with their URC-enabled product, then diagnostic data can be captured by the Resource Server with the user's permission. With this collected data, service providers 110 can assist the customer in resolving the problem in real-time. A payment model can also be employed that allows the transaction to take place without the need for a previously established customer relationship between user and service providers. User Interface Designers 112 can also provide digital content 114 to an end User via the Resource Server.

In accordance with an embodiment, resource query and resource retrieval processes can be implemented to comply with the specification of a Resource Server HTTP Interface, such as that described below. The resource delivery process can be divided into two phases: a first or resource query phase, and a second or resource retrieval phase. The resource query phase provides for discovery of resources that fit a client's description, while the resource retrieval phase provides for fetching the resource from the Resource Server.

### Resource Query Algorithm and Method

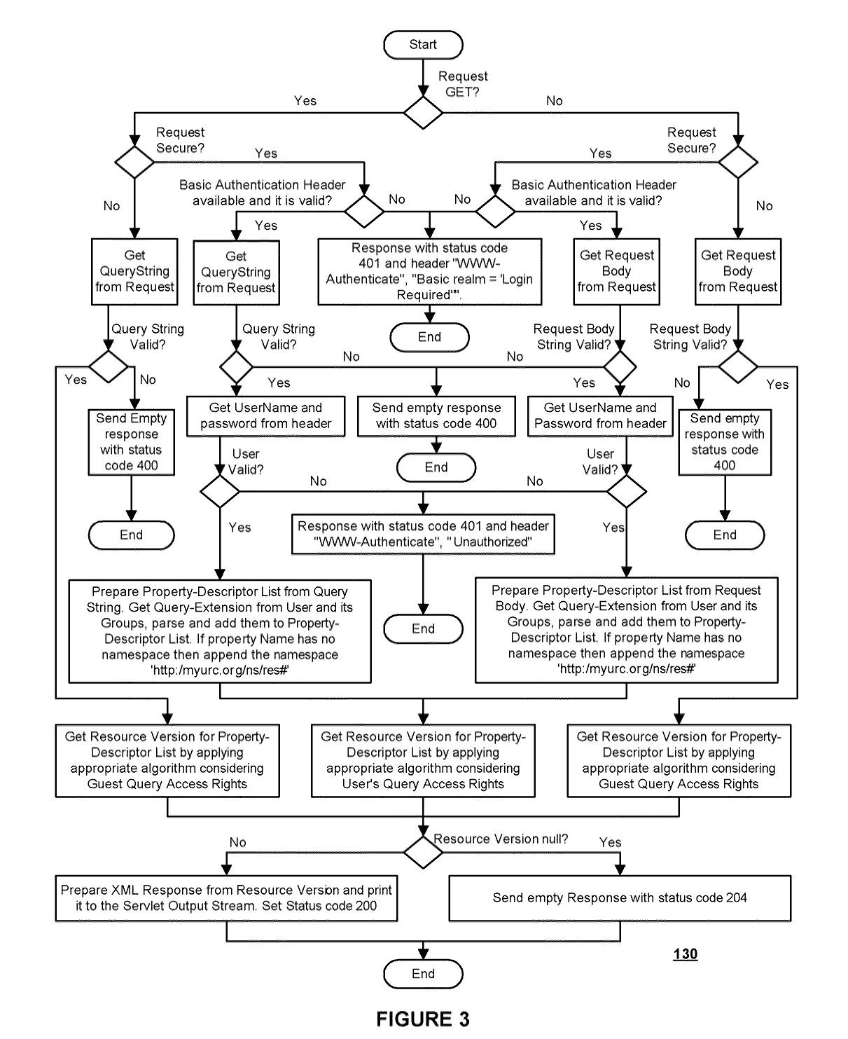

FIG. 3 shows an algorithm 130 and method for resource retrieval in accordance with an embodiment. As shown in FIG. 3, the “Get Resource Version for Property-Descriptor List by applying appropriate algorithm” blocks refer to the algorithm and method described in further detailed below under “Resource Matching Algorithm and Method”. In accordance with an embodiment, the process first determines if a request is a request GET, whether the request is secure, and if so whether the basic authentication header is available and valid. If the header is not available or valid, the system responds with a status code 401 or similar status code, and the process ends. If the header is available and valid, the query string or request body as appropriate is retrieved from the request. If the request is secure the username and password can be retrieved from the header. If the user is valid, the system prepares a property-descriptor list from the query string or request body as appropriate. The system then gets resource versions for the property descriptor list by applying an appropriate algorithm considering the user's query access rights. The system can then prepare an XML response from the resource version and print or provide it to the servlet output stream.

### Resource Retrieval Algorithm and Method

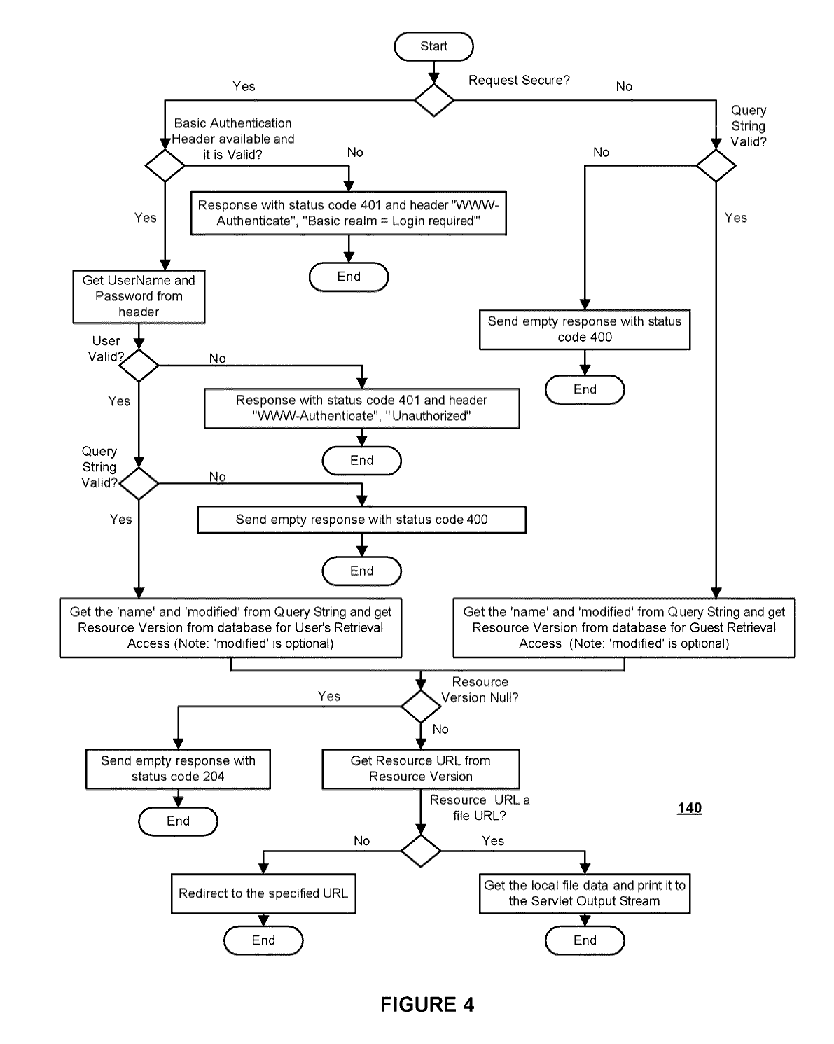

FIG. 4 shows an algorithm 140 and method for resource retrieval in accordance with an embodiment. As shown in FIG. 4, in accordance with an embodiment, the process first determines if a request is secure, and if so whether the basic authentication header is available and valid. If the header is not available or valid the system responds with a status code 401 or similar status code, and the process ends. If the header is available and valid, the query string is retrieved from the request. The username and password can be retrieved from the header. If the user is valid, the system then determines whether the query string is valid, and if so gets the name and modified attributes from the query string to retrieve the resource version from the database for the user's retrieval access. A resource URL is determined from the resource version. If the resource URL is a file URL the request can be redirected either to a specified URL, or used to get the local file data and print or provide it to the servlet output stream.

### Resource Matching Algorithm and Method

Resource matching is a core activity of the Resource Server (similar to the manner in which keyword matching is a core activity for some search engines). The user of the Resource Server needs to be sure that the Resource Server delivers the most appropriate resource for their query. In accordance with an embodiment, weighting and/or weights can be used to determine an appropriate resource. However, although weighting can provide sophisticated matching, in many instances the clients (i.e. the originators of the resource requests) are not able to specify the exact weights in their queries to yield optimal results. To address this, in accordance an embodiment, instead of using weights the Resource Server handles resource queries and their properties via algorithms and methods that are specific to the type of the requested resource. In accordance with an embodiment, resource matching can be implemented to comply with a specification of the Resource Property Vocabulary, such as that provided below. In accordance with this vocabulary, the type of a resource is denoted by the property http://myurc.org/ns/res#type, which is a “hard property”, (i.e. a matching resource must have exactly the requested value for this property). Other properties may be “soft” properties, (i.e. a resource may be chosen as the best match even though a soft property does not match). In accordance with other embodiments, different or alternate vocabularies can be used. In accordance with an embodiment, based on the resource type, the system looks for specific hard properties that must match, in a specified order. Special treatment is required for the property http://myurc.org/ns/res#forTargetName. This property may be “*” for stored resources (based on the specification of the Resource Property Vocabulary), but the resource request may ask for a specific target name, in which case the specific one may be substituted by a “*”.

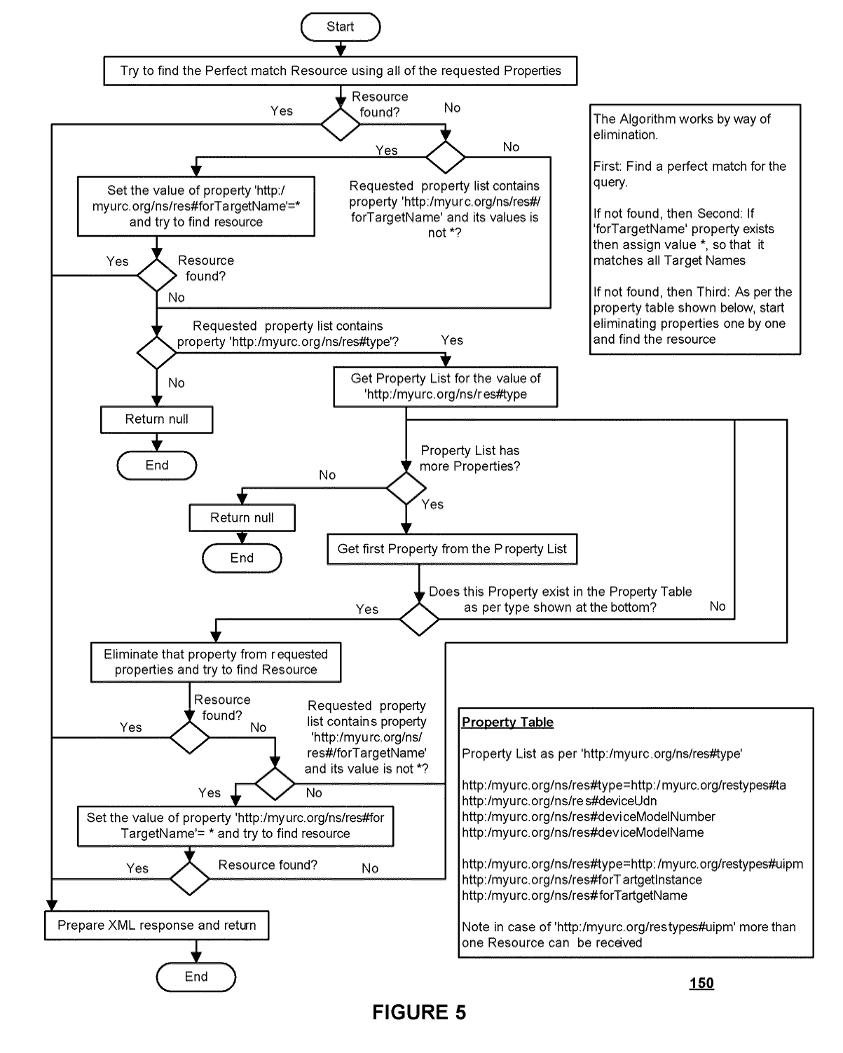

FIG. 5 shows a resource matching algorithm 150 and method in accordance with an embodiment. As shown in FIG. 5, in accordance with an embodiment, the process first tries to find a perfect match resource using all of the requested properties. If a matching resource is found, then the system prepares an appropriate XML response, and returns. If a perfect match resource is not found, then the system sets the value of property http://myurc.org/ns/res#forTargetName, and tries to find an appropriate resource, which can include parsing through multiple properties of the requested property list. If a property in the property lists exists in the property table, it can be elminated from the requested properties, and the system can set the value of propertyhttp://myurc.org/ns/res#forTargetName and attempt to find the resource. If the resource is found, the system can then prepare an XML response, and return.

### Resource Server Database

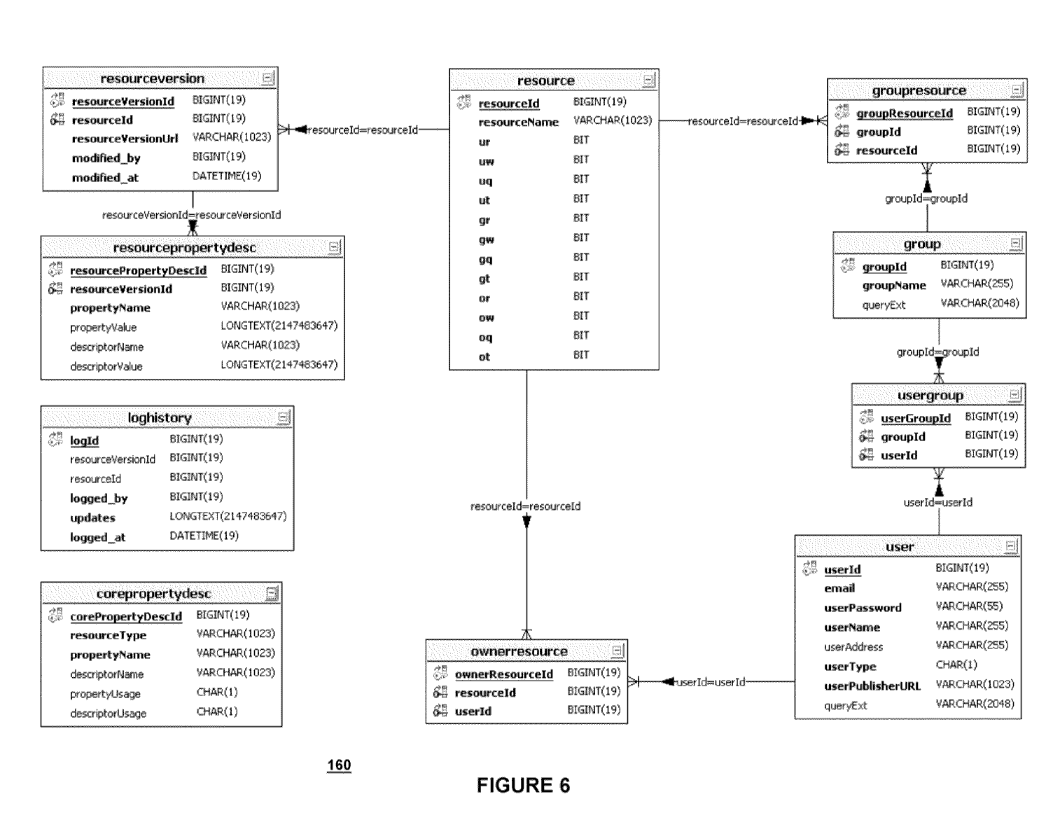

FIG. 6 shows a database structure 160 for use with the Resource Server in accordance with an embodiment. Depending on the particular embodiment and implementation, the following features can also be provided:

Pre-defined property names and corresponding descriptor names can be stored in the database as records of a table. Each record identifies whether a property and pertaining descriptors are mandatory, recommended, or optional, for a certain resource type. In accordance with an embodiment, this can be based on the Resource Property Vocabulary specification described above, or another vocabulary.

Changes on resources with their versions, access rights and properties can be stored in the database, with a timestamp of the change and the user making the change. This allows any changes to be backtracked easily if necessary.

Each user can have exactly one associated publisher URL. When a user creates or edits a resource, their publisher URL is automatically assigned to the resource's publisher URI property (http://myurc.org/ns/res#publisherUri). In accordance with an embodiment, Resource Server clients can reference certain publishers in their resource queries, and can be confident that a resource's claimed publisher is correct.

For each user and group, an SQL fragment is stored that will automatically be added to a resource query coming from the pertaining user and group. If fragments are stored for both the user and any of their groups, the fragments are ANDed. Thus the results for a resource query can be personalized. This feature can be used to implement features such as trust relationships to publishers, or subscriptions.

### Resource Server User Interface Access Rights

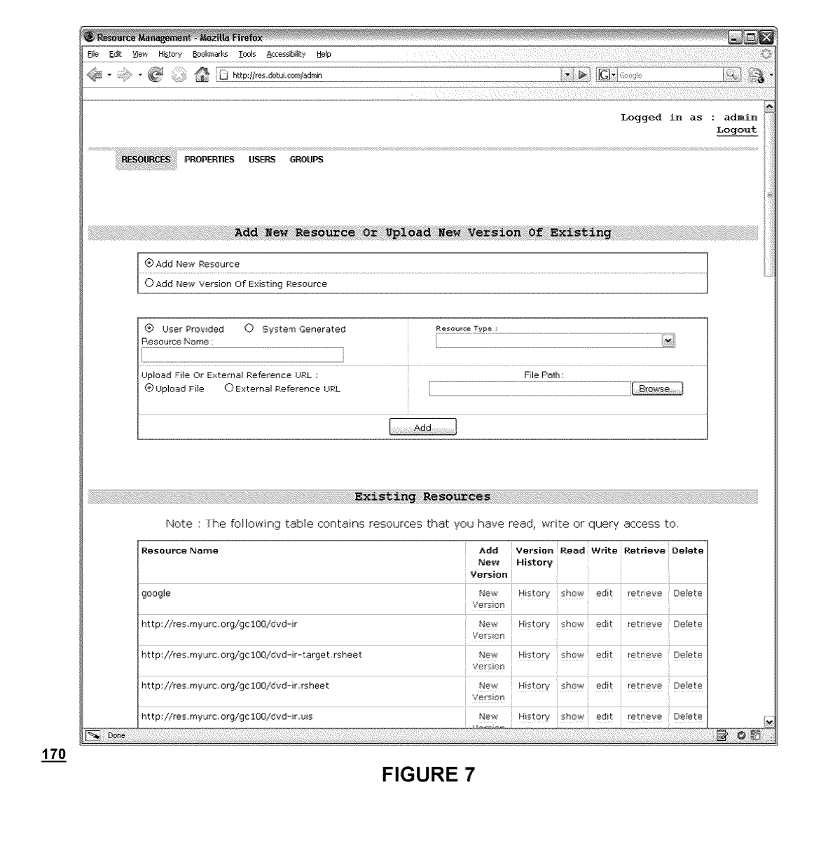

FIGS. 7-19 show interface screens for use by users and administrators in accordance with an embodiment. A user must first login by their specific name and password. Once logged in, they will be able to do those actions and see those resources that they have access to, based on their access rights.

FIG. 7 shows a resource editing and uploading interface screen 170 in accordance with an embodiment. As shown therein, a user can:

1. Upload a new resource:

a. The user provides the resource name, or lets the Resource Server generate one.

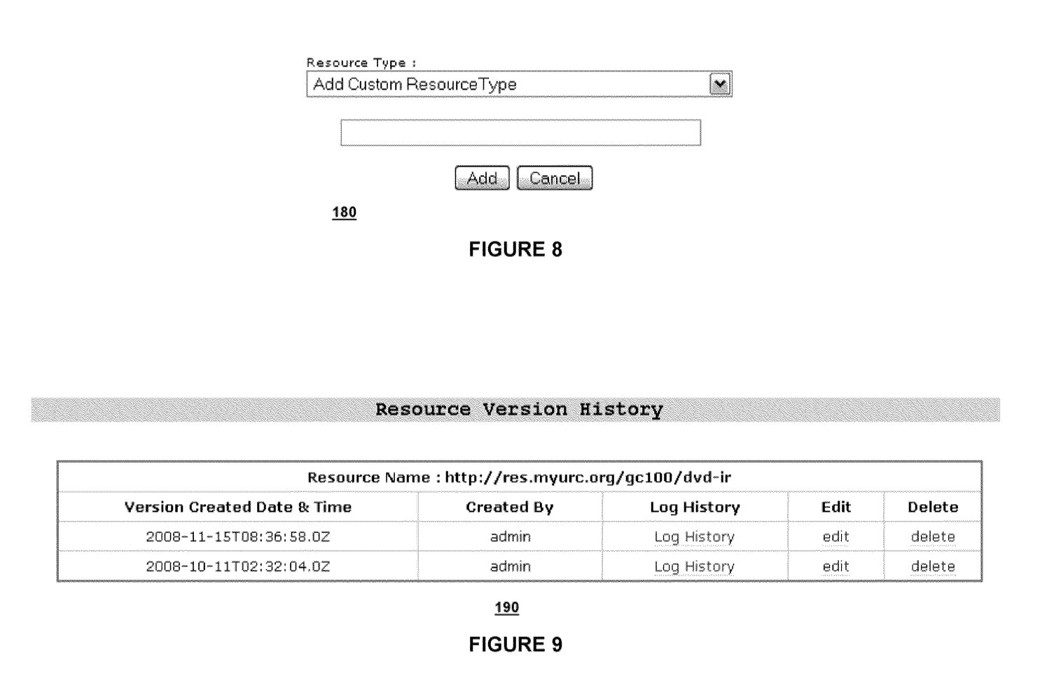

b. The system provides a list of resource types (taken from the database) and allows the user to select one. If the user selects “Add Custom Resource Type”, then an input field appears and the user can type a custom resource type (as shown 180 in FIG. 8).

c. The system allows the user to upload a resource as a file from the local filesystem.

2. Create a new resource by referencing an external URL. In this case, the external resource URL is stored in the Resource Server database rather than the resource itself.
3. Upload a new version of an existing resource:

a. The user can either type the name of the existing resource (upper part) or find the existing resource in the lower part of the page, and click on “New Version”.

b. Then the user can upload a local file.

4. Create a new version of an existing resource by referencing an external URL.
5. View the version history of a specific resource, by pressing the “History” link on a resource:

a. In a first step, a list of versions for a specific resource is shown (as shown 190 in FIG. 9).

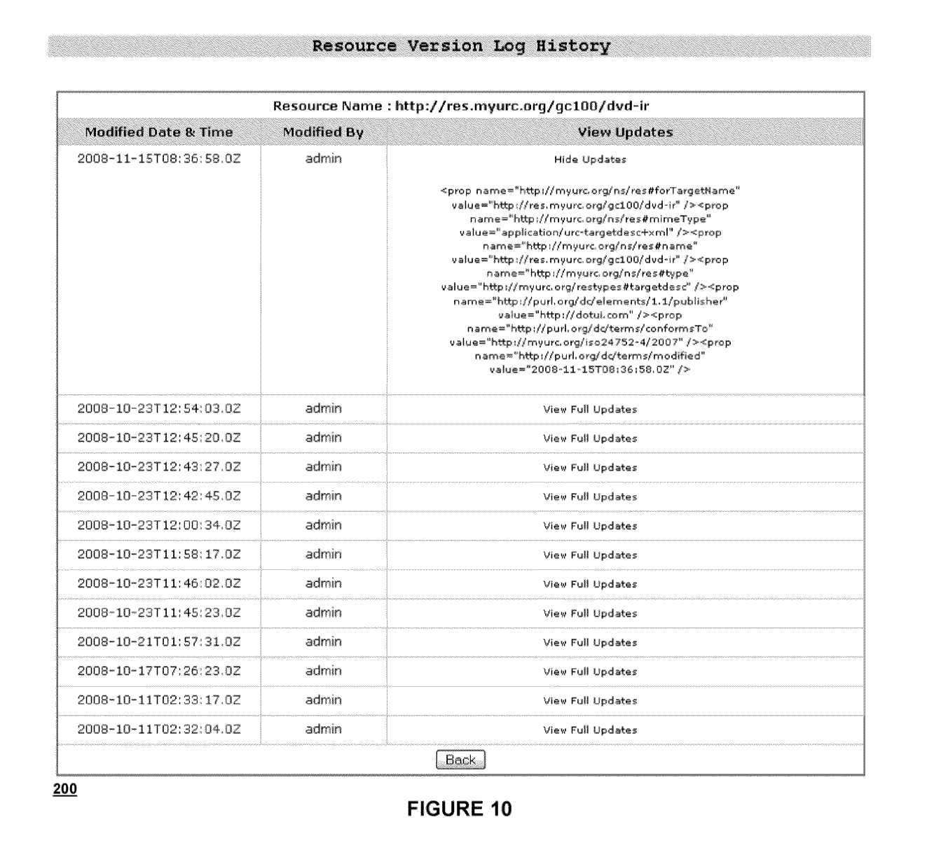

b. In a second step, the system allows the user to view a change log of a resource version, by pressing the “Log History” link. In the resource version log history, an XML-encoded list of changes can be displayed for every change item (as shown 200 in FIG. 10).

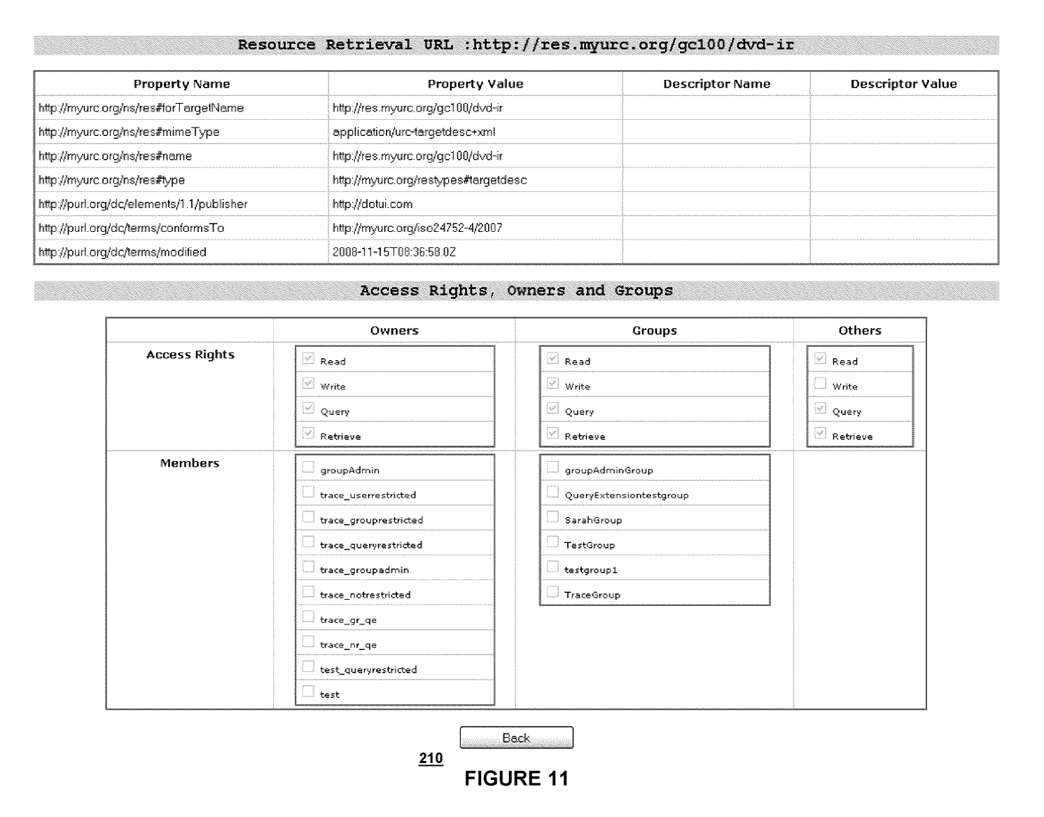

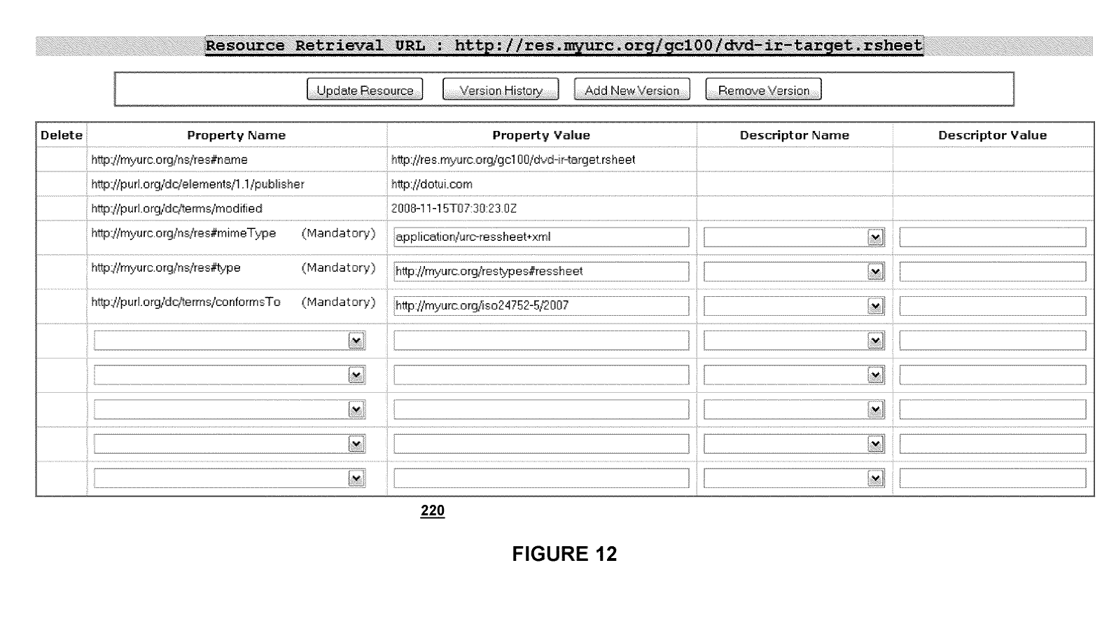

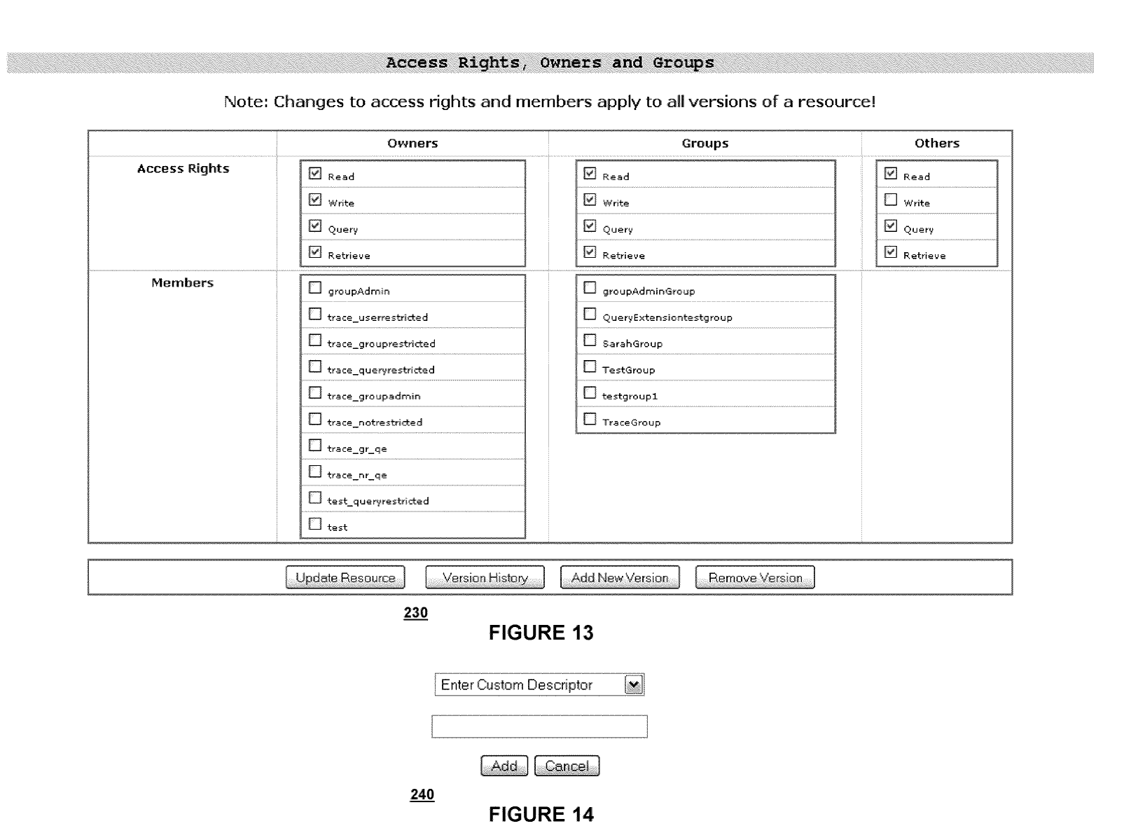

6. View a read-only description of the most recent version of a resource, its access rights, proper-ties and descriptors, by pressing the “show” link in the resources list (as shown 210 in FIG. 11; note for this view the user only needs to have “read” access to the resource).
7. View an editable description of the most recent version of a resource, its access rights, proper-ties and descriptors, by pressing the “edit” link in the resources list (as shown 220, 230 in FIGS. 12-13; note for this view the user needs to have “write” access to the resource).
8. The user can also:

a. Edit property values.

b. Add a new descriptor and value for a property. In accordance with an embodiment, the user can choose among descriptor names that are pre-defined for a given property (as defined by the Resource Property Vocabulary specification, or another vocabulary); or they can enter a custom descriptor name (as shown 240 in FIG. 14).

c. Add a new property and value for a resource. The user can choose among property names that are pre-defined for a given resource (as defined by the Resource Property Vocabulary specification, or another vocabulary); or they can enter a custom property name.

d. Delete an existing property and its value. Only properties that are not mandatory can be deleted.

e. Change access rights for owners, groups and guests (“others”).

f. Change set of owners, and set of groups.

g. Retrieve a version history for the resource.

h. Start the dialog for adding a new resource version.

i. Remove the currently shown version of the resource.

j. Retrieve the resource content of the currently shown version (using the link to “Resource Retrieval URL” shown at the top of the screen).

Depending on the particular embodiment and implementation, the following features can also be provided:

The Resource Server can automatically generate the resource name (property http://myurc.org/ns/res#name) upon creation of a resource.

The Resource Server can use the timestamp of upload as the version name (property http://purl.org/dc/terms/modified).

The Resource Server can automatically assign the publisher URI of the uploader (property http://myurc.org/ns/res#publisherUri).

### Property Editing Interface

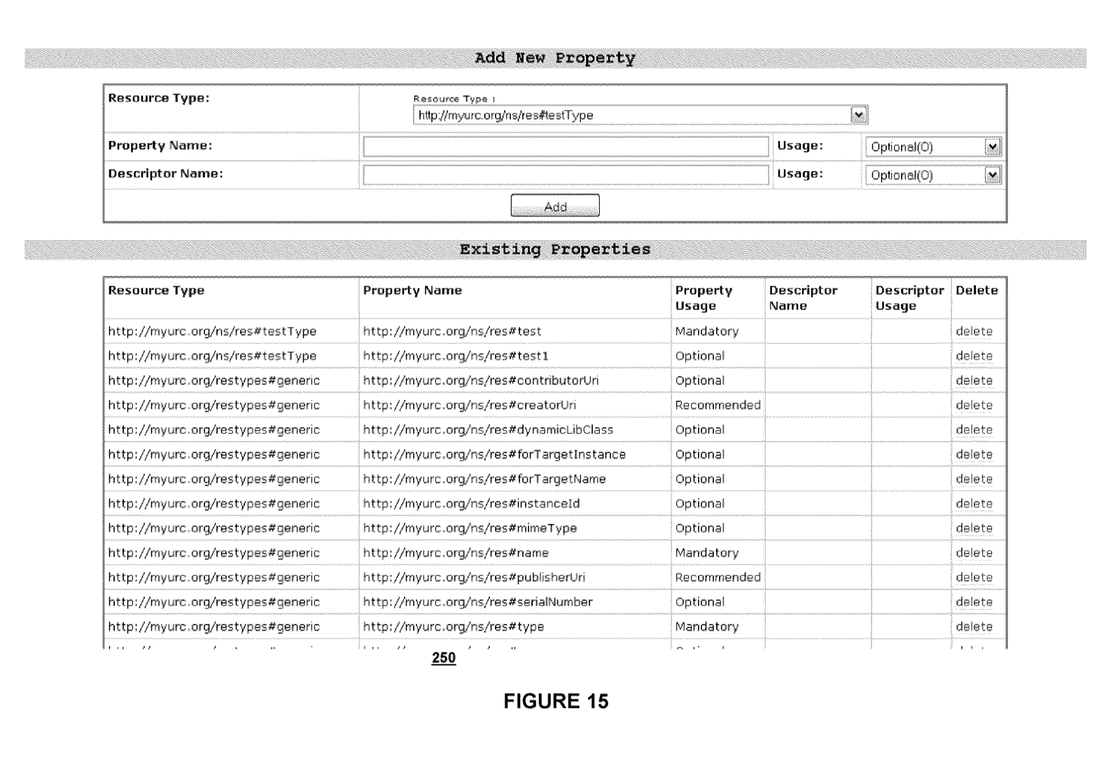

FIG. 15 shows a resource editing and uploading interface screen 250 in accordance with an embodiment. As described above, the pre-defined property and descriptor names can be stored in the Resource Server's database. In accordance with an embodiment, this content can be designed to comply with the Resource Property Vocabulary specification, or another vocabulary. As shown in FIG. 15, the user can:

1. Create new property-descriptor combinations for specific resource types. Such a record can include whether the property is mandatory, recommended or optional (also for the descriptor).
2. Delete an existing property-descriptor combination (using “delete” link in the list of properties).

### User Management Interface

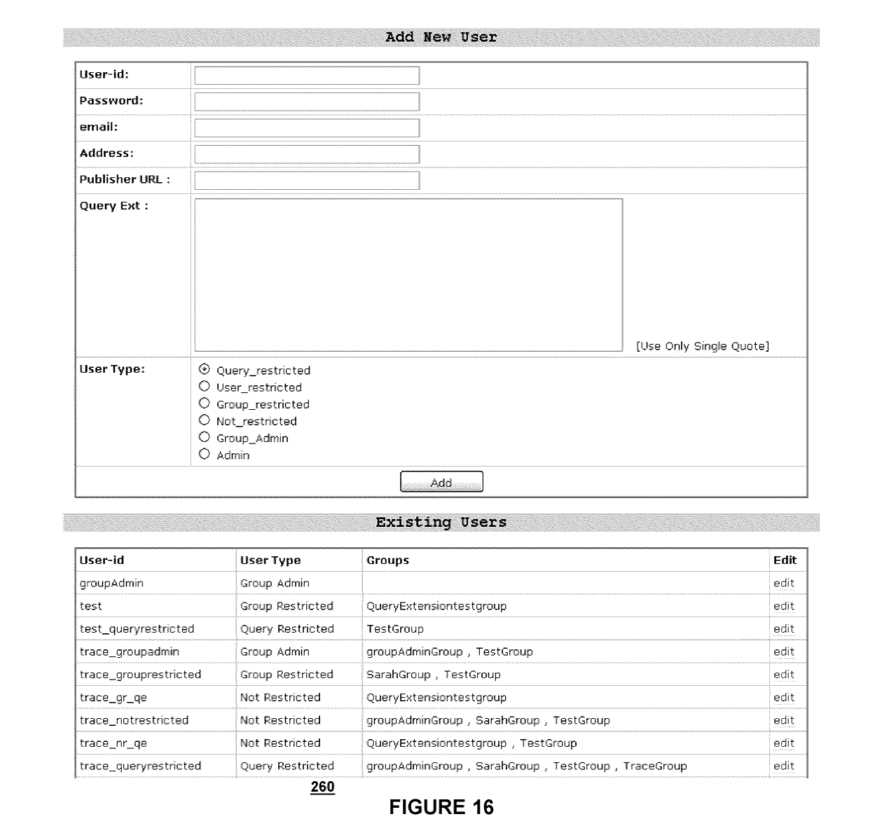

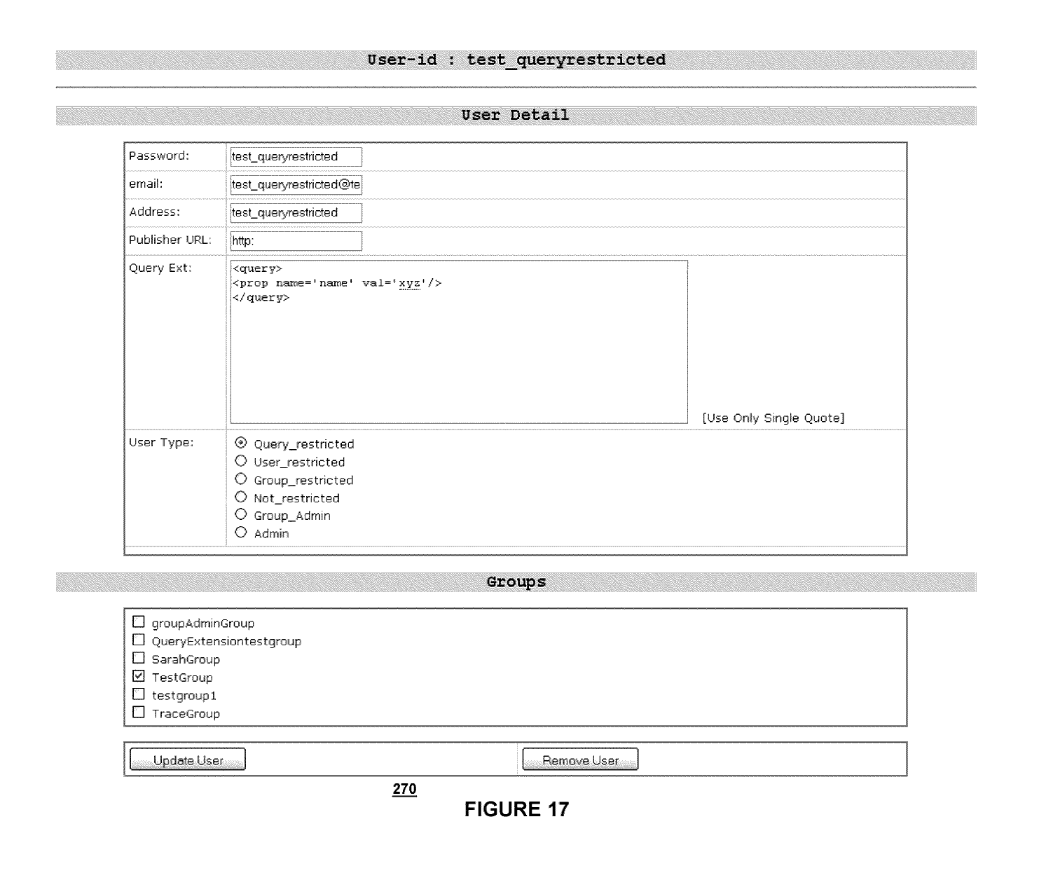

FIGS. 16-17 show a user management interface screen 260, 270 in accordance with an embodiment. As shown therein, users of type “Admin” can use the user management interface. In particular an admin can:

1. Add a new user, with userid, password, email, address, publisher URL, query extension (SQL fragement for the user), and user type.
2. See a list of existing users.
3. Edit the details of an existing user.
4. Remove an existing user (via the edit interface for a particular user).

### Group Management Interface

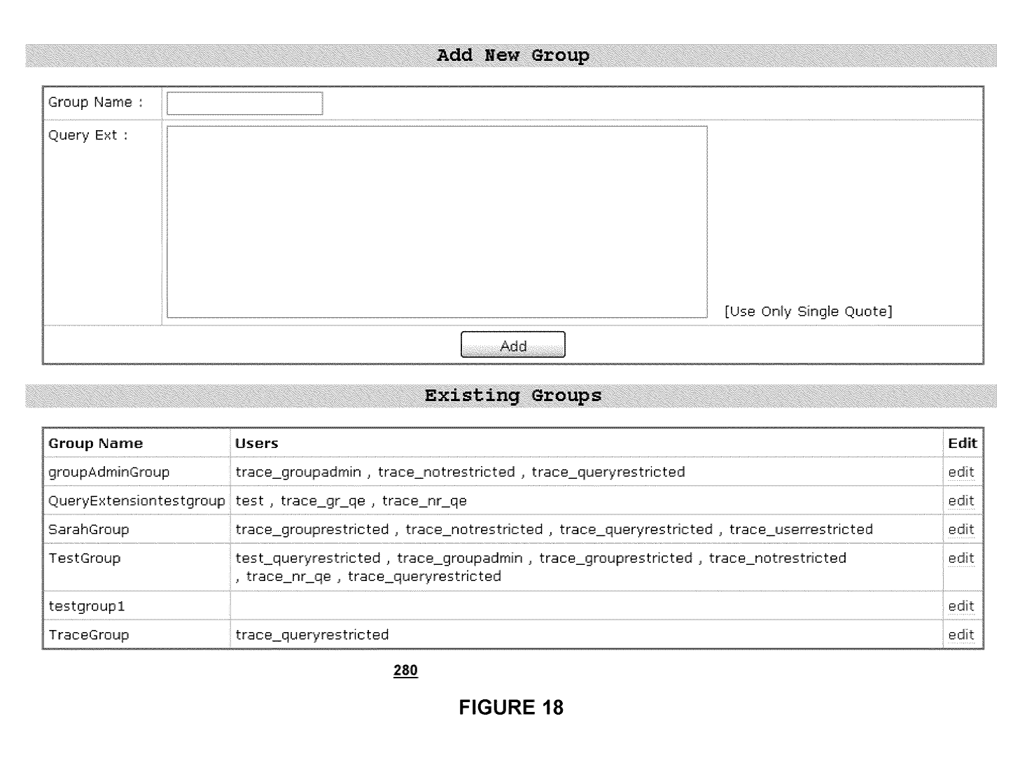

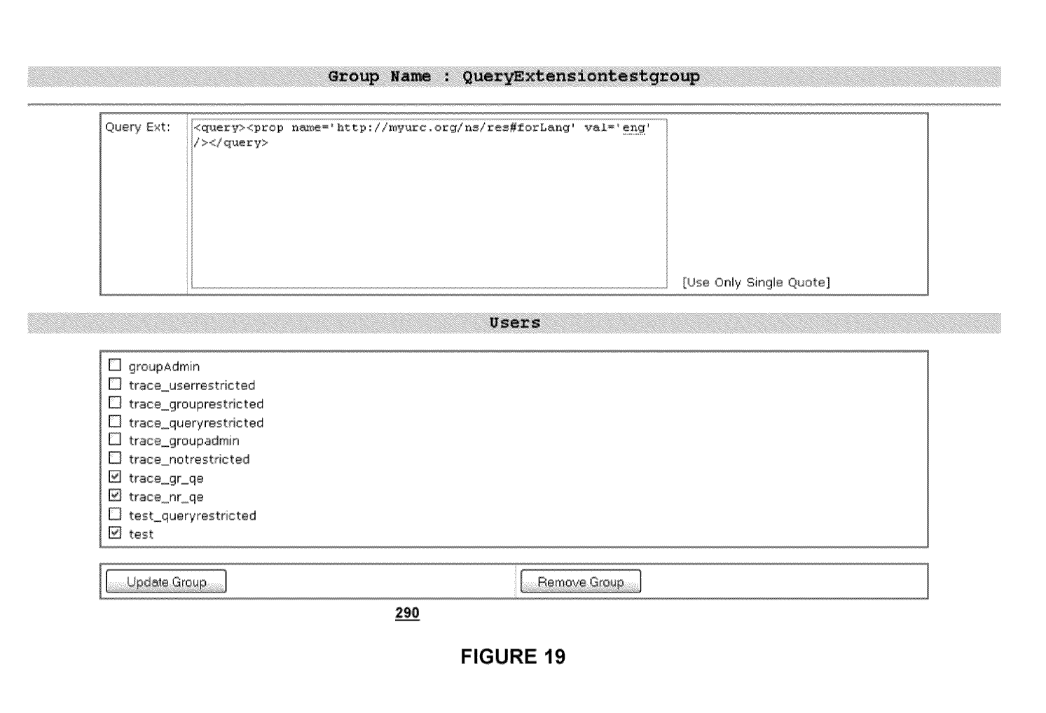

FIGS. 18-19 show a Group Management Interface screen 280, 290 in accordance with an embodiment. As shown therein, the admin can:

1. Add a new group, with group name, and query extension (SQL fragement for the group).
2. See a list of existing groups.
3. Edit the query extension, and set of members for an existing group.
4. Remove a group (via the edit interface for a particular group).

### Integrated Resource Development Environment

In accordance with an embodiment, a web-based interactive resource development environment can be provided by the Resource Server that includes some or all of the interfaces described above. Additionally, depending on the particular embodiment and implementation, the following features can also be provided:

A resource is immediately created and edited on the Resource Serve; with no need to store the resource locally on the author's computer.

Based on the implemented resource matching algorithm, the Resource Server can guide the author in assigning an appropriate set of properties and descriptors for the resource. In particular, the Resource Server can alert the author to other resources that have a very similar (or same) set of values for properties and descriptors, and suggest additional properties and descriptors to differentiate that resource from others.

The resource development environment can provide a graphical editor for socket descriptions and pertaining resource sheets. While editing, the Resource Server can check against syntactical and semantic rules for socket descriptions and resource sheets, and alert the user in case of any violation.

When designing a UIPM or UIPM client based on an existing UI socket description, the editor can support the user in generating an initial simple design draft; and can allow the author to pick from a list of available UI socket elements when connecting the UI elements to socket elements.

When designing a UIPM or UIPM client for a socket description that does not exist yet, the resource development environment can automatically generate an initial UI socket description based on the UI elements the author has created.

### 2. URC Resource Server HTTP Interface

This section describes how resources can be queried and retrieved from a resource server via HTTP, in accordance with an embodiment.

### Requirements

1. The resource server shall be available at a fixed domain name.
2. Two alternate usage modes: anonymous, authenticated.
3. Two steps for downloading a resource: Resource query, resource retrieval.
4. Resource query shall be available via HTTP GET/POST (anonymous) and HTTPS POST (anonymous or authenticated).
5. Resource retrieval shall be available through HTTP GET/POST (anonymous) and HTTPS POST (anonymous or authenticated).
6. A request for a resource shall contain a list of properties (optionally including descriptors) and values. The list of properties is open. Which set of properties are applicable for a resource query depends on the resources' properties being queried.
7. Property names shall be full (absolute) URIs, consisting of a namespace identifier and a property name.
8. The response (result) of a request for resource shall indicate the appropriate MIME type through the Content-Type field of the HTTP header.

### Resource Server URL

A resource server shall have a fixed URL, using the HTTP scheme and a domain name (e.g. http://myurc.org/resserv/). In the remainder of this section, the resource server URL is referenced as http://res-sery-url/.

### Resource Properties

In accordance with an embodiment, resources are stored on the resource server with their metadata. Metadata is expressed in the form of resource properties. A resource property name shall be a string representing a full (absolute) URI [RFC 3986], to be understood as a concatenation of a namespace identifier and a property name. Specific encoding rules may apply when using a property name in a given context (for example as URI component, or inside XML content). Property names shall be case-insensitive. The value of a property shall be a string. One property may occur multiple times for a resource, but with different values, thus expressing that all values apply to the resource. A property may have one or multiple descriptors, allowing for variations of the property along the descriptors' value spaces (e.g. language codes). The purpose of a descriptor is to find the most relevant property among multiple properties with the same name. A descriptor shall be a string (e.g. “lang” for language), and its value also a string (e.g. “en” for the English language code). A human understandable description should be available for each property at its URI which should be resolvable. For example, a property can be described within an RDF schema file, with the property's URI consisting of the location of the RDF schema file and the property name as fragment identifier (e.g. “http://myurc.org/ns/res#forTargetInstance”.

### Resource Query

In accordance with an embodiment, a client can ask the resource server to send a list of resource descriptions (including a URL for download) that meet specific criteria. This is called a “resource query”. If the client knows the URL of a resource, it can immediately retrieve it (see “resource retrieval” below). However, metadata (descriptions) on a resource can only be obtained through a resource query. A resource server shall offer resource queries through HTTP GET, HTTPS GET and HTTPS POST.

### Resource Query: HTTP GET Request

In accordance with an embodiment, an HTTP GET request shall be made to http://res-serv-url/query?prop1=value1&prop2=value2 whereby

prop1 and prop2 may be any property name, either as full URL (at least one colon ‘:’ character included) or as property without namespace (no colon ‘:’ character included), in which case the default namespace http://myurc.org/ns/res# shall be assumed.

value1 and value2 may be any string indicating a desired value for the property. The request shall contain one or more property-value pairs.

Reserved characters (see RFC 3986, section 2.2) shall be percent-encoded (see RFC 3986, section 2.1), when contained in a property name or value. Common programming languages offer encoding functions for URL components, for example the global function encodeURIComponent() in JavaScript. The HTTP GET request header should not contain an “Authorization” header [RFC 2617]. If it contains one, the server shall ignore it. It is not possible to specify a property descriptor in a resource query as HTTP GET request.

### Resource Query: HTTP(S) POST Request

In accordance with an embodiment, an HTTP POST request shall be made to http://res-serv-url/query (unsecure connection) or https://res-serv-urliquery (secure connection), with an XML-encoded message body in the following format:

```
<query>
  <prop name=“prop1” val=“value1” wgt=“weight1”>
    <descriptor name=“desc1” val=“dvalue1” />
    <descriptor name=“desc2” val=“dvalue2” />
  </prop>
  <prop name=“prop2” val=“value2” wgt=“weight2” />
</query>
```

Whereby:

The message body shall comply to [XML 1.0]. It should not contain any namespace declaration.
The encoding shall be UTF-8 [UCS].
The resource server should respect the header fields of the HTTP(S) request [RFC 2616].
For HTTPS POST requests, a resource server may require basic authentication in the message header. If required, but not present in the request, the server shall respond with error code 401 Unauthorized [RFC 2616].
   <query> shall contain 1 or more <prop> elements.
   A <prop> element shall have a ‘name’ and a ‘val’ attribute, and may have a ‘wgt’ attribute.
   The ‘name’ attribute shall bear any property name, either as full URL (at least one colon ‘:’ character included) or as property without namespace (no colon ‘:’ character included), in which case the default namespace http://myurc.org/ns/res# shall be assumed.
   The ‘val’ attribute shall bear any string indicating a desired value for the pertaining property.
   The ‘wgt’ attribute, if present, shall bear any floating point number between 0.0 and 1.0, indicating the weight of the property-value pair for match finding. A weight of 1.0 indicates that the requested resources must have the given property-value pair (i.e. resources with a different value for the property shall not be included in the response). A weight of 0.0 indicates that the given property-value pair is not relevant for the resource search. The exact meaning of weights between 0.0 and 1.0 is implementation-specific.
Multiple <prop> elements may have the same ‘name’ content, thus indicating multiple allowed values for one property.
   A <prop> element may contain any number of <descriptor> elements.
   A <descriptor> element shall have a ‘name’ and a ‘val’ attribute.
   The ‘name’ attribute shall bear a descriptor name that applies to the nesting property name.
   A ‘val’ attribute shall bear any string indicating a desired value for the pertaining descriptor.
Multiple <descriptor> elements may have the same ‘name’ content, thus indicating multiple allowed values for one descriptor.

In accordance with an embodiment, entity and character references shall be used for reserved characters, when contained in a property name or value. For example, “&lt;” should be used for “<”, “&gt;” should be used for “>”, “&amp;” should be used for “&”, and “&quot;” should be used for a double quote character (“).

### Resource Query: Response

In accordance with an embodiment, the resource server shall respond to a resource query (HTTP GET or HTTP(S) POST) as follows. If successful (i.e. the resource server has found at least one resource that matches the request), the resource server shall respond with an HTTP status code of 200, and a list of resources as an XML-encoded body in the format below. Otherwise the resource server shall respond with the appropriate HTTP status code (see below) and an empty body.

```
<response>
  <resource about=“aboutURI1”>
    <globalAt>globalURI1</globalAt>
    <prop name=“prop11” val=“value11”>
      <descriptor name=“desc111” val=“dvalue111” />
      <descriptor name=“desc112” val=“dvalue112” />
    </prop>
    <prop name=“prop12” val=“value12” />
  </resource>
  <resource about=“aboutURI2”>
    <globalAt>globalURI2</globalAt>
    <prop name=“prop21” val=“value21” />
    <prop name=“prop22” val=“value22” />
  </resource>
</response>
```

Whereby:

The message body shall comply with [XML 1.0]. It should not contain any namespace declaration.

The encoding shall be UTF-8.

The header fields shall comply with [RFC 2616].

<response> shall contain one or more <resource> elements.

<resource> shall have an ‘about’ attribute, specifying a resource's globally unique identifier (i.e. the value of the property http://myurc.org/ns/res#name [RES Namespace]).

<resource> shall contain one or multiple <globalAt> subelements, with each containing a URI that can be used to download the resource. Note that the ‘globalAt’ URI may include a “query component” [RFC 3986].

<resource> shall contain one or more <prop> elements. In general, it shall enumerate all properties that the resource server has stored for the pertaining resource.

<prop> shall have a ‘name’ attribute and a ‘val’ attribute, describing a property-value pair of the resource.

The ‘name’ attribute shall bear any property name, as full URL.

The ‘val’ attribute shall bear any string indicating the value for the property.

Multiple <prop> elements may have the same name to indicate that the resource has multiple values (potentially with different descriptor values) for a single property.

<prop> may contain any number of <descriptor> elements. In general, it shall enumerate all descriptors that match the pertaining descriptors in the resource query. The specific matching algorithm is implementation-specific.

<descriptor> shall have a ‘name’ and a ‘val’ attribute.

The ‘name’ attribute shall bear a descriptor name that applies to the nesting property name.

A ‘val’ attribute shall bear any string indicating the value for the descriptor.

Multiple <descriptor> elements within one <prop> element shall not have the same name. If one property has the same value for different values of a descriptor, this shall be reported as multiple <prop> elements with different descriptor values nested.

### Resource Query: Relevant HTTP Status Codes

In accordance with an embodiment, a response to a resource response shall include one of the following HTTP status codes (cf. [RFC 2616], section 10):

| Status Code | Description |
|---|---|
| 200 OK | The request has succeeded, and the response is conveyed through the message body. |
| 204 No Content | There is no match for the query. (No message body.) |
| 400 Bad Request | The request could not be understood by the server due to malformed syntax. The client SHOULD |
| | NOT repeat the request without modifications. (No message body.) |
| 401 Unauthorized | The HTTPS request did not contain basic authorization. |
| 500 Internal Server Error | The server encountered an unexpected condition which prevented it from fulfilling the request. (No |
| | message body.) |
| 501 Not Implemented | The server does not support the functionality required to fulfill the request. This is the appropriate |
| | response when the server does not recognize the request method and is not capable of supporting |
| | it for any resource. (No message body.) |
| 503 Service Unavailable | The server is currently unable to handle the request due to a temporary overloading or |
| | maintenance of the server. The implication is that this is a temporary condition which will be |
| | alleviated after some delay. If known, the length of the delay MAY be indicated in a Retry-After |
| | header. If no Retry-After is given, the client SHOULD handle the response as it would for a 500 |
| | response. (No message body.) |

### Resource Retrieval

In accordance with an embodiment, a client shall retrieve a resource by its URL, as given as element content of the <globalAt> element in the resource response. If multiple URLs are given for a resource, any of them may be used to retrieve it. Note that a resource's URL may include query and fragment components, and may point to any Web server on the Internet. However, any web server offering resource retrieval shall comply to this section of this specification, even if it does not implement the resource query interface. The MIME type of the resource, if available, shall be the value of its http://myurc.org/ns/res#mimeType property, if specified. If this is not specified on the resource, the resource server may infer an appropriate MIME type in an implementation-specific way, or default to “application/octet-stream”. The resource retrieval shall support the If-Modified-Since field in the request header [RFC 2616], by taking into account the http://purl.org/dc/terms/modified property of a resource, if available.

Resource Retrieval: HTTP GET Request In accordance with an embodiment, anonymous retrieval shall be available through HTTP GET. The HTTP GET request header should not contain an “Authorization” header [RFC 2617]. If it contains one, the server shall ignore it. If authentication is required, the resource server may return error code 301 Moved Permanently [RFC 2616], and redirect to the corresponding URL for authenticated retrieval (HTTPS).

### Resource Retrieval: HTTPS GET Request

In accordance with an embodiment, authenticated retrieval shall be available through HTTPS GET. The request header from the client should contain an “Authorization” header with “Basic”, userid and password, as specified in [RFC 2617] for basic authentication. If it contains no “Authorization” header or the “Authorization” header contains data that does not grant access to the requested resource, the resource server shall respond with error code 401 Unauthorized [RFC 2616], and with the following information in the response (challenge): WWW-Authenticate: Basic realm=“Login required”. If, after having sent the error code 401, the client's request header still contains no “Authorization” header or the “Authorization” header contains data that does not grant access to the requested resource, the server may respond again with error code 401 Unauthorized [RFC 2616], or with error code 403 Forbidden [RFC 2616], at its discretion.

### 3. URC Resource Property Vocabulary

This section describes a core set of generic and resource type-specific properties that can be used in a URC ecosystem, in accordance with an embodiment. This applies to resources that are stored on the resource server, as well as for others like devices in the network. This specification is directed in particular to resource authors (for describing their resources upon upload to a resource server) and developers of UCHs and UCH components such as UIPMs, TDMs and TAs (for querying matching resources from a resource server). Other (non-core) property names may be used to describe resources, as long as the property names do not conflict with the core set defined in this document. In order to avoid potential conflicts with future versions of core properties and with other non-core properties, the use of author-owned URIs as namespaces for non-core property names is strongly recommended.

In accordance with an embodiment, resources are stored on the resource server with their metadata. Metadata is expressed as a set of resource properties attached to a resource. A resource property name is a string representing an (absolute) URI (not a URI reference which may be relative) [RFC 3986], being a concatenation of a namespace identifier and a property name. Often, the property name is represented as fragment component of the URI, but that is not required.

In accordance with an embodiment, matching of property names shall be case-insensitive. The value of a property shall be a string. Note that specific encoding rules may apply when coding a property name (and value) in a given context (for example as URI component, or inside XML content). One property may occur multiple times for a resource, but with different values, thus expressing that each value applies to the resource (AND operation). A property may have one or multiple descriptors, allowing for variations of the property value along the descriptors' value spaces (e.g. language codes). The purpose of a descriptor is to find the most relevant property value among alternatives. A descriptor name shall be a string (e.g. “lang” for language), and its value a string (e.g. “en” for the English language code). Since descriptors are specific to properties, this specification defines descriptors in the context of the properties that they apply to.

In accordance with an embodiment, a human understandable description should be available for each property name at its URI which should be resolvable. A good practice is to describe a set of properties (called “vocabulary”) in an RDF schema file, with a property's URI consisting of the location of the RDF schema file and the property name as fragment identifier.

### Generic Properties

In accordance with an embodiment, the following properties describe resources of all types, where applicable.

| Property Name | Description | Values | Usage |
|---|---|---|---|
| http://myurc.org/ns/res#name | Globally unique identifier (URI) of a | URI [RFC 3986], | required for resources |
| | resource. Note that multiple versions of | not necessarily | that are stored on a |
| | one resource may exist (see | resolvable | resource server |
| | http://purl.org/dc/terms/modified below). | | |
| | Note: Arguably, the property | | |
| | http://www.w3.org/1999/02/22-rdf-syntax-ns#about | | |
| | (attribute ‘rdf:about’) [ISO/IEC | | |
| | 24752-5:2008] could be used as property | | |
| | name for a globally unique identifier. | | |
| | However, there is a slight difference | | |
| | between the meaning of | | |
| | http://www.w3.org/1999/02/22-rdf-syntax-ns#about | | |
| | and | | |
| | http://myurc.org/ns/res#name in that | | |
| | http://www.w3.org/1999/02/22-rdf-syntax-ns#about | | |
| | assigns a resource to a | | |
| | structured set of property-value pairs | | |
| | (called “description”) rather than specifying | | |
| | the name of the resource itself. | | |
| http://purl.org/dc/terms/modified | [DCMI Terms] | xsd:date Time | required for resources |
| | Date on which the resource was changed | [XSD Datatypes] | that are stored on a |
| | most recently. Used to identify the version | in any of the | resource server |
| | of a resource. | following | |
| | | formats: | |
| | | yyyy- | |
| | | mm- | |
| | | ddThh: | |
| | | mm:ssZ | |
| | | yyyy- | |
| | | mm- | |
| | | ddThh: | |
| | | mm:ss+ | |
| | | zz:zz | |
| | | yyyy- | |
| | | mm- | |
| | | ddThh: | |
| | | mm:ss− | |
| | | zz:zz | |
| | | Example: “2008- | |
| | | 08- | |
| | | 14T15:40:02+02: | |
| | | 00” | |
| http://myurc.org/ns/res#type | Type of resource with regard to the URC | URI [RFC 3986], | required |
| | ecosystem. | recommended | |
| | For packaged resources (e.g. provided as | to be resolvable. | |
| | a zip file), the http://myurc.org/ns/res#type | See sections | |
| | property reflects the resource type of the | below for type- | |
| | index file. See property | specific values. | |
| | http://myurc.org/ns/res#indexFile below. | | |
| http://purl.org/dc/terms/conformsTo | Conformance to a standard [DCMI Terms]. | URI [RFC 3986], | recommended for |
| | | not necessarily | resources that comply |
| | | resolvable. See | to a standard |
| | | sections below | |
| | | for type-specific | |
| | | values. | |
| http://myurc.org/ns/res#mimeType | MIME type [RFC 2046] of the resource. | MIME type [RFC | recommended for |
| | This property is used by the resource | 2046], from any | resources that are |
| | server to determine the MIME type for a | of the following | stored on a resource |
| | resource served to a client upon resource | trees [RFC | server |
| | retrieval [RES-SERV-HTTP]. | 4288]: | |
| | | Standards | |
| | | Tree | |
| | | [IANA | |
| | | MIME | |
| | | Types] | |
| | | Vendor | |
| | | Tree | |
| | | (prefix | |
| | | “vnd.”) | |
| | | [IANA | |
| | | MIME | |
| | | Types] | |
| | | Personal | |
| | | or | |
| | | Vanity | |
| | | Tree | |
| | | (prefix | |
| | | “prs.”) | |
| | | [IANA | |
| | | MIME | |
| | | Types] | |
| | | Special | |
| | | x. | |
| | | Tree | |
| | | (prefix | |
| | | “x.” or | |
| | | “x-”) | |
| http://myurc.org/ns/res#instanceId | Instance identifier for the resource. | xsd:string [XSD | Optional |
| | Applicable to devices in a network, in | Datatypes] | |
| | particular. | | |
| http://myurc.org/ns/ | Name of the main class of a resource that | xsd:string [XSD | Optional |
| res#dynamicLibClass | is a dynamic library file. Applies only to | Datatypes] | |
| | certain types of dynamic libraries (e.g. JAR | | |
| | files). | | |
| http://myurc.org/ns/ | Specifies the target (class) name for which | URI [RFC 3986], | Optional |
| res#forTargetName | the resource can be applied. | not necessarily | |
| | | resolvable. | |
| http://myurc.org/ns/ | Specifies the target instance for which the | xsd:string [XSD | Optional |
| res#forTargetInstance | resource can be applied [ISO/IEC 24752- | Datatypes] | |
| | 5:2008]. If not specified, the resource can | | |
| | be applied to all target instances. | | |
| http://purl.org/dc/elements/1.1/title | A name given to the resource [DCMI | xsd:string [XSD | Recommended |
| | Terms]. | Datatypes], | |
| | A language tag may be specified as the | recommended | |
| | value of the descriptor “lang” [RFC 4646] | to be short (not | |
| | [IANA Language Tags]. | exceeding 5 | |
| | The title can be used as a human-readable | words). | |
| | label for the resource (class). | | |
| http://purl.org/dc/elements/1.1/ | Human readable description of the | xsd:string [XSD | Optional |
| description | resource [DCMI Terms]. | Datatypes], may | |
| | A language tag should be specified as the | be long. | |
| | value of the descriptor “lang” [RFC 4646] | | |
| | [IANA Language Tags]. | | |
| http://purl.org/dc/elements/1.1/language | A language of the resource, if applicable | Language tag | Optional |
| | [DCMI Terms]. | [RFC 4646], as | |
| | | registered in | |
| | | [IANA Language | |
| | | Tags] | |
| http://purl.org/dc/elements/1.1/creator | An entity primarily responsible for making | xsd:string [XSD | Optional |
| | the resource [DCMI Terms]. | Datatypes] | |
| http://myurc.org/ns/res#creatorUri | URI of creator. | URI [RFC 3986] - | Recommended |
| | | should be | |
| | | resolvable | |
| http://purl.org/dc/elements/1.1/publisher | An entity responsible for making the | xsd:string [XSD | Optional |
| | resource available [DCMI Terms] | Datatypes] | |
| http://myurc.org/ns/res#publisherUri | URI of publisher. | URI [RFC 3986] - | Recommended |
| | | should be | |
| | | resolvable. | |
| http://purl.org/dc/elements/1.1/ | An entity responsible for making | xsd:string [XSD | Optional |
| contributor | contributions to the resource (other than | Datatypes] | |
| | the creator) [DCMI Terms]. | | |
| http://myurc.org/ns/ | URI of contributor. | URI [RFC 3986] - | optional |
| res#contributorUri | | should be | |
| | | resolvable. | |
| http://myurc.org/ns/res#serialNumber | Serial number of a resource instance. | xsd:string [XSD | optional |
| | | Datatypes] | |
| http://myurc.org/ns/res#upc | Universal Product Code (UPC) of a | xsd:string [XSD | optional |
| | resource. | Datatypes] | |
| http://myurc.org/ns/res#indexFile | Path and name of index/main file of the | Path and file | recommended if |
| | resource (applicable if resource is provided | names for the | resource is provided as |
| | as file package, e.g. zip file). The index file | index file as part | package (e.g. zip file) |
| | is the entry point for accessing the | of the resource | with a dedicated index |
| | aggregated resource. | package. | file |
| | If property | Examples: | |
| | http://myurc.org/ns/res#indexFile is used, | “/index.html”, | |
| | property | “/main/start.php” | |
| | http://myurc.org/ns/res#indexFileMimeType | | |
| | (see below) is required. | | |
| http://myurc.org/ns/ | Specifies the MIME type of the index file of | MIME type [RFC | required if |
| res#indexFileMimeType | the resource. | 2046]. | http://myurc.org/ns/ |
| | | | res#indexFile is |
| | | | specified |

Other property names from metadata vocabularies, may be used as generic resource properties, if applicable. However, only those properties listed in this document are considered to be “core properties” in the URC ecosystem.

### Resource Type Specific Properties

This section defines resource type specific core properties for resources. The type of a resource is determined by the property http://myurc.org/ns/res#type. In this section, whenever a generic property is reiterated for a specific resource type, the type-specific definition overwrites the generic one (but only if not otherwise noted).

### Target Description Properties

In accordance with an embodiment, Target descriptions defined in [ISO/IEC 24752-4:2008] are described by generic resource properties, and any of the following properties:

| Property Name | Description | Values | Usage |
|---|---|---|---|
| http://myurc.org/ns/res#name | Globally unique identifier (URI) of the | URI [RFC 3986], not necessarily | required |
| | target description. Note that the target | resolvable | |
| | description name is different from the | | |
| | target name (which is the value of the | | |
| | ‘about’ attribute on the <target> element | | |
| | of the target description). | | |
| http://myurc.org/ns/res#forTargetName | Name of the target that the target | URI [RFC 3986], not necessarily | required |
| | description describes. This is the value | resolvable | |
| | of the ‘about’ attribute on the <target> | | |
| | element in the target description. | | |
| http://myurc.org/ns/res#type | URC-specific type of resource. | “http://myurc.org/restypes#targetdesc” | required |
| http://purl.org/dc/terms/conformsTo | Conformance to a standard [DCMI | “http://myurc.org/iso24752-4/2007” | required |
| | Terms]. | | |
| http:/myurc.org/ns/res#mimeType | MIME type for target description. | “application/urc-targetdesc+xml” | required |
| | | [ISO/IEC 24752-4:2008] | |

### Socket Description Properties

In accordance with an embodiment, Socket descriptions defined in [ISO/IEC 24752-2:2008] are described by generic resource properties, and any of the following properties:

| Property Name | Description | Values | Usage |
|---|---|---|---|
| http://myurc.org/ns/res#name | Globally unique identifier (URI) | URI [RFC 3986], not necessarily | Required |
| | of the socket description. Note | resolvable | |
| | that the socket description name | | |
| | is different from the socket name | | |
| | (which is the value of the ‘about’ | | |
| | attribute on the <uiSocket> | | |
| | element in the socket | | |
| | description). | | |
| http://myurc.org/ns/res#forSocketName | Name of the socket that the | URI [RFC 3986], not necessarily | Required |
| | socket description describes. | resolvable | |
| | This is the value of the ‘about’ | | |
| | attribute on the <uiSocket> | | |
| | element in the socket | | |
| | description | | |
| http://myurc.org/ns/res#type | URC-specific type of resource. | “http://myurc.org/restypes#uisocketdesc” | Required |
| http://purl.org/dc/terms/conformsTo | Conformance to a standard | “http://myurc.org/iso24752-2/2007” | Required |
| | [DCMI Terms]. | | |
| http://myurc.org/ns/res#mimeType | MIME type for target description. | “application/urc-uisocketdesc+xml” | Required |
| | | [ISO/IEC 24752-2:2008] | |
| http://myurc.org/ns/res#forTargetName | Target name(s) that the socket | URI [RFC 3986], not necessarily | recommended |
| | belongs to (as specified by the | resolvable | |
| | ‘http://myurc.org/res#name’ | | |
| | property of a URC-compatible | | |
| | target). May occur multiple times | | |
| | if a socket belongs to multiple | | |
| | targets. | | |

### Resource Sheet Properties

In accordance with an embodiment, Resource Sheets defined in [ISO/IEC 24752-5:2008] are described by generic resource properties, and any of the following properties:

| Property Name | Description | Values | Usage |
|---|---|---|---|
| http://myurc.org/ns/res#name | Globally unique | URI [RFC 3986], not necessarily resolvable | Required |
| | identifier (URI) for | | |
| | the resource | | |
| | sheet. This is the | | |
| | value of the | | |
| | ‘rdf:about’ attribute | | |
| | on the | | |
| | <ResSheet> | | |
| | element in the | | |
| | resource sheet. | | |
| http://myurc.org/ns/res#type | URC-specific type | “http://myurc.org/restypes#ressheet” | Required |
| | of resource. | | |
| http://purl.org/dc/terms/conformsTo | Conformance to a | “http://myurc.org/iso24752-5/2007” | Required |
| | standard [DCMI | | |
| | Terms]. | | |
| http://purl.org/dc/elements/1.1/format | Specifies an | MIME type [RFC 2046], from any of the | recommended if |
| | atomic resource | following trees [RFC 4288]: | resource sheet |
| | format that applies | Standards Tree [IANA MIME Types] | contains atomic |
| | to all atomic | Vendor Tree (prefix “vnd.”) [IANA | resources with a |
| | resources that are | MIME Types] | single MIME |
| | contained in the | Personal or Vanity Tree (prefix “prs.”) | type (e.g. |
| | described | [IANA MIME Types] | “image/jpeg”). |
| | resource sheet | Special x. Tree (prefix “x.” or “x-”) | |
| | [ISO/IEC 24752 | | |
| | 5:2008]. | | |
| http://purl.org/dc/elements/1.1/type | Specifies an | One of the following: Collection, Dataset, | recommended if |
| | atomic resource | Event, Image, InteractiveResource, | resource sheet |
| | type that applies | MovingImage, PhysicalObject, Service, | contains atomic |
| | to all atomic | Software, Sound, Stilllmage, Text [DCMI | resources for a |
| | resources that are | Terms]. | single type (e.g. |
| | contained in the | | “Text”). |
| | described | | |
| | resource sheet | | |
| | [ISO/IEC 24752- | | |
| | 5:2008]. | | |
| http://myurc.org/ns/res#forLang | Specifies a | Language tag [RFC 4646], as registered in | recommended if |
| | language that is | [IANA Language Tags] | resource sheet |
| | used in every use | | contains atomic |
| | context of every | | resources for a |
| | Atomic Resource | | single language. |
| | Description and | | |
| | that is assigned to | | |
| | all Grouping | | |
| | Resources | | |
| | contained in the | | |
| | Resource Sheet | | |
| | described | | |
| | [ISO/IEC 24752- | | |
| | 5:2008]. | | |
| http://myurc.org/ns/res#aResDescForDomain | Specifies a | URI [RFC 3986], not necessarily resolvable | recommended if |
| | domain (given as | | resource sheet |
| | URI) that is used | | contains atomic |
| | in every use | | resources |
| | context for every | | |
| | Atomic Resource | | |
| | that is contained | | |
| | in the described | | |
| | Resource Sheet | | |
| | [ISO/IEC 24752- | | |
| | 5:2008]. | | |
| http://myurc.org/ns/res#role | Specifies a role | URI [RFC 3986], not necessarily resolvable. | recommended if |
| | URI that is used in | [ISO/IEC 24752-5:2008] defines the following | resource sheet |
| | every use context | set of pre-defined roles. Other roles may be | contains atomic |
| | of every Atomic | used. | resources with a |
| | Resource that is | http://myurc.org/ns/res#label | single role |
| | contained in the | http://myurc.org/ns/res#help, | |
| | described | http://myurc.org/ns/res#help- | |
| | Resource Sheet | purpose, or | |
| | [ISO/IEC 24752- | http://myurc.org/ns/res#help-effect | |
| | 5:2008]. | http://myurc.org/ns/res#accesskey | |
| | | http://myurc.org/ns/res#keyword | |
| | | http://myurc.org/ns/res#location | |
| http://myurc.org/ns/res#groupingForDomain | Specifies a | URI [RFC 3986], not necessarily resolvable | recommended if |
| | domain that is | | resource sheet |
| | used in every | | contains |
| | Grouping | | groupings |
| | Resource that is | | |
| | contained in the | | |
| | described | | |
| | Resource Sheet | | |
| | [ISO/IEC 24752- | | |
| | 5:2008]. | | |

### Resource Sheet Package Properties

In accordance with an embodiment, if a resource sheet refers to externally stored resources, it may be provided as a package together with the external resources, e.g. as zip file. In this case, resource sheet packages are described by resource sheet properties, and any of the following properties:

| Property Name | Description | Values | Usage |
|---|---|---|---|
| http://myurc.org/ns/res#type | URC-specific type of resource. | “http://myurc.org/restypes#ressheet” | required |
| http://myurc.org/ns/ | MIME type for resource sheet | MIME type [RFC 2046] of the | required |
| res#mimeType | | package file. | |
| | | Example: “application/zip” | |
| http://myurc.org/ns/ | Path and name of the resource sheet | Path and file name for the | recommended |
| res#indexFile | (applicable if resource sheet is provided | resource sheet file as part of the | if resource |
| | as part of a file package, e.g. zip file). | resource package. | is provided |
| | If property | Examples: “/English.rsheet”, | as package |
| | http://myurc.org/ns/res#indexFile is | “/main/Main.rsheet” | (e.g. zip file) |
| | used, property | | with a |
| | http://myurc.org/ns/res#indexFileMimeType | | dedicated |
| | (see below) is required. | | index file |
| http://myurc.org/ns/ | Specifies the MIME type of the resource | “application/urc-ressheet+xml” | required if |
| res#indexFileMimeType | sheet file of the package. | [ISO/IEC 24752-5:2008] | resource |
| | | | sheet is |
| | | | provided as |
| | | | part of a |
| | | | package |

### Resource Directory Properties

In accordance with an embodiment, Resource Directories defined in [ISO/IEC 24752-5:2008] are described by generic resource properties, and any of the following properties:

| Property Name | Description | Values | Usage |
|---|---|---|---|
| http://myurc.org/ns/res#type | URC-specific | “http://myurc.org/restypes#resdir” | Required |
| | type of resource. | | |
| http://purl.org/dc/terms/conformsTo | Conformance to a | “http://myurc.org/iso#24752-5/2007” | Required |
| | standard [DCMI | | |
| | Terms]. | | |
| http://myurc.org/ns/res#mimeType | MIME type for | “application/urc-resdir+xml” [ISO/IEC | Required |
| | resource sheet | 24752-5:2008] | |
| http://purl.org/dc/elements/1.1/format | Specifies a | MIME type [RFC 2046], from one of the | recommended if |
| | format that | following trees [RFC 4288]: | resource directory |
| | applies to every | Standards Tree [IANA MIME | contains resource |
| | atomic resource | Types] | sheets with atomic |
| | that is (directly or | Vendor Tree (prefix “vnd.”) [IANA | resources with a |
| | indirectly) | MIME Types] | single MIME type |
| | contained in the | Personal or Vanity Tree (prefix | (e.g. “image/jpeg”). |
| | resource | “prs.”) [IANA MIME Types] | |
| | directory | Special x. Tree (prefix “x” or “x-”) | |
| | [ISO/IEC 24752- | | |
| | 5:2008]. | | |
| http://purl.org/dc/elements/1.1/type | The nature or | One of the following: Collection, Dataset, | recommended if |
| | genre of the | Event, Image, InteractiveResource, | resource directory |
| | resource [DCMI | MovingImage, PhysicalObject, Service, | contains resource |
| | Terms]. | Software, Sound, StillImage, Text [DCMI | sheets with atomic |
| | Specifies an | Terms] | resources for a |
| | atomic resource | | single type (e.g. |
| | type that applies | | “Text”). |
| | to every atomic | | |
| | resource that is | | |
| | (directly or | | |
| | indirectly) | | |
| | contained in the | | |
| | resource | | |
| | directory | | |
| | [ISO/IEC 24752- | | |
| | 5:2008]. | | |
| http://myurc.org/ns/res#forLang | Specifies a | Language tag [RFC 4646], as registered in | recommended if |
| | language that is | [IANA Language Tags] | resource directory |
| | used for every | | contains resource |
| | use context in | | sheets with atomic |
| | every atomic | | resources for a |
| | resource, | | single language. |
| | grouping | | |
| | resource and | | |
| | UIID that is | | |
| | (directly or | | |
| | indirectly) | | |
| | contained in the | | |
| | resource | | |
| | directory | | |
| | [ISO/IEC 24752- | | |
| | 5:2008]. | | |
| http://myurc.org/ns/res#aResDescForDomain | Specifies a | URI [RFC 3986], not necessarily resolvable | recommended if |
| | domain that is | | resource directory |
| | used in every use | | contains resource |
| | context of every | | sheets with atomic |
| | that is (directly or | | resources |
| | indirectly) | | |
| | contained in the | | |
| | resource | | |
| | directory | | |
| | [ISO/IEC 24752- | | |
| | 5:2008]. | | |
| http://myurc.org/ns/res#role | Specifies a role | URI [RFC 3986], not necessarily resolvable. | recommended if |
| | that is used in | [ISO/IEC 24752-5:2008] defines the | resource directory |
| | every use context | following set of roles which may be | contains resource |
| | of every atomic | extended: | sheets with atomic |
| | resource that is | http://myurc.org/ns/res#label | resources with a |
| | (directly or | http://myurc.org/ns/res#help, | single role |
| | indirectly) | http://myurc.org/ns/res#help-purpose, | |
| | contained in the | or | |
| | resource | http://myurc.org/ns/res#help-effect | |
| | directory | http://myurc.org/ns/res#accesskey | |
| | [ISO/IEC 24752- | http://myurc.org/ns/res#keyword | |
| | 5:2008]. | http://myurc.org/ns/res#location | |
| http://myurc.org/ns/res#groupingForDomain | Specifies the | URI [RFC 3986], not necessarily resolvable | recommended if |
| | domain(s) of the | | resource directory |
| | user interface | | contains resource |
| | elements that | | sheets with |
| | occur as the | | groupings |
| | leaves of the | | |
| | group tree | | |
| | described by the | | |
| | grouping | | |
| | resource | | |
| | [ISO/IEC 24752- | | |
| | 5:2008]. | | |
| http://myurc.org/ns/res#uiidForDomain | Specifies a | URI [RFC 3986], not necessarily resolvable | recommended if |
| | domain that | | resource directory |
| | applies to every | | contains UIID |
| | UIID that is | | descriptions. |
| | (directly or | | |
| | indirectly) | | |
| | contained in the | | |
| | resource | | |
| | directory | | |
| | [ISO/IEC 24752- | | |
| | 5:2008]. | | |

### TDM Properties

In accordance with an embodiment, TDMs are described by generic resource properties, and any of the following properties:

| Property Name | Description | Values | Usage |
|---|---|---|---|
| http://myurc.org/ns/res#type | Type of resource with regard to | “http://myurc.org/restypes#tdm” [UCH] | required |
| | the URC ecosystem. | | |
| http://purl.org/dc/terms/conformsTo | Specifies the version-specific | Version URL of a UCH spec version, e.g. | required |
| | URL of the UCH specification | “http://myurc.org/TR/uch1.0/”. | |
| | that the TDM conforms to [UCH]. | | |
| http://myurc.org/ns/res#mimeType | MIME type [RFC 2046] of the | Any registered [IANA MIME Types] or | recommended |
| | TDM. | unregistered MIME type. | |
| http://myurc.org/ns/res#devicePlatform | Identifier for the device platform | Platform-specific identifier, e.g. “UPnP”. | recommended |
| | of the TDM. | | |

### TA Properties

In accordance with an embodiment, Target Adapters (TAs) are described by generic resource properties, generic TA properties, and platform-specific TA properties.

### Generic TA Properties

| Property Name | Description | Values | Usage |
|---|---|---|---|
| http://myurc.org/ns/res#type | Type of resource with regard to the URC | “http://myurc.org/restypes#ta” | required |
| | ecosystem. | [UCH] | |
| http://purl.org/dc/terms/conformsTo | Specifies the version-specific URL of the | Version URL of a UCH spec, | required |
| | UCH specification that the TA conforms | e.g. | |
| | to [UCH]. | “http://myurc.org/TR/uch1.0/”. | |
| http://myurc.org/ns/res#mimeType | MIME type [RFC 2046] of the TA. | Any registered [IANA MIME | recommended |
| | | Types] or unregistered MIME | |
| | | type. | |
| http://myurc.org/ns/res#devicePlatform | Identifier for the device platform of the | Platform-specific identifier, | recommended |
| | TA. | e.g. “UPnP”. | |
| http://myurc.org/ns/res#forTargetName | Specifies the target (class) name for | URI [RFC 3986], not | recommended |
| | which the TA works with. The value “*” | necessarily resolvable. | |
| | specifies that the TA works with all target | | |
| | classes. | | |
| http://myurc.org/ns/res#forTargetInstance | Specifies the target instance for which | xsd:string [XSD Datatypes] | optional |
| | the TA can be applied [ISO/IEC 24752- | | |
| | 5:2008]. If not specified, the TA can be | | |
| | applied to all target instances. | | |
| http://myurc.org/ns/res#deviceUpc | Universal Product Code (UPC) of the | xsd:string [XSD Datatypes] | optional |
| | target device that the TA applies to. | | |
| http://myurc.org/ns/res#deviceSerialNumber | Serial number of the target device that | xsd:string [XSD Datatypes] | optional |
| | the TA applies to. | | |
| | Note: This property restricts the use of | | |
| | the TA to single instances of targets. Cf. | | |
| | http://myurc.org/ns/res#forTargetInstance. | | |
| http://myurc.org/ns/res#tdUri | URI of the target description pertaining to | URI [RFC 3986], absolute or | Optional |
| | the TA. If relative, it is based on the | relative, must be resolvable. | |
| | location of the TA (or where it was | | |
| | retrieved from). | | |

### TA Properties for UPnP Platform

| Property Name | Description | Values | Usage |
|---|---|---|---|
| http://myurc.org/ns/res#devicePlatform | Identifier for the device platform of the TA. | “UPnP” | Required |
| http://myurc.org/ns/res#deviceType | UPnP device type, as given in the UPnP XML | URN [UPNP | recommended |
| | Device Description, as content of | ARCHITECTURE] | |
| | <deviceType>. | | |
| http://myurc.org/ns/res#deviceCreator | Device manufacturer name, as given in the | xsd:string [XSD | optional |
| | UPnP XML Device Description, as content of | Datatypes] | |
| | <manufacturer>. | | |
| http://myurc.org/ns/res#deviceCreatorUrl | Device manufacturer URL, as given in the | URI [RFC 3986] - | optional |
| | UPnP XML Device Description, as content of | should be resolvable | |
| | <manufacturerURL>. | | |
| http://myurc.org/ns/res#deviceModelName | Device model name, as given in the UPnP | xsd:string [XSD | optional |
| | XML Device Description, as content of | Datatypes] | |
| | <modelName>. | | |
| http://myurc.org/ns/res#deviceModelNumber | Device model number, as given in the UPnP | xsd:string [XSD | optional |
| | XML Device Description, as content of | Datatypes] | |
| | <modelNumber>. | | |
| http://myurc.org/ns/res#deviceModelUrl | Device model URL, as given in the UPnP | URI [RFC 3986] - | optional |
| | XML Device Description, as content of | should be resolvable | |
| | <modelURL>. | | |
| http://myurc.org/ns/res#deviceUpc | Universal Product Code (UPC) of the device, | xsd:string [XSD | optional |
| | as given in the UPnP XML Device | Datatypes] | |
| | Description, as content of <UPC>. | | |
| http://myurc.org/ns/res#deviceSerialNumber | Device serial number, as given in the UPnP | xsd:string [XSD | Optional |
| | XML Device Description, as content of | Datatypes] | |
| | <serialNumber>. | | |
| | Note: Should only be used if the TA is | | |
| | specific to a particular target instance. | | |
| http://myurc.org/ns/res#deviceUdn | Unique Device Name (UDN), as given in the | xsd:string [XSD | optional |
| | UPnP XML Device Description, as content of | Datatypes] | |
| | <UDN>. | | |
| | Note: Should only be used if the TA is | | |
| | specific to a particular target instance. | | |

### UIPM Properties

In accordance with an embodiment, User Interface Protocol Modules (UIPMs) are described by generic resource properties, and any of the following properties:

| Property Name | Description | Values | Usage |
|---|---|---|---|
| http://myurc.org/ns/res#type | Type of resource with regard to the | “http://myurc.org/restypes#uipm” | required |
| | URC ecosystem. | [UCH] | |
| http://purl.org/dc/terms/conformsTo | Specifies the version-specific URL | Version URL of a UCH spec, e.g. | required |
| | of the UCH specification that the | “http://myurc.org/TR/uch1.0/”. | |
| | UIPM conforms to [UCH]. | | |
| http://myurc.org/ns/res#mimeType | MIME type [RFC 2046] of the | Any registered [IANA MIME | recommended |
| | UIPM. | Types] or unregistered MIME type. | |
| http://myurc.org/ns/res#forTargetName | Specifies the target (class) name | URI [RFC 3986], not necessarily | required |
| | for which the UIPM can be applied. | resolvable. | |
| | Note that, if multiple URI entries | “*”: target-generic UIPM - applies | |
| | exist for this property, the UIPM is | to any target class (but only one at | |
| | applicable to any one of a set of | a time). | |
| | (alternate) targets. | “all”: UIPM applies to the complete | |
| | | set of all targets. | |
| http://myurc.org/ns/res#forSocketName | Specifies the name (URI) of a | URI [RFC 3986], not necessarily | optional |
| | socket that the UIPM maps to. | resolvable. | |
| | Note that, if there are multiple URI | “*”: socket-generic UIPM - applies | |
| | entries of this property, the UIPM | to any socket (but only one at a | |
| | maps to the set of specified | time). | |
| | sockets (at the same time). | “all”: UIPM applies to the set of all | |
| | | sockets of the target. | |
| http://myurc.org/ns/res#forTargetInstance | Specifies the target instance for | xsd:string [XSD Datatypes] | optional |
| | which the UIPM can be applied | | |
| | [ISO/IEC 24752-5:2008]. If not | | |
| | specified, the resource can be | | |
| | applied to all target instances. | | |
| | Note: Use only if the UIPM is | | |
| | specific to a particular target | | |
| | instance. | | |
| http://myurc.org/ns/res#urlScheme | Specifies a scheme for controllers | Scheme component of URI [RFC | optional |
| | to connect to the UIPM via a URL. | 3986]. | |
| | Can be used by the UIPM as | Examples: “http”, “ftp”, “urn”, | |
| | ‘scheme’ parameter in function | “vnc”. | |
| | IUIPMListener.startUriService( ) | | |
| | [UCH], if UIPM communicates with | | |
| | controllers via URLs. | | |
| http://myurc.org/ns/res#urlPortNo | Specifies a port number for | Port number. | optional |
| | controllers to connect to the UIPM | For example, “80” is the default | |
| | via a URL. | port number for HTTP. | |
| | Can be used by the UIPM as ‘port’ | | |
| | parameter in function | | |
| | IUIPMListener.startUriService( ) | | |
| | [UCH], if UIPM communicates with | | |
| | controllers via URLs. | | |
| http://myurc.org/ns/res#urlBasePath | Specifies a base path for | Some first part of path component | optional |
| | controllers to connect to the UIPM | of a URI [RFC 3986], starting with | |
| | via a URL. | a slash (“/”). | |
| | Can be used by the UIPM as | For example, the base path | |
| | ‘basePath’ parameter in function | “/UCH/URC-HTTP” with HTTP | |
| | IUIPMListener.startUriService( ) | means that all HTTP requests to | |
| | [UCH], if UIPM communicates with | the UCH that begin with “http:// | |
| | controllers via URLs. | ip-address/UCH/URC-HTTP” | |
| | | should be serviced | |
| | | (dispatched) to the UIPM. | |
| http://myurc.org/ns/res#protocolShortName | Specifies a short name for the user | Any values allowed for the | optional |
| | interface protocol that the UIPM | ‘shortName’ attribute of a | |
| | offers to controllers. | <protocol> element in a UIList | |
| | Can be used by the UIPM as | [UCH]. | |
| | ‘protocolShortName’ parameter in | Examples: “HTTP/HTML”, “RDP”, | |
| | function | “VNC”, “CE-HTML-1.0”, “URC- | |
| | IUIPMListener.addCompatibleUI( ) | HTTP”, “XRT”. | |
| | [UCH], if UIPM communicates with | | |
| | controllers via URLs. | | |
| http://purl.org/dc/terms/conformsTo | Specifies the version-specific URL | Version URL of a UCH spec | required |
| | of the URC-HTTP protocol | version, | |
| | specification that the UIPM | “http://myurc.org/TR/uch1.0/”. | |
| | conforms to [UCH] (only applicable | | |
| | to URC-HTTP UIPMs, ie. | | |

URC-HTTP UIPM Properties

In accordance with an embodiment, a URC-HTTP UIPM is a UIPM that offers the URC-HTTP protocol as an interface to clients/controllers. A URC-HTTP UIPM is described by generic resource, and any of the following properties:

| Property Name | Description | Values | Usage |
|---|---|---|---|
| http://purl.org/dc/terms/conformsTo | Specifies the version-specific URL of the URC- | Version URL of a URC- | required |
| | HTTP protocol specification that the UCH | HTTP spec, e.g. | |
| | conforms to [URC-HTTP]. | “http://myurc.org/TR/urc-http-protocol2.0/”. | |
| | Note: This property is in addition to | | |
| | http://purl.org/dc/terms/conformsTo on UIPMs | | |
| | (see section UIPM Properties). For URC-HTTP | | |
| | UIPMs, http://purl.org/dc/terms/conformsTo | | |
| | shall thus occur twice (but with different | | |
| | values). | | |
| http://myurc.org/ns/res#protocolShortName | Specifies a short name for the user interface | “URC-HTTP” | Required |
| | protocol that the UIPM offers to | | |
| | controllers/clients. | | |

### UIPM Client Properties

In accordance with an embodiment, UIPM clients are applications and scripts that are interfacing with the UCH via some UIPM. Some UIPM clients may be simple web pages (typically HTML pages with embedded scripts or objects running on any web browser) that can be retrieved from the UCH's web server.

| Property Name | Description | Values | Usage |
|---|---|---|---|
| http://myurc.org/ns/res#type | Type of resource with regard to the | “http://myurc.org/ | required |
| | URC ecosystem. | restypes#uipm-client” [UCH] | |
| http://myurc.org/ns/ | Specifies a short name for the user | Any values allowed for the | required |
| res#wrapsProtocolShortName | interface protocol that the UIPM client | ‘shortName’ attribute of a | |
| | uses in interfacing with the UIPM. | <protocol> element in a | |
| | | UIList [UCH]. | |
| | | Examples: “HTTP/HTML”, | |
| | | “RDP”, “VNC”, “CE-HTML- | |
| | | 1.0”, “URC-HTTP”, “XRT”. | |
| http://myurc.org/ns/res#protocolShortName | Specifies a short name for the user | Any values allowed for the | recommended |
| | interface protocol that the UIPM client | ‘shortName’ attribute of a | |
| | offers (as a wrapper to a protocol that | <protocol> element in a | |
| | the UIPM offers). | UIList [UCH]. | |
| | | Examples: “HTTP/HTML”, | |
| | | “RDP”, “VNC”, “CE-HTML- | |
| | | 1.0”, “URC-HTTP”, “XRT”. | |
| http://myurc.org/ns/res#mimeType | MIME type [RFC 2046] of the resource. | MIME type [RFC 2046]. | recommended |
| | This property is used by the resource | Some UIPM client resources | |
| | server to determine the MIME type for a | may be provided as a file | |
| | resource served to a client upon | package (e.g. zip file), | |
| | resource retrieval [RES-SERV-HTTP]. | consisting of all files needed | |
| | | by the controller to run the | |
| | | UIPM client. | |
| http://myurc.org/ns/res#indexFile | Path and name of index file of the UIPM | Path and file name for the | required if |
| | client (applicable if UIPM client is | index file as part of the UIPM | UIPM client. |
| | provided as file package). The index file | client package. | resource is |
| | is the entry point for controllers for | Examples: “/index.html”, | provided as |
| | using the UI protocol, as specified by | “/main/start.php” | package with |
| | the property | | an index file |
| | http://myurc.org/ns/res#protocolShortName. | | |
| http://myurc.org/ns/res#indexFileMimeType | Specifies the MIME type of the index | MIME type [RFC 2046]. | required if |
| | file of the UIPM client resource. | Examples: “text/html”, | UIPM client |
| | | “application/xhtml+xml”, | resource is |
| | | “application/ce-html+xml”, | provided as |
| | | “application/x-ce-html+xml” | package with |
| | | | an index file |

### URC-HTTP Client Properties

In accordance with an embodiment, a URC-HTTP client is a client of a URC-HTTP UIPM, i.e. an application or script that interfaces with the UCH via the URC-HTTP protocol [URC-HTTP] provided by the URC-HTTP UIPM. A URC-HTTP Client is described by generic resource properties, and any of the following properties:

| Property Name | Description | Values | Usage |
|---|---|---|---|
| http://purl.org/dc/terms/conformsTo | Specifies the version-specific | Version URL of a URC-HTTP spec, | required |
| | URL of the URC-HTTP protocol | e.g. “http://myurc.org/TR/urc-http-protocol2.0/”. | |
| | specification that the UCH | | |
| | conforms to [URC-HTTP]. | | |
| http://myurc.org/ns/ | Specifies a short name for the | “URC-HTTP” | required |
| res#wrapsProtocolShortName | user interface protocol that the | | |
| | UIPM client uses in interfacing | | |
| | with the UIPM. | | |

### UCH Properties

In accordance with an embodiment, a Universal Control Hub (UCH) is described by generic resource properties, and any of the following properties:

| Property Name | Description | Values | Usage |
|---|---|---|---|
| http://myurc.org/ns/res#type | Type of resource with regard to the URC | “http://myurc.org/TR/uch/” [UCH] | required |
| | ecosystem. | | |
| http://purl.org/dc/terms/conformsTo | Specifies the version-specific URL of the | Version URL of a UCH spec, e.g. | required |
| | UCH specification that the UCH conforms | “http://myurc.org/TR/uch1.0/”. | |
| | to [UCH]. | | |
| http://myurc.org/ns/res#baseUri | Base URI for the location of the UCH. | URI [RFC 3986] - should be resolvable | optional |

### Target Properties—URC-Compatible Target Properties

In accordance with an embodiment, URC-compatible targets are described by generic resource properties, if applicable, and any of the following properties:

| Property Name | Description | Values | Usage |
|---|---|---|---|
| http://myurc.org/ns/res#name | Unique identifier for target class. This is the | URI [RFC 3986], not necessarily | required |
| | value of the ‘about’ attribute in the target | resolvable | |
| | description. | | |
| http://myurc.org/ns/res#type | Type of resource with regard to the URC | “http://myurc.org/restypes#target” | required |
| | ecosystem. | | |
| http://myurc.org/ns/res#instanceId | Instance identifier for the target. | xsd:string [XSD Datatypes] | optional |
| http://myurc.org/ns/res#friendlyName | Friendly name for the device instance. | xsd:string [XSD Datatypes] | optional |
| http://myurc.org/ns/res#description | Name of the target description (see section | URI [RFC 3986], not necessarily | optional |
| | Target Description Properties, property | resolvable | |
| | ‘http://myurc.org/ns/res#name’) that describes | | |
| | the target. | | |
| | Note that the target and its target description | | |
| | are two different resources with different names, | | |
| | though closely related. Only a target description | | |
| | can be stored on a resource server. | | |
| http://myurc.org/ns/res#descriptionAt | Resolvable URI for a target description file. | URI [RFC 3986], must be | optional |
| | | resolvable | |

### UCH-Internal Target Properties

This section applies to targets that are connected to Target Adapters [UCH]. These targets are devices or services on the network that can be remotely controlled through a UCH, but are not URC compatible. In accordance with an embodiment, UCH-internal targets are described by generic resource properties if applicable, and any of the following properties:

| Property Name | Description | Values | Usage |
|---|---|---|---|
| http://myurc.org/ns/res#name | Unique identifier for the class of the | URI [RFC 3986], not necessarily | Required |
| | target. Maybe equal to modelUri (see | resolvable | |
| | below). | | |
| http://myurc.org/ns/res#type | Type of resource with regard to the | “http://myurc.org/TR/uch#target” | required |
| | URC ecosystem. | [UCH] | |
| http://myurc.org/ns/res#instanceId | Instance identifier for the target. | xsd:string [XSD Datatypes] | required |
| http://myurc.org/ns/res#friendlyName | Friendly name for the device instance. | xsd:string [XSD Datatypes] | required |
| http://myurc.org/ns/res#devicePlatform | Identifier for the device platform of the | Platform-specific identifier, e.g. | recommended |
| | target. | “UPnP”. | |
| http://myurc.org/ns/res#deviceType | Type of the device. | Platform-specific. | optional |
| http://myurc.org/ns/res#modelName | Device model name. | Platform-specific. | optional |
| http://myurc.org/ns/res#modelNumber | Device model number. | Platform-specific. | optional |
| http://myurc.org/ns/res#modelUri | URI identifying the device model. | URI [RFC 3986], not necessarily | optional |
| | | resolvable | |

### Socket Properties

In accordance with an embodiment, Sockets are machine interfaces to targets at runtime, based on [ISO/IEC 24752-2]. Sockets are described by generic resource properties, if applicable, and any of the following properties:

| Property Name | Description | Values | Usage |
|---|---|---|---|
| http://myurc.org/ns/res#name | Unique identifier for socket class. This is the | URI [RFC 3986], not necessarily | required |
| | value of the ‘about’ attribute on <uiSocket> in | resolvable | |
| | the socket description. | | |
| http://myurc.org/ns/res#type | Type of resource with regard to the URC | “http://myurc.org/restypes#socket” | required |
| | ecosystem. | [UCH] | |
| http://myurc.org/ns/res#description | Name of the socket description (see section | Socket description name (URI). | optional |
| | Socket Description Properties, property | | |
| | ‘http://myurc.org/ns/res#name’) that describes | | |
| | the socket. Note that the socet and its socket | | |
| | description are two different resources with | | |
| | different names, though closely related. | | |
| http://myurc.org/ns/res#descriptionAt | Resolvable URI for a socket description file. | URI [RFC 3986], must be | optional |
| | | resolvable | |

### Client Properties

In accordance with an embodiment, Clients are devices on the network that act as controllers to a UIPM [UCH]. Clients (and their users) are described by generic resource properties if applicable, and any of the following properties:

| Property Name | Description | Values | Usage |
|---|---|---|---|
| http://myurc.org/ns/res#type | Type of resource with regard to the URC | “http://myurc.org/TR/uch/#client” | required |
| | ecosystem. | [UCH] | |
| http://myurc.org/ns/res#instanceId | Instance identifier for the client. This may | xsd:string [XSD Datatypes] | required |
| | be the IP address of the controller. | | |
| http://myurc.org/ns/res#authorizationCode | An authorization code for opening a | xsd:string [XSD Datatypes] | optional |
| | session. The authorization code may | | |
| | have been provided by the UCH. | | |
| http://myurc.org/ns/res#friendlyName | Friendly name for the client instance. | xsd:string [XSD Datatypes] | optional |
| http://myurc.org/ns/res#devicePlatform | Identifier for the device platform of the | Platform-specific identifier, e.g. | optional |
| | client. | “UPnP”. | |
| http://myurc.org/ns/res#deviceType | Type of the client device. | Platform-specific. | optional |
| http://myurc.org/ns/res#modelName | Device model name. | Platform-specific. | optional |
| http://myurc.org/ns/res#modelNumber | Device model number. | Platform-specific. | optional |
| http://myurc.org/ns/res#modelUri | URI identifying the device model. | URI [RFC 3986], not necessarily | optional |
| | | resolvable | |

### Configuration File Properties

In accordance with an embodiment, Configuration files are used by URC ecosystem components that have some kind of generic behavior that can be configured for specific contexts. For example, a configuration file for a TA could specify IR codes for device-communication, as they map to the elements of the device's socket. In general, configuration files should be described with the same set of properties as for the component they configure. For example, a TA configuration file would use the properties as specified in TA Properties. There is one exception: A configuration file shall have a ‘http://myurc.org/ns/res#type’ property value that is distinct from that of the component it configures. It is recommended to use a ‘http://myurc.org/ns/res#type’ property value that is derived from (or extends) the ‘http://myurc.org/ns/res#name’ property value of the component. For example, if a TA's ‘http://myurc.org/ns/res#name’ has value “http://example.com/ta/platform”, all pertaining configuration files could have a ‘http://myurc.org/ns/res#type’ property with value “http://example.com/ta/platform/configfile”.

### 4. URC Control Hub

This section describes a Universal Control Hub (UCH) architecture, in accordance with an embodiment. This approach is a profiling of the Universal Remote Console (URC) technology (as specified by ISO/IEC 24752) in the context of a Remote User Interface scenario (as specified by CEA-2014-A). In accordance with an embodiment, the UCH allows the application of the URC technology in an environment with non-URC compliant controllers and non-URC compliant targets. In this approach, the URC technology is implemented “in a box”, with the Universal Control Hub acting as gateway between various controllers and various targets. In accordance with an embodiment, a gateway (“control hub”) is used as a middle layer between a controller and a target device or service. The gateway translates between any controller and any target; neither the controller nor the target needs to be URC compatible.

### Conformance

In accordance with an embodiment, a Universal Control Hub (UCH) conforms to the standard described herein if it provides: Support for the UIPM API; Implementation of the UIPM Listener interface,; Support for TDM API, Implementation of the TDM Listener interface, Support for TA API, Implementation of the TA Listener interface. Implementation of a discovery mechanism.

In accordance with an embodiment, a User Interface Protocol Module (UIPM) conforms to the standard described herein if it provides: Implementation for the UIPM API; Support for the UIPM Listener interface.

In accordance with an embodiment, a Target Discovery Module (TDM) conforms to the standard described herein if it provides: Implementation of the TDM API, Support for the TDM Listener interface.

In accordance with an embodiment, a Target Adapter (TA) conforms to the standard described herein if it provides: Implementation of the TA API, Support for the TA Listener interface.

### Runtime Model for UIPMs, TDMs and TAs

Basically there are two ways to design the APIs for the UCH: object-oriented or function-oriented.

### Object-Oriented Design

In the object-oriented approach, data and behavior is encapsulated as “objects”. Functions are understood as “methods” pertaining to objects such as targets, sessions, and socket elements. Regarding the UCH design, this approach has the following benefits: More natural for object-oriented languages (Java, C++); Slightly better performance for object-oriented languages (e.g. using session pointers rather than session ids and hash tables for managing sessions).

### Function-Oriented Design

In the function-oriented approach, data is passed as parameters of functions, preferably as primitive data types such as strings and numbers. Regarding the UCH design, this approach has the following benefits: Works for all languages (including non-object-oriented like C); Element values are passed as strings (no types or type checking); More suitable for cross-language interfaces (e.g. using JavaScript as glue code between Java and Flash); Only one interface to implement, and one to listen to; More in line with URC-HTTP protocol.

### Approach: Facade

In accordance with an embodiment, the approach taken by this specification is aligned with the function-oriented design approach. It allows for using the object-oriented approach inside the UCH or its loadable modules, but uses a facade approach for communication between the standardized components of a UCH. For example, a Target Adapter could maintain a session object internally, but exposes it to the UCH by a session identifier. A similar approach is taken for targets which are represented to User Interface Protocol Modules (UIPMs) by target identifiers.

### Modules Loaded at Runtime

In accordance with an embodiment, the UCH provides the runtime environment for User Interface Protocol Modules (UIPMs), Target Discovery Modules (TDMs) and Target Adapters (TAs). A UIPM and TA shall be available as separate code files, and in a form that allows the UCH to dynamically load and install its code. A TDM may be integrated into the UCH, or may be available as a separate file and in a form that allows the UCH to dynamically load and install its code.

### Optional Functions

In accordance with an embodiment, some functions are specified as optional, i.e. the module may or may not implement it. However, the module shall implement a stub of the function in any case, and shall throw a NotImplementedException if it doesn't support the optional function.

### Concurrency

In accordance with an embodiment, the functions specified in section Interaction Between UIPM and UCH, section Interaction Between Target Discovery Module (TDM) and UCH, and section Interaction Between Target Adapter and UCH shall be executed synchronously if they have a return type (not “void”); or synchronously or asynchronously if they have no return type (“void”).

### Property Map

In accordance with an embodiment, targets and resources (in the following just called “object”), including loadable modules (UIPMs, TDMs and TAs) shall be described through metadata. The UCH may retrieve such metadata from a resource server, or from local configuration data, or from somewhere else. At runtime, the UCH shall represent an object's metadata as a property map. A property map is a set of key-value pairs, both of type string. Unless otherwise noted, duplicate properties are allowed if their values differ. In general, multiple values are to be interpreted as additional values for the property (i.e. the set of key-value pairs that have identical keys represents a list of values for the key). The UCH provides a module's property map to the module itself at initialization time. This allows for customization of a generic module based on a particular runtime context. In addition, the UCH may utilize the property map of any object, for example for determining the most appropriate UIPM for a set of available targets.

### Property Names

In accordance with an embodiment, a property name shall be a URI [RFC 3986], consisting of a namespace and a local property name. This allows for an extensible set of properties. A core set of properties and their meanings are defined herein. Other (non-core) property names may be used to describe objects, as long as the property names do not conflict with the core set. In order to avoid potential conflicts with future versions of core properties and with other non-core properties, the use of author-owned URIs as namespaces for non-core property names is strongly recommended.

### Implementation Considerations

Implementation of property maps are platform-specific. Programming languages with hash maps should use hash maps with strings as keys and string arrays as values (to accommodate multiple values of the same property). Otherwise pairs of string arrays should be used.

### Target Instance Identifier

In accordance with an embodiment, the UCH shall provide identifiers for target instances (see ISO/IEC 24752-1, section 6.1.2 Target instance identifier). The target instance identifiers shall be globally unique. Target instance identifiers are strings, and shall not contain whitespace characters. Their format may be specific to the underlying target platform. The string “all” is reserved and shall not be used as target instance identifier. In this specification, a target instance identifier is commonly named ‘targetId’.The UCH should use target instance identifiers that are persistent even after periods of target unavailability, and after the UCH has restarted. For targets running on UPnP, the UDN is a suitable target instance identifier.

In accordance with an embodiment, static and dynamic resources may be defined to be specific to target instances. Static resources may use the <forTargetInstance> element (ISO/IEC 24752-5, section 6.7.3.6) to indicate a particular target instance. For dynamic resources, a TA may indicate their specificity to a particular target instance in the updateDynRes() function via the ‘targetId’ parameter.

### Session Identifier

In accordance with an embodiment, the UCH shall provide identifiers for sessions which are unique within the UCH. The UCH should not reuse session identifiers of sessions that have been terminated.

### Paths

In accordance with an embodiment, particular values of socket elements or components thereof are referenced by path strings. The following table lists possible forms of paths, as used by the APIs specified in subsequent sections of this document.

| Path Forfm Name | Syntax(es) | Description |
|---|---|---|
| root path | / | all Socket elements (and their components, if any) |
| path without | /set1/set2/id | alternative formats for non-dimensional Socket element or set |
| indices | id | |
| path with given | /set1[index1]/set2/ | one component of a dimensional Socket element or set, i.e. that has a ‘dim’ |
| indices | id[index2][index3] | attribute or that is contained (directly or indirectly) in a set that has a ‘dim’ |
| | | attribute |
| path with empty | /set1[ ]/set2/id[ ][ ] | all components of the Socket element or set id. |
| indices | | May be mixed with form “path with given indices”, thus partially specifying a |
| | | set of indices, e.g.: “/set1[index1]/set2/id[index2][ ]”, |
| | | “/set1[ ]/set2/id[index2][index3]”, “/set1[index1]/set2/id[ ][index3]”. |
| path with range of | /set1[index1a | specific components of the Socket element or set id, within a specific range |
| indices | index1b]/set2/id[index2a | of index values (index1a <= index1 <= index1b, index2a <= index2 <= |
| | index2b][index3a index3b] | index2b, index3a <= index3 <= index3b). |
| | | This form can only be applied for indices whose type is totally ordered (i.e. |
| | | the index type must be based on an XSD type with the fundamental facet |
| | | ‘ordered’ having a value of “total” or “partial”; if “partial”, only those index |
| | | values that can be compared with the boundaries will be included in the |
| | | response). |
| | | This form can be mixed with the “path with given indices” form, and the |
| | | “path with empty indices” form. EXAMPLE: “/set1[index1]/set2/id[index2a |
| | | index2b][ ]”. |
| path for command | /set1/set2/cmdid[state] | “state” field of a command (component) only applicable for commands of |
| state | id[state] | type “uis:basicCommand” or “uis:timedCommand” use first or second form |
| | /set1[index1]/set2/ | for non-dimensional commands; and last form for dimensional commands. |
| | cmdid[index2][index3][state] | |
| path for command | /set1/set2/cmdid[ttc] | “timeToComplete” field of a command (component) only applicable for |
| timeToComplete | cmdid[ttc] | commands of type “uis:timedCommand” use first or second form for non- |
| | /set1[index1]/set2/ | dimensional commands; and last form for dimensional commands. |
| | cmdid[index2][index3][ttc] | |
| path for local | /set1/set2/cmdid/parid | local parameter of a command (component) use first or second form for |
| command | parid | non-dimensional commands; and last form for dimensional commands. |
| parameter | /set1[index1]/set2/ | |
| | cmdid[index2][index3]/parid | |
| path for partial | eltPath#xmlPath | partial content of an XML-coded Socket element value (i.e. a Socket |
| XML content | | element with a complex XSD form). |
| | | eltPath references a Socket element, in any of the following path forms: |
| | | “path without indices”, “shortcut path” or “path with given indices”. |
| | | xmlPath has any one of the following syntaxes: |
| | | “root” for requesting an XML fragment containing the root element only. |
| | | “childrenOf(nodeId)” for requesting an XML fragment containing the child |
| | | nodes of the XML element with id = “nodeId”. |
| | | “parentOf(nodeId)” for requesting an XML fragment containing the parent |
| | | node of the XML element with id = “nodeId”. |
| | | “id(nodeId)” for requesting an XML fragment containing the XML element |
| | | with id = “nodeId”. The fragment will contain the nodeId element including its |
| | | attributes, but not its child nodes. |

### Values

In accordance with an embodiment, all values are passed as strings. NULL represents the undefined value. Optional socket elements that are not available in a socket at runtime have the undefined value.

### Resources

In accordance with an embodiment, a UIPM should not itself contact a resource server to query for resources. Instead, it should use the appropriate function getResources() to have the UCH do the query and retrieval for it. It is implementation-specific where the UCH will go for resource retrieval including a local configuration mechanism, a local resource server, a global resource server, or any combination of these. Atomic resources (even if they are dynamic) are common to all sessions on the same socket, and common to all components (index combinations) of a socket element. However, they may be different for different target instances (specified by the http://myurc.org/ns/res#forTargetInstance property).

### Local Data Store

In some cases different modules (UIPMs, TDMs, TAs) and the UCH core may wish to share data with each other. For this purpose, a shared Map is provided by the UCH, called “local data store”. Modules may store data as key-value pairs in the local UCH store, which may be accessed by other (related) modules that know the corresponding keys. It is recommended that keys are used that will likely not conflict with data written by other modules at runtime. Manufacturers of modules should use keys in the form of URIs that they own, such as URLs under their domain name. EXAMPLE: “http://example.com/uipm/portno”. Note that the local data store is not persistent. Data will not survive a UCH restart. Also, upon removal of a module (TA or UIPM) from the system, the UCH may delete data written by that module. Note also that the local UCH store is not a safe place for communicating sensitive information such as authorization keys, since it can be read by the UCH, and all UIPMs, TDMs and TAs. The UCH shall provide a local data store object as a map with distinct keys. No duplicate keys are allowed (i.e. setting a value for an already existing key will overwrite the previous data for that key). The local data store shall implement the functions as defined hereby for IUCHStore:

Object getValue(string Key)

Gets a stored value from the local data store (a map, see section Local Data Store).
key: Key (string) for the value.
Return value: Value stored under the given key. The caller may need to cast the returned object into the correct type. The return value is NULL if no entry exists for the given key.
   void setValue(string Key, Object Value)

Set a (new) value for the given key. If the key didn't exist in the map before, it will be created. If the key is already existing, the map stores the new value under the key, and the old value is lost.
key: Key (string) for the value.
value: value to be stored under the key.

### Interaction Between UIPM and UCH

### UIPM Loading and Unloading

In accordance with an embodiment, a UIPM may be retrieved from local or remote resources (e.g. resource server). The UCH should load a UIPM when the UIPM's set of applicable targets is a subset of the currently available targets in the UCH. The set of applicable targets is specified by the aggregation of all existing “http://myurc.org/ns/res#forTargetName” property values for a UIPM. The UCH may unload a UIPM at any time, but should call its finalize() function prior to unloading. A UCH should unload a UIPM if it is not applicable (anymore) to the current set of available targets. A UCH should unload a UIPM after the UIPM has called removeUIPM()

### API of UIPM (IUIPM)

### Mandatory Functions

void init(IUIPMListener uipmListener, Map uipmProps, Map uchProps) throws UIPMFatalException

In accordance with an embodiment, after a UIPM has been installed and loaded, the UCH shall call init() prior to any other UIPM function. This allows the UIPM to initialize itself.
uipmListener: Object in the UCH implementing the IUIPMListener interface (see section API of UIPM Listener (IUIPMListener)). The UIPM will call the uipmListener's functions to communicate with the UCH.
uipmProps: Property map for UIPM configuration. Additional (implementation-specific) properties may occur. See also section Property Map.
uchProps: Property map for the UCH. Additional (implementation-specific) properties may occur. See also section Property Map.
UIPMFatalException: In case the UIPM cannot initialize itself, it throws a
UIPMFatalException. In this case the UCH should call no function of the UIPM anymore, and may unload the UIPM (without calling finalize). The exception shall include a text string describing the problem that occurred.
   void Finalize()

Tells the UIPM to clean up its own memory. The UIPM does not need to clean up for the sessions or user interface items it has created within the UCH the UCH will take care about this itself. The UCH should call finalize() before it uninstalls or unloads the UIPM. However, finalize() shall not be called after init() has thrown a UIPMFatalException.

Map getUIPMProps()

Gets property map of the UIPM.
Return value: Property map for the UIPM at runtime. The UIPM shall return the uipmProps map it got when init() was called (see section void init(IUIPMListener uipmListener, Map uipmProps, Map uchProps) Throws UIPMFatalException), optionally with additional properties added. See also section Property Map.
   void targetDiscovered(string targetId) Throws UIPMFatalException

This function is called when a new target has been discovered after initialization of the UIPM.
targetId: Globally unique target instance identifier.
UIPMFatalException: The UIPM has encountered a problem that cannot be fixed, and needs to shut down. From now on, the UCH should call no function of the UIPM anymore, and may unload the UIPM (without calling finalize). The exception shall include a text string describing the problem that occurred.
   void targetDiscarded(string targetId) Throws UIPMFatalException

This function is called when a target has been discarded after initialization of the UIPM.
targetId: Globally unique target instance identifier.
UIPMFatalException: The UIPM has encountered a problem that cannot be fixed, and needs to shut down. From now on, the UCH should call no function of the UIPM anymore, and may unload the UIPM (without calling finalize). The exception shall include a text string describing the problem that occurred.
   void sessionForwardRequest(string sessionId, Map forwardInfo) Throws UIPMFatalException

The target requests the client (UIPM/controller) to open a session with a different socket. There are two types of forward requests: A “destructive forward request” asks the client to close the current session. A “spawn forward request” does not affect the current session.
sessionId: UCH-internal session identifier.
forwardInfo: Map (property-value pairs) with the following properties:
forwardType: “D”=destructive, “S”=spawn.
   NOTE: After a destructive forward request, the UIPM should close the current session by calling closeSession() see section void closeSession(string sessionId).
   targetId (shall be present if target instance identifier available): Same meaning as defined in section void sessionForwardRequest(string sessionId, Map forwardInfo).
   targetName (shall be present if target instance identifier not available): Same meaning as defined in section void sessionForwardRequest(string sessionId, Map forwardInfo).
   socketName (shall be present): Same meaning as defined in section void sessionForwardRequest(string sessionId, Map forwardInfo).
   authorizationCode (may be present): Same meaning as defined in section void sessionForwardRequest(string sessionId, Map forwardInfo).
UIPMFatalException: The UIPM has encountered a problem that cannot be fixed, and needs to shut down. From now on, the UCH should call no function of the UIPM anymore, and may unload the UIPM (without calling finalize). The exception shall include a text string describing the problem that occurred.
   void sessionAborted(string sessionId) Throws UIPMFatalException

The target has terminated a session (which may be in active or suspended mode).
sessionId: UCH-internal session identifier.
UIPMFatalException: The UIPM has encountered a problem that cannot be fixed, and needs to shut down. From now on, the UCH should call no function of the UIPM anymore, and may unload the UIPM (without calling finalize). The exception shall include a text string describing the problem that occurred.
   void updateValues(string[ ] sessionIds, string[ ] paths, string[ ] operations, string[ ] values, boolean[ ] hasDynRes) Throws UIPMFatalException

The target's status has changed, affecting one or more sessions. NOTE: The arrays paths, operations, values and hasDynRes shall be of the same size. NOTE: A UCH that watches dependencies may trigger an update for a variable that has a ‘calculate’ dependency defined if one if the parameters in its ‘calculate’ dependency has changed. The UCH may either add the update to the arrays as part of an “accumulated update”, or as a separate call to updateValues()
sessionIds: Array with UCH-internal session identifiers. The status change applies to all sessions that are included in the array.
paths: as specified in section void updateValues(string[ ] sessionIds, string[ ] paths, string[ ] operations, string[ ] values, boolean[ ] hasDynRes).
operations: as specified in section void updateValues(string[ ] sessionIds, string[ ] paths, string[ ] operations, string[ ] values, boolean[ ] hasDynRes).
values: as specified in section void updateValues(string[ ] sessionIds, string[ ] paths, string[ ] operations, string[ ] values, boolean[ ] hasDynRes).
hasDynRes: as specified in section void updateValues(string[ ] sessionIds, string[ ] paths, string[ ] operations, string[ ] values, boolean[ ] hasDynRes).
UIPMFatalException: The UIPM has encountered a problem that cannot be fixed, and needs to shut down. From now on, the UCH should call no function of the UIPM anymore, and may unload the UIPM (without calling finalize). The exception shall include a text string describing the problem that occurred.
   boolean isImplemented(string functionName)

This function allows the UCH to check whether any of the optional functions are implemented by the UIPM.

functionName: Any of the name of the optional functions below, without parentheses.

Return value: true=function implemented, false=function not available.

### Optional Functions

void controllerRequest(Object Request, Object Response) Throws UIPMFatalException

NOTE: The controllerRequest() function is currently specific to HTTP requests and responses. Future versions of this document may accommodate additional URI schemes. A UIPM may implement the controllerRequest() function. If it does not implement it, it shall not call the UCH's startUriService() function. The UCH calls controllerRequest() if it has received a request from a controller to a URI that the UIPM has claimed for itself by a previous call to startUriService() The UCH is responsible for creating the request and (partially empty) response objects prior to calling controllerRequest()
request: Request object (specific to programming language and URI scheme used), containing all information regarding the request that the controller sent.
   For Java implementations, the request object shall implement:
      javax.servlet.http.HttpServletRequest for the HTTP scheme [Java Servlet API]
      javax.servlet.ServletRequest for other URI schemes [Java Servlet API] For C/C++ implementations, the request object shall implement:
      A Map object with the following keys (values are strings):
         “RequestPath”: abs_path part of URL, as defined in [RFC 2616].
         “QueryString”: query part of URL, as defined in [RFC 2616].
         “RequestBody”: Post data (content) of an HTTP request
         Any general, request or entity header fields, as specified by [RFC 2616], [RFC 2109] or [RFC 2965]. Examples of field names: “Cache-Control”, “Connection”; “Accept”, “Accept-Charset”, “Accept-Encoding”, “Accept-Language”, “Authorization”, “User-Agent”; “Allow”, “Content-Encoding”, “Content-Language”, “Content-Type”, “Cookies”, “Set-Cookies”.
         For each header or entity field in the request, the UCH shall provide one key-value pair in the map, with the key being the header name (with the trailing ‘:’ being truncated), and the value being the exact content string as given for the header in the request (with the trailing line break being truncated).
         NOTE: [RFC 2109] is obsolete by [RFC 2965]. However, in practice, many implementations are still using [RFC 2109].
   For .NET/C# implementations, the request object shall implement:
      System. Net. HttpListenerRequest
response: Response object (specific to programming language and URI scheme used), containing information regarding the response to the controller.
   For Java implementations, the response object shall implement:
      javax.servlet.http.HttpServletResponse for the HTTP scheme [Java Servlet API]
      javax.servlet.ServletResponse for other URI schemes [Java Servlet API]
   For C/C++ implementations, the response object shall implement:
      A Map object with the following properties with string values:
         “ResponseBody”: Post data (content) for the HTTP response, as defined in [RFC 2616].
         “HttpStatus”: HTTP status code for the HTTP response, as defined in [RFC 2616].
         Any general, response or entity header fields, as specified by [RFC 2616], [RFC 2109] or [RFC 2965]. Examples of field names: “Cache-Control”, “Connection”; “Accept-Ranges”, “Age”, “Server”, “WWW-Authenticate”, “Authorization”; “Allow”, “Content-Encoding”, “Content-Language”, “Content-Type”, “Cookies”, “Set-Cookies”.
         For each key-value pair in the map, the UCH shall include a header field in the response, with the header being the key (a ‘:’ shall be appended by the UCH), and its content being the exact value string (a line break shall be appended by the UCH).
         NOTE: [RFC 2109] is obsolete by [RFC 2965]. However, in practice, many implementations are still using [RFC 2109].
   For .NET/C# implementations, the response object shall implement:
      System. Net. HttpListenerResponse
UIPMFatalException: The UIPM has encountered a problem that cannot be fixed, and needs to shut down. From now on, the UCH should call no function of the UIPM anymore, and may unload the UIPM (without calling finalize). The exception shall include a text string describing the problem that occurred.

API of UIPM Listener (IUIPMListener)

How to access the UCH (socket layer) from a UIPM.

### Mandatory Functions

string[ ] getAvailableTargetIds()

Get the identifiers of the available targets.

Return value: Array with globally unique target instance identifiers.

string getTargetName(string targetId)

Get the name (URI) of a target. Note that the target name is not necessarily unique within the UCH since there may be multiple copies of one target type (with the same target name). NOTE: The name (URI) of a target is the value of the ‘about’ attribute of the <target> element in a target description.

targetId: Globally unique target instance identifier.

Return value: Name (URI) of the target.

Map getTargetProps(string targetId)

Get a property map for a target.

targetId: Globally unique target instance identifier.
Return value: Property map of target at runtime. Additional (implementation-specific) properties may occur. See also section Property Map.
   string getTargetDescriptionUri(string targetName)

Get the URI for retrieving the target description.
targetName: Name (URI) of the target.
Return value: Absolute URI for the target description. The URI may point to a local or a global location, but must be resolvable.
   NOTE: The function getDocument() (see section string getDocument(string uri, string postData) throws UCH Exception) can be used to retrieve the actual Target Description document.
   string getDocument(string uri, string postData) Throws UCHException

Get description document through HTTP GET or POST (HTTP proxy function). Default values should be used for HTTP header data.

NOTE: getDocument() can be used to retrieve local or remote documents.
uri: URI of HTTP request (may include query parameters).
postData: Data for POST method as string. NULL if GET method requested.
Return value: Received document as string.
UCHException: An HTTP error occurred. Should contain the error message as text, e.g. “404 Not found”.
   string[ ] getSocketNames(string targetName)

Get the socket names (URIs) for a target type. Note that this is a convenience function for the UIPM since the socket names are specified in the target description.

targetName: Name (URI) of the target.

Return value: Array with socket names (URI) of the target type.

string getSocketDescriptionUri(string targetName, string socketName)

Get the URI for retrieving the socket description.
targetName: Name (URI) of the target.
socketName: Name (URI) of the socket.
Return value: Absolute URI for the socket description. The URI may point to a local or a global location, but must be resolvable.
   NOTE: The function getDocument()(see section string getDocument(string uri, string postData) throws UCH Exception) can be used to retrieve the actual Socket Description document. Strictly, targetName is not needed since a socket description is already identified by its socket name. However, UCH implementations may be simpler if they don't need to keep track of a cross-target list of socket names.
   string getSocketName(string sessionId)

Get the socket name (URI) for a specified session.

sessionId: UCH-internal session identifier.

Return value: socket name (URI).

string getSocketFriendlyName(string targetId, string socketName)

Get the friendly name for a socket on a target instance. This is a short, human-readable name for the socket, and may be user-configured.

NOTE: For example, the friendly name can be used as part of the URI for a user interface.socketName: name (URI) of the socket.

targetId: Globally unique target instance identifier.

Return value: Friendly name of the socket.

Map getLocators(string targetName)

Get a map with locator ids and locator types for a specific target type.

targetName: Name (URI) of the target.

Return value: Map with:
keys: locator ids (strings)
values: locator types (strings), one of {“audio”, “visual”, “other”} (see ISO/IEC 24752-4:2008, section 6.7).
   void invokeLocator(string targetId, string locatorId)

Invoke the specified locator function on the specified target. Note that it is not necessary to have a session open with the target.
targetId: Globally unique target instance identifier.
locatorId: ‘id’ attribute of the locator, as specified in returned map of getLocators()(see section Map getLocators(string targetName)).
   boolean is ElementAvailable(string targetId, string socketName, string eltId)

Check whether a specified socket element is available at runtime.

NOTE: Socket elements with an attribute optional=“true” may not be available at runtime. Other socket elements are always available.
targetId: Globally unique target instance identifier.
socketName: Name (URI) of a socket.
eltId: element identifier, as specified by the ‘id’ attribute of a socket element in the socket description.
   Return value: true=element available, false=element not available.
   Map[ ] getResources(string sessionId, Map[ ] resProps)

Get any kind of resource from the UCH. The UCH should relay the request to a resource server or TA if it cannot handle it locally (this is implementation-specific). The caller shall specify the properties of the requested resource as much as possible. A specific matching algorithm is implementation-specific. See also section Resources.
sessionId: UCH-internal session identifier. May be NULL (in which case dynamic atomic resources are not included in the returned result).
NOTE: sessionId should be specified by the caller, if available, since atomic resources that are dynamic can only be included in the result if the session is known by the UCH.
resProps: Map with Property-value pairs, duplicate properties with different values are allowed (they are interpreted as values that all need to be present on a resource, resulting in an implicit AND operation on the property values). Property names are URIs [RFC 3986].
   For atomic resources, an extensible set of RDF properties is defined in ISO/IEC 24752-5, Resource Description. Note that this assumes a flattened structure of an atomic resource description, for a single context only.
   Requests for atomic resources shall have a property “http://myurc.org/ns/res#type” with value “http://myurc.org/restypes#atomic”.
   For other resources, RDF properties and their URIs may be defined by other standards or documents, preferably under the URC Consortium.
EXAMPLE: The following map instance requests an English text label (atomic resource) for the value “true” of the ‘power’ element in the socket description “http://example.com/socket”, and the label being published by “MyCorp”.
Property=“http://myurc.org/ns/res#eltRef', [“http://example.com/socket#power”]
Property=“http://myurc.org/ns/res#role”, Values=[“http://myurc.org/ns/res#label”]
Property=“http://myurc.org/ns/res#forLang”, Values=[“en”]
Property=“http://myurc.org/ns/res#valRef, Values=[“true”]
Property=“http://purl.org/dc/elements/1.1/type”, Values=[“Text”]
Property=“http://purl.org/dc/elements/1.1/publisher”, Values=[“MyCorp”]
Note that the values in this map are arrays of strings. Thus multiple (ANDed) values can be assigned to one property, if appropriate.
Return value: Array of maps, each containing the requested resource (in their pertaining type—e.g. string for textual resource), and the complete set of metadata assigned to it. The maps are in the order of the requests (i.e. for every request item in the ‘resProps’ array, there shall be a response item in the returned array). If no match can be found for a request item, the corresponding response item shall be NULL.
   The actual resource object shall be assigned to the key “content” (in a platform-specific type reflecting the nature of the resource, e.g. string, image), or retrievable by URI reference (e.g. in “file:” format for locally stored files) given as value of the key “contentAt”. Note that it is up to the UCH to decide which resources to provide as object, and which to provide as URI reference (this may depend on the MIME type of the resource).
   Caching may apply in an implementation-specific way.
      Map openSessionRequest(IUIPM uipm, string targetId, string socketName, Map clientProps)

Request for opening a session with the specified target and socket.
uipm: UIPM object (caller) that is opening a session with the UCH.
targetId: Globally unique target instance identifier
socketName: Name (URI) of the socket that the UIPM wants to connect to.
clientProps: Property map of the client requesting a session opening. Additional (implementation-specific) properties may occur. See also section Property Map.
   Note that the property http://myurc.org/ns/res#authorizationCode may be used to convey an authorization code for opening the session. The authorization code may have been provided by a previous session that requested a forward to the specified socket.
Return value: Map (property-value pairs) with the following properties:
   result: “A”=accept, “R”=reject, “F”=forward.
   sessionId (shall be present if result=“A”): UCH-internal identifier for the new session.
   targetId or targetName (either one shall be present if result=“F”): as specified in section void sessionForwardRequest(string sessionId, Map forwardInfo).
   socketName (shall be present if result=“F”): as specified in section void sessionForwardRequest(string sessionId, Map forwardInfo).
   authorizationCode (may be present if result=“F”): as specified in section void sessionForwardRequest(string sessionId, Map forwardInfo).
      void closeSession(string sessionId)

The UIPM closes a session with the UCH.

sessionId: UCH-internal session identifier.

Map getValues(string sessionId, string[ ] paths)

The UIPM asks for the values/states of specified socket elements or components thereof.
sessionId: UCH-internal session identifier.
paths: Array of paths, each item of any of the forms specified in section Paths.
Return value: Map containing path-values corresponding (in their order) to the elements of argument paths. However, invalid paths shall be omitted in the returned map.
   Object[ ] getIndices(string sessionId, string[ ] eltIds, integer[ ] indexNos)

The UIPM asks for the available values for a particular index of a dimensional socket element or set.
sessionId: UCH-internal session identifier.
   eltIds: Array of element ids (‘id’ attribute values of socket elements or sets).
   indexNos: Array of 0-based index numbers (0 specifies the first index). Note that the index number refers to the dimensions of a single socket element or set, not to its path (i.e. indices of dimensional ancestor sets do not count here).
      EXAMPLE: A set with id=“set” and dim=“xsd:integer xsd:string” has two indices. getIndices(sessionId, [“set”], [1]) would request the available values for the second index (which is of type xsd:string).
   Return value: Array with index ranges, each array item corresponding (in their order) to the elements of arguments ‘eltIds’ and ‘indexNos’. Each item shall be either NULL (for an invalid eltIds item or indexNos item) or an array containing the requested index values as items, which should be in ascending order as specified by their pertaining types, if applicable.
   NOTE: This function looks at the actual value for a specific index of a socket element, isolated from other indices that are part of all actual paths for the given element. For sparse arrays, the index value may not occur in any possible combination with values of other indices.
      Map setValuesRequest(string sessionId, string[ ] paths, string[ ] operations, string[ ] reqValues)

The UIPM requests to change the target state in one or more operations on specified socket elements or components thereof. The requested operations are coded as cross-indexed arrays of paths, operation identifiers and requested new values. “Cross-indexed” means that array elements with the same index belong together.

NOTE: The UCH may validate the requests and block those that would violate a socket element's type or dependencies (see section boolean setValidation(ITA ta, boolean activate), setValidation function). Blocking means that the UCH removes invalid requests before passing them on to the pertaining TA.
sessionId: UCH-internal session identifier.
paths: Array of paths, each item of any of the forms specified in section Path. This array is cross-indexed with the values and the operations array, i.e. they have the same size, and items with the same index are corresponding.
operations: Array of operation codes. The following codes are allowed:
   “S”=set value of variable or local command parameter (not with path for command state, and not referencing a notification)
   “A”=add indices (only with path with given indices)
   “R”=remove indices (only with path without indices, path with given indices)
   “I”=invoke (only with path for command state). Pertaining local parameters shall be, and global parameters may be specified by preceding array elements (with an “S” operation) of the same call.
   “K”=acknowledge (only with path without indices, or path with given indices, referencing a notification)
   NOTE: Invalid operation codes and operation codes that are not applicable to the pertaining paths should be ignored by the UCH.
reqValues: Array of requested values, as strings. Corresponding items for operation “A” (add indices) may be NULL. Corresponding items for operations “R” (remove indices) and “K” (acknowledge) shall be NULL.
Return value: Map contains all path-values that were updated in response to the request, but only those that occurred in-session to parameter ‘sessionId’. This includes new values for variables, new states for commands, and new states for notifications. Note that the indices of the returned map do not necessarily correspond to the indices of the arguments path, operations and reqValues.
   NOTE: Out-of-session changes may be propagated to the UIPM through updateValues() even before setValuesRequest() has been finished().
      string getipAddress()

Get the IP address of the UCH. A UIPM may need this information to set up its own listener for a port that is not serviced by the UCH.

Return value: ip address of UCH as string.

string startUriService(IUIPM uipm, string scheme, int port, boolean portIsFlexible, string basePath, boolean basePathIsFlexible) Throws UCHException

The UIPM requests the UCH to start servicing a URI which is made up of a given scheme, port, and base path. If successful, the UCH will forward all messages that have this URI as its base, to controllerRequest(). If the UIPM indicates that the base path is flexible, the UCH can modify the base path in case it is not available any more.

NOTE: This function does not advertise the URI through its UI List a separate call to addCompatibleUI() is needed for that.
uipm: UIPM object (caller) that is requesting service for a URI with the UCH. The controllerRequest() function of this object will be called upon a controller request to the specified URI.
scheme: URI scheme, such as “http”, “ftp”, “urn”, “vnc”, etc.
port: number of port for listening to controller requests. 0 if no preference for port number.
portIsFlexible: true if the UCH may modify the port number, otherwise false. Must be true if parameter port is 0.
basePath: base path for the URI, e.g. “/UCH/flash”.
basePathIsFlexible: true indicates that the UCH may modify the base path in case the specified path is already taken. false indicates that the UCH may not modify the base path if the path is already taken the function returns NULL.
Return value: URI for which the UCH has started service for the UIPM (e.g. “http://192.168.0.10/UCH/URC/”). If the URI is based on a hierarchical folder system, the URI shall end with a folder delimiter (‘/’ in case of http and ftp). Note that, if the path is flexible, the path may have been modified by the UCH (e.g. modify “Flash” to “Flash01”, etc.). Returns NULL if the UCH cannot service the specified URI.
UCHException: Invalid request.
   void stopUriService(string uri) Throws UCHException

The UIPM requests the UCH to stop servicing a URI that was requested to be serviced in a previous call to startUriService()
uri: URI that the UCH is requested to stop servicing. URI has been returned by the UCH in a previous call to startUriService().
UCHException: Invalid request.

boolean addCompatibleUI(string targetId, string[ ] socketNames, string protocolShortName, string[ ] uris, Map protocolInfo) Throws UCHException

Tell the UCH to add a user interface item (advertised by the UIPM) to its UIList (see section UIList) which is exposed to controllers on request. If the UIPM wants to advertise multiple user interfaces at the same time, it needs to call addCompatibleUI() multiple times.
targetId: Globally unique target instance identifier for the target that the UI controls. Value “all” allowed if the UI controls all target instances together. If the UI is for a subset of available target instances, addCompatibleUI() has to be called multiple times, once for each targetId.
   NOTE: The value “all” is not allowed in conjunction with a protocolShortName of “URC-HTTP”.
socketNames: Names (URIs) of the sockets that the UI connects to. Empty array if the UI connects to all available sockets.
   NOTE: An empty array of socket names is represented as element content “all” for <socketName> in the UIList (see section UIList).
protocolShortName: Short name for the UI protocol used, to be used as value of the ‘shortName’ attribute of the <protocol> element in the UIList [UPnP RUI].
   Examples: “URC-HTTP”, “HTTP/HTML”, “CE-HTML-1.0”, “VNC”.
uris: URIs for controllers to communicate with the UIPM (e.g. opening a control session). All URIs shall contain identical scheme, port and base URL (that was previously assigned to the UIPM by the UCH, see section string startUriService(IUIPM uipm, string scheme, int port, boolean portIsFlexible, string basePath, boolean basePathIsFlexible)). The UCH will include the URIs in the UIList as element content of the <uri> tags [UPnP RUI].
protocolInfo: Map with property-value pairs to be advertised by the UCH as subelements of the <protocolInfo> element in a UIList (see section UIList). Property names shall be strings, each reflecting the tag name of a pertaining XML element (default namespace assumed). Values shall be strings. The default rules for properties names (see section Property Names) do not apply to protocolInfo.
Return value: true=UCH has added UI to UIList.false=UCH could not add the UI to the UIList.
UCHException: Invalid request.

The UCH shall map these parameter values to an entry in the UIList (see section UIList) as follows:
<uiID> contains the targetId. The UCH shall merge multiple calls to addCompatibleUI() with the same targetId into one <uiID> block (with separate <protocol> subelements for each call).
<name> contains the friendly name of the target, if provided by the TDM in targetDiscovered() (as value of property http://myurc.org/ns/res#friendlyName in targetProps); otherwise the target's label as defined for the corresponding targetName (URI). If provided, the target's label should accommodate the user's language preferences (see section User-Preferred Language).
   NOTE: The friendly name of a target is a human-readable name of the target instance.
   This is typically a user-configurable label, such as “bedroom TV”.
The ‘uris’ parameter shall result in one or multiple <uri> elements, each containing one URI for the protocol.
<targetName> shall contain the name (URI) of the target with the specified targetId.
<socketName> shall provide the names of the involved sockets (if any), as given by the socketNames parameter. If no socket name is provided, no <socketName> element shall exist. If multiple socket names are provided, multiple <socketName> elements shall exist. The ‘friendlyName’ attribute on each <socketName> element may bear the ‘id’ attribute value of the corresponding <socket> element in the target description. Alternatively, it may bear an atomic resource label for the socket (in which case it should match the user-preferred language, see section User-Preferred Language).
Other subelements of <protocolInfo> shall be included, as specified in the protocolInfo map argument.
   void removeCompatibleUI(string[ ] uris) Throws UCHException

Tells the UCH to remove user interface URIs from the UIList that were previously added by one call to addCompatibleUI(). Note that the UCH may have to remove the pertaining <protocol> or <ui> element from the UList if no <uni> element is remaining in it.
uris: array of URIs to pull from the UIList. This must be identical as used for a previous call to addCompatibleUI().
UCHException: Invalid URIs. The exception shall include a text string describing the problem that occurred.
   IUCHStore getLocalUCHStore()

Get the local UCH store (a map, see section Local Data Store).

Return value: Local UCH Store.

Map getUCHProps()

Get property map of the UCH.
Return value: Property map for the UCH at runtime. Additional (implementation-specific) properties may occur.
   boolean isImplemented(string functionName)

This function allows the UIPM to check whether any of the optional functions are implemented by the UIPMListener.

functionName: Any of the name of the optional functions below, without parentheses.

EXAMPLE: “validateValue”.

Return value: true=function implemented, false=function not available.

### Optional Functions

boolean validateValue(string sessionId, string path, string value) Throws UCHNotImplementedException

The UCH validates a given value for a given path with regard to the pertaining XSD type, or runtime constraints by dependencies. The following runtime constraints are considered: length, minLength, maxLength, pattern, minInclusive, maxInclusive, minExclusive, maxExclusive.
sessionId: UCH-internal session identifier.
path: Path of a pertaining socket variable or local parameter (or component thereof), as specified in section Paths.
value: Value to be checked against the variables/parameter's type and runtime constraints.
Return value: true=valid value, false=invalid value.
UCHNotImplementedException: Thrown if UCH does not support this function.
   boolean getDependencyValue(string sessionId, string path, string dependency) Throws UCHNotImplementedException

Get the actual value of a dependency, pertaining to a socket set or element. NOTE: This function does not work for ‘calculate’ dependencies. See function updateValues() in section void updateValues(string[ ] sessionIds, string[ ] paths, string[ ] operations, string[ ] values, boolean[ ] hasDynRes) for how a UCH may use the ‘calculate’ dependency.
sessionId: UCH-internal session identifier.
path: Path of a pertaining socket set or element (or component thereof), as specified in section Paths.
dependency: One of the following strings:
“relevant”
“write”
“insert” (only allowed if path specifies a dimensional set or element)
Return value: Current value of the specified dependency. NULL if ‘insert’ dependency asked for a non-dimensional set of element.
UCHNotImplementedException: Thrown if UCH does not support this function.
   string getElementRef(string sessionId, string path) Throws UCHNotImplementedException

Get the elementRef URI that points to a particular socket element/set. The elementRef can be used as part of the query for the label of the socket element/set, see function getResources(), section Map[ ] getResources(string sessionId, Map[ ] resProps).

NOTE: This is a convenience function for light-weight UIPMs.
sessionId: UCH-internal session identifier.
path: Path of a pertaining socket set or element (or component thereof), as specified in section Paths.
Return value: URI pointing to the socket element/set, consisting of a domain URI and the element's identifier (as fragment identifier), separated by a ‘#’ character.
   EXAMPLE: “http://example.com/socket#power”.
      boolean is SessionSuspendable(string sessionId) Throws UCHNotImplementedException

Asks whether the given session can be suspended.

sessionId: UCH-internal session identifier.

Return value: true=session can be suspended, false=session cannot be suspended.

UCHNotImplementedException: Thrown if UCH does not support this function.

long suspendSession(string sessionId, long suggestedTimeout) Throws UCHNotImplementedException

The target is requested to suspend the given session with a suggested timeout value.
sessionId: UCH-internal identifier of an active session (not already suspended).
suggestedTimeout: Timeout (in seconds) the UIPM suggests indicating a time period for the target to keep the session for subsequent resume operation.
Return value: Tentative timeout (in seconds) from the target/0 if the target has rejected the request. The target intends to hold the session for subsequent resume operation for the timeout period. However, this is not a guaranteed value the target may terminate the session at any time for any reason.
UCHNotImplementedException: Thrown if UCH does not support this function.
   boolean is SessionResumable(string sessionId) Throws UCHNotImplementedException

Asks whether the given session can be resumed.

sessionId: UCH-internal session identifier.

Return value: true=session can be resumed, false=session cannot be resumed.

UCHNotImplementedException: Thrown if UCH does not support this function.

boolean resumeSession(string sessionId) Throws UCHNotImplementedException

The target is requested to resume the given session.
sessionId: UCH-internal identifier of a suspended session.
Return value: true=session resumed, false=session could not be resumed. If false, the session has terminated, and the UIPM shall not call resumeSession() or closeSession() any more on this session.
UCHNotImplementedException: Thrown if UCH does not support this function.
   void removeUIPM(IUIPM uipm)

The UIPM requests the UCH to be finalized and unloaded. UIPMs should call this function if they cannot operate anymore because of the currently available set of targets or other reasons. The UCH may follow this request. In any case, the UCH shall call finalize() on the UIPM before it unloads the UIPM.

uipm: UIPM object (caller) that wants to be removed.

### Interaction Between Target Discovery Module (TDM) and UCH

A Target Discovery Module (TDM) is responsible for discovering targets and providing information on discovered targets to the UCH. A TDM may be specific for a single target, or generic for a whole class of targets (e.g. UPnP targets).

TDM Loading and Unloading

A TDM may be retrieved from local or remote resources (e.g. resource server). Loading of a TDM is out of scope for this specification. The UCH may load a Target Discovery Module (TDM) in a proprietary way, for example as part of the executable file, or as shared library referenced by a configuration file. The UCH may unload a TDM at any time, but should call its finalize() function (section void finalize() prior to unloading. The UCH should unload a TDM after the TDM has called removeTDM()(see section void removeTDM(ITDM tdm)).

### Target Discovery Module Interface (ITDM)

This section specifies how the UCH will communicate with a TDM once it is installed and loaded into the application.

### Mandatory Functions

void init(ITDMListener tdmListener, Map tdmProps, Map uchProps) throws TDMFatalException

After the TDM has been installed and loaded, the UCH calls init() prior to any other TDM function. This allows the TDM to initialize itself. Note that discovery of targets shall only start upon calling startDiscovery().
tdmListener: Object in the UCH implementing the ITDMListener interface (see section Target Discovery Manager Listener). The TDM will call the tdmListener's functions to communicate with the UCH.
tdmProps: Property map for TDM. Additional (implementation-specific) properties may occur. See also section Property Map.
uchProps: Property map for the UCH. Additional (implementation-specific) properties may occur.
TDMFatalException: In case the TDM cannot initialize itself, it throws a TDMFatalException. In this case the UCH should call no function of the TDM anymore, and may unload the TDM (without calling finalize). The exception shall include a text string describing the problem that occurred.
   void finalize()

The UCH should call finalize() before it uninstalls or unloads the TDM. However, finalize() shall not be called after init() has thrown a TDMFatalException.

The UCH should call stopDiscovery() prior to finalize(). In any case, the TDM shall stop discovery upon finalize() is called.
Map getTDMProps()

Get property map of the TDM.
Return value: Property map for the TDM at runtime. This shall be the tdmProps map it got when init() was called (see section void init(ITDMListener tdmListener, Map tdmProps, Map uchProps) Throws TDMFatalException), optionally with additional properties added. See also section Property Map.
   void startDiscovery() Throws TDMFatalException

This function signals the TDM to start discovery of targets, until stopDiscovery() is called. Shall be ignored if the TDM is already in target discovery mode.

NOTE: The TDM will now look for new and disappearing targets, until either stopDiscovery() or finalize() is called.
TDMFatalException: In case the TDM encounters an error condition that prevents discovery and cannot be fixed, it throws a TDMFatalException. In this case the UCH should call no function of the TDM anymore, and may unload the TDM (without calling finalize). The exception includes a text string describing the problem that occurred.
   void stopDiscovery() Throws TDMFatalException

This function signals the TDM to stop discovery of targets, until startDiscovery() is called. Shall be ignored if the TDM is not in target discovery mode.
TDMFatalException: The TDM has encountered an error condition that cannot be fixed. In this case the UCH should call no function of the TDM anymore, and may unload the TDM (without calling finalize). The exception includes a text string describing the problem that occurred.

### Optional Functions

void targetRequest(Object request, Object response) Throws TDMFatalException

NOTE: The targetRequest() function is currently specific to HTTP requests and responses. Future versions of this document may accommodate additional URI schemes. A TDM may implement the targetRequest() function. If it does not implement it, it shall not call the UCH's startUriService() function. The UCH calls targetRequest() if it has received a request from a target to a URI that the TDM has claimed for itself by a previous call to startUriService(). The UCH is responsible for creating the request and response objects prior to calling targetRequest(). The request and response parameters of targetRequest() have exactly the same meaning as the request and response parameters of controllerRequest() respectively (see section void controllerRequest(Object request, Object response) throws UIPMFatal Exception).

### Target Discovery Manager Listener Interface (ITDMListener) Mandatory Functions

string targetDiscovered(Map targetProps, Map taProps)

A TDM has discovered a new target, and provides information on the discovered target, and on the target adapter to be loaded for it. In response, the UCH will install and load an appropriate Target Adapter (TA) for the new target. If the corresponding TA is already installed (same identifier), the new target shall be registered with the already installed TA.
targetProps: Property map for the target at runtime. Any property as specified for Targets may be present, but none is required by the TDM (the TA is responsible for completing the missing properties later, though). Additional (implementation-specific) properties may occur. Note that targetProps should contain adequate information for registering the target with the Target Adapter so that it can uniquely identify and connect to it in a network. See also section Property Map.
taProps: Property map for target adapter (TA) that should help the UCH to find an appropriate TA at runtime. Any property as specified for TAs may be present, but none is required (since these properties are used for querying a TA). Other (implementation-specific) properties may occur.
   Special case: If the property http://myurc.org/ns/res#name is present, the UCH shall retrieve and use the TA with the given identifier (no need for querying).
Return value: The UCH shall return the targetId (string) that it has assigned the newly discovered target. This may be identical to the property ‘http://myurc.org/ns/res#instanceld’ in targetProps, if globally unique. NULL if the UCH does not instantiate a Target Adapter for this target, and does not want to be notified when the target will be discarded.
   NOTE: The TDM is responsible for storing the targetId for the discovered target. It will be needed for signaling the disappearance of the target via the function targetDiscarded().
      void targetDiscarded(string targetId)

A TDM calls this function when a target has disappeared from the network. Depending on the target and its networking platform, this can mean that the target was powered off, or just disconnected from the network.

targetId: Globally unique target instance identifier

IUCHStore getLocalUCHStore()

Get the local UCH store (a map, see section Local Data Store).

Return value: Local UCH Store.

string getIpAddress()

Get the IP address of the UCH. A TDM may need this information to set up its own listener for a port that is not serviced by the UCH.

Return value: ip address of UCH as string.

string startUriService(ITDM tdm, string scheme, int port, boolean portIsFlexible, string basePath, boolean basePathIsFlexible) Throws UCHException

The TDM requests the UCH to start servicing a URI which is made up of a given scheme, port, and base path. If successful, the UCH will forward all messages that have this URI as its base, to targetRequest(). If the TDM indicates that the base path is flexible, the UCH can modify the base path in case it is not available any more.
tdm: TDM object (caller) that is requesting service for a URI with the UCH. The targetRequest() function of this object will be called upon a request to the specified URI.
scheme: URI scheme, such as “http”, “ftp”, “urn”, “vnc”, etc.
port: number of port for listening to requests. 0 if no preference for port number.
portIsFlexible: true if the UCH may modify the port number, otherwise false. Must be true if parameter port is 0.
basePath: base path for the URI.
basePathIsFlexible: true indicates that the UCH may modify the base path in case the specified path is already taken. false indicates that the UCH may not modify the base path if the path is already taken the function returns NULL.
Return value: URI for which the UCH has started service for the TDM (e.g. “http://192.168.0.10/TDM/”). If the URI is based on a hierarchical folder system, the URI shall end with a folder delimiter (‘/’ in case of http and ftp). Note that, if the path is flexible, the path may have been modified by the UCH (e.g. modify “TDM” to “TDM01”, etc.). Returns NULL if the UCH cannot service the specified URI.
UCHException: Invalid request.
   void stopUriService(string uri) Throws UCHException

The TDM requests the UCH to stop servicing a URI that was requested to be serviced in a previous call to startUriService()
uri: URI that the UCH is requested to stop servicing. URI has been returned by the UCH in a previous call to startUriService().
UCHException: Invalid request.

Map[ ] getResources(string sessionId, Map[ ] resProps)

Same as function IUIPMListener.getResources(), see section Map[ ] getResources(string sessionId, Map[ ] resProps).

string getDocument(string uri, string postData) Throws UCHException

Same as function IUIPMListener.getDocument(), see section string getDocument(string uri, string postData) Throws UCH Exception.

Map getUCHProps()

Get property map of the UCH.
Return value: Property map for the UCH at runtime. Additional (implementation-specific) properties may occur.
   boolean isImplemented(string functionName)

This function allows the TDM to check whether any of the optional functions are implemented by the TDMListener.

functionName: Any of the name of the optional functions below, without parentheses.

EXAMPLE: “removeTDM”.

Return value: true=function implemented, false=function not available.

### Optional Functions

void removeTDM(ITDM tdm)

The TDM requests the UCH to be finalized and unloaded. TDMs should call this function if they cannot operate anymore because of external events or other reasons. The UCH may follow this request. In any case, the UCH shall call finalize() on the TDM before it unloads the TDM.

tdm: TDM object (caller) that wants to be removed.

### Interaction Between Target Adapter and UCH

In accordance with an embodiment, a Target Adapter (TA) represents one or multiple targets to the UCH. It is being installed and loaded upon the discovery of a first target that it can represent. The UCH will register new targets with the TA as they are discovered by the TDM; and unregister after they have disappeared. After having opened a session on a target's socket, the TA is responsible for managing the values of the pertaining socket instance. NOTE: Target registration (and un-registration) is a separate step because one TA may represent multiple targets. Also, one target (type) may occur as multiple instances in a network (with different targetIds) the associated TA must be able to deal with this situation.

### TA Loading and Unloading

A TA may be retrieved from local or remote resources (e.g. resource server).

The UCH should load a TA when the TA's properties match the set of properties provided by a TDM upon target discovery (see section string targetDiscovered(Map targetProps, Map taProps)). The UCH may unload a TA at any time, but should call its finalize() function (section void finalize() prior to unloading. A UCH should unload a TA if it has no targets registered (anymore). A UCH should unload a TA after the TA has called removeTA() (see section void removeTA(ITA ta)).

### Target Adapter Interface (ITA)

### Mandatory Functions

void init(ITAListener taListener, Map taProps, Map uchProps) Throws TAFatalException

When the TA is installed and loaded, the UCH calls init() prior to any other TA function. This allows the TA to initialize itself. Note that the observation of a specific target needs a separate function call, i.e. registerTarget().

NOTE: The UCH shall be prepared for the TA calling functions of the TA Listener during the execution of init(). For example, the TA may call setValidation (see section boolean setValidation(ITA ta, boolean activate)) to set the validation mode of the UCH.
taListener: Object in the UCH implementing ITAListener interface (see section Target Adapter Listener). The TDM will call the tdmListener's functions to communicate with the UCH.
taProps: Property map for TA configuration. Additional (implementation-specific) properties may occur. See also section Property Map.
uchProps: Property map for the UCH. Additional (implementation-specific) properties may occur. See also section Property Map.
TAFatalException: In case the TA cannot initialize itself, it throws a TAFatalException. In this case the UCH should call no function of the TA anymore, and may unload the TA (without calling finalize). The exception shall include a text string describing the problem that occurred.
   void finalize()

The UCH should call finalize() before it uninstalls or unloads the TA. However, finalize() shall not be called after init() has thrown a TAFatalException.

If the UCH has targets registered with a TA (see section void registerTarget(string targetId, Map targetProps) Throws TAException, TAFatalException), it should unregister them (see section void unregisterTarget(string targetId) Throws TAFatalException) prior to calling finalize(). In any case, the TA shall unregister all targets when finalize() is called.
Map getTAProps()

Get property map of the TA.
Return value: Property map for the TA at runtime. This shall be the taProps map it got when init() was called (see section void init(ITAListener taListener, Map taProps, Map uchProps) throws TAFatalException), optionally with additional properties added. See also section Property Map.
   void registerTarget(string targetId, Map targetProps) Throws TAException, TAFatalException

The TA gets a mandate to represent a given target with a given targetId. From now on, until unregister() is called for this target, the TA shall expose the target's sockets to the UCH.
targetId: Globally unique target instance identifier. The TA is responsible for remembering the targetId in connection with the specific target.
targetProps: Property map for target, as passed on by the TDM that discovered the target (see section string targetDiscovered(Map targetProps, Map taProps)).
TAException: If the TA, for any reason, cannot find or connect to the target, it throws a TAException. In this case the UCH may try to register the target with a different TA. The exception shall include a text string describing the problem that occurred.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   void unregisterTarget(string targetId) Throws TAFatalException

Stop exposing a target to the UCH. This function is typically called when a target has disappeared from the network. If sessions are open on this target, the TA shall close these sessions (via sessionAborted, see section Target Adapter Listener Interface (ITAListener)) prior to returning from unregisterTarget.
targetId: Globally unique target instance identifier.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   string[ ] getRegisteredTargetIds() Throws TAFatalException

Get the target identifiers that the TA is currently representing.
Return value: Array with Globally unique target instance identifiers.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   Map getLocators(string targetName)

Get a map with locator ids and locator types for a specific target type.

targetName: Name (URI) of the target.

Return value: Map with:
keys: locator ids (strings)
values: locator types (strings), one of {“audio”, “visual”, “other”} (see ISO/IEC 24752-4:2008, section 6.7).
   void invokeLocator(string targetId, string locatorId) Throws TAException, TAFatalException

Invoke the specified locator function on a target. This requires a prior call to registerTarget on this target. But it is not necessary to have a session open with this target.
targetId: Globally unique target instance identifier.
locatorId: ‘id’ attribute of the locator, as specified in Target Description
TAException: If the TA, for any reason, cannot find or trigger the locator, it throws a TAException. The exception shall include a text string describing the problem that occurred.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   string getTargetName(string targetId) Throws TAFatalException

Get the name (URI) of a target. Note that there may be multiple copies of targets (different targetIds) with the same target name.
targetId: Globally unique target instance identifier.
Return value: Name (URI) of the target.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   string getTargetDescriptionUri(string targetName) Throws TAFatalException

Get the URI for retrieving the target description.
targetName: Name (URI) of the target.
Return value: URI for the target description. The URI may point to a local or a global location, but must be resolvable. If relative, its base shall be the base URL of the location where the TA was retrieved from (implementation-specific).
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   Map getTargetProps(string targetId) Throws TAFatalException

Get the target's properties.
targetId: Globally unique target instance identifier.
Return value: Property map for target. Additional (implementation-specific) properties may occur. Note that the TA may have to complete the properties map it got from the TDM via registerTarget (see section void registerTarget(string targetId, Map targetProps) throws TAException, TAFatalException) by adding required properties. See also section Property Map.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   string[ ] getSocketNames(string targetName) Throws TAFatalException

Get the names (URIs) of a target's sockets.

NOTE: This function is provided for the convenience of light-weight UCHs. In general, a UCH could glean this information from the Target Description.
targetName: Name (URI) of the target.
Return value: Array with the names (URIs) of the target's sockets.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   string getSocketName(string sessionId) Throws TAFatalException

Get the socket name (URI) for a specified session.
sessionId: UCH-internal session identifier.
Return value: socket name (URI).
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   string getSocketFriendlyName(string targetId, string socketName)

Get the friendly name for a socket. This is a short, human-readable name for the socket, and may be user-configured.

NOTE: A TA may use the id attribute value of the <socket> element in the target description as the socket's friendly name.

targetId: UCH-internal target identifier.

socketName: name (URI) of the socket.

Return value: Friendly name of the socket.

string[ ] getSessionIds(string targetId, string socketName) Throws TAFatalException

Get the set of session identifiers for a given socket name (URI).
targetId: Globally unique target instance identifier. Note that this is needed since the TA may represent multiple targets of the same kind.
socketName: Socket name (URI).
Return value: Array with UCH-internal session identifiers.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   string getSocketDescriptionUri(string targetId, string socketName) throws TAFatalException

Get the URI for retrieving the socket description.
targetId: Globally unique target instance identifier.
socketName: Name (URI) of a socket.
Return value: URI for the socket description. The URI may point to a local or a global location, but must be resolvable. If relative, its base shall be the base URL of the location where the TA was retrieved from (implementation-specific).
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   Map openSessionRequest(string targetId, string socketName, Map clientProps) Throws TAFatalException

The UCH asks for permission to open a session with a specified client on a specified socket. Note that this function asks for permission only, and is not supposed to actually open a session.
targetId: Globally unique target instance identifier
socketName: Name (URI) of the socket that the client wants to connect to
clientProps: Property map for the client requesting a session opening, with properties as defined in section Map openSessionRequest(IUIPM uipm, string targetId, string socketName, Map clientProps).
Return value: Map (property-value pairs) with the following properties:
   result: “A”=accept, “R”=reject, “F”=forward.
   targetId or targetName (either targetId or targetName shall be present if result=“F”). Same meaning as specified in section void sessionForwardRequest(string sessionId, Map forwardInfo).
   socketName (shall be present if result=“F”): Same meaning as defined in section void sessionForwardRequest(string sessionId, Map forwardInfo).
   authorizationCode (may be present if result=“F”): Same meaning as defined in section void sessionForwardRequest(string sessionId, Map forwardInfo).
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   void sessionOpened(string targetId, string sessionId, string socketName, Map clientProps) Throws TAFatalException

If the TA has accepted an open session request (see above), and if the UCH succeeded in the necessary steps to open a session with the client, the UCH will call sessionOpened and provide the sessionId pertaining to the new session.
targetId: Globally unique target instance identifier
sessionId: UCH-internal session identifier assigned to the new session. The TA should remember the session identifier for future references.
socketName: Name (URI) of the socket that the session is created upon.
clientProps: Property map for the client requesting a session opening, with properties as specified in section Map openSessionRequest(IUIPM uipm, string targetId, string socketName, Map clientProps).
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   void sessionClosed(string sessionId) Throws TAFatalException

The UCH signals the TA that a session has been closed with one of the TA's targets, caused by a UIPM or the UCH itself (e.g. due to session timeout). The TA should do the necessary clean-up internally and with the target.
sessionId: UCH-internal session identifier.
   NOTE: From now the TA can forget the sessionId, since it will not be used by the UCH anymore.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   Map setValuesRequest(string sessionId, boolean is Validated, string[ ] paths, string[ ] operations, string[ ] reqValues) Throws TAFatalException

The client requests to change the target state in one or more operations on specified socket elements or components thereof. The requested operations are coded as cross-indexed arrays of paths, operation identifiers and requested new values. “Cross-indexed” means that array elements with the same index belong together.
sessionId: UCH-internal session identifier.
paths: Array of paths, each item of any of the forms specified in section Path. This array is cross-indexed with the values and the operations array, i.e. they have the same size, and items with the same index are corresponding.
operations: Array of operation codes. The following codes are allowed:
   “S”=set value (not with path for command state, and not referencing a notification)
   “A”=add indices (only with path with given indices)
   “R”=remove indices (only with path without indices, path with given indices)
   “I”=invoke (only with path for command state)
   “K”=acknowledge (only with path without indices, or path with given indices, referencing a notification)
   NOTE: Invalid operation codes and operation codes that are not applicable to the pertaining paths should be ignored by the TA.
reqValues: Array of requested values, as strings. Corresponding items for operation “A” (add indices) may be NULL. Corresponding items for operations “R” (remove indices) and “K” (acknowledge) shall be NULL.
Return value: Map contains all path-values that were updated in response to the request, including new values for variables, new states for commands, and new states for notifications. Note that the indices of the returned map do not necessarily correspond to the indices of the arguments path, operations and reqValues.
   NOTE: When a TA changes the session's state in response to a setValuesRequest() call, it should report these changes through the return value of setValuesRequest().

The TA should not call updateValues() (see section void updateValues(string[ ] sessionIds, string[ ] paths, string[ ] operations, string[ ] values, boolean[ ] hasDynRes)) before setValuesRequest() has finished. Exception: If the call to setValuesRequest() triggers changes to other sessions, these (but only these) may be propagated through updateValues() before setValuesRequest() has finished.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   Map getValues(string sessionId, string[ ] paths) Throws TAFatalException

The client asks for the values/states of specified socket elements or components thereof.
sessionId: UCH-internal session identifier.
paths: Array of paths, each item of any of the forms specified in section Paths.
Return value: Map containing path-values corresponding (in their order) to the elements of argument paths. However, invalid paths shall be omitted in the returned map.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   Object[ ] getIndices(string sessionId, string[ ] eltIds, integer[ ] indexNos)

The UCH asks for the available values for a particular index of a dimensional socket element or set.

See section Object[ ] getIndices(string sessionId, string[ ] eltIds, integer[ ] indexNos).
Map[ ] getDynRes(string sessionId, Map[ ] resProps) Throws TAFatalException

Get a dynamic atomic resource from the TA, pertaining to a given session. The UCH shall specify the properties of the requested resource as much as possible. A specific matching algorithm is implementation-specific. See also section Resources.
sessionId: UCH-internal session identifier.
resProps: Property map for resource query. Duplicate properties with different values are allowed (they are representing ANDed values for the resource query). See parameter ‘resProps’ in function getResources (section Map[ ] getResources(string sessionId, Map[ ] resProps)) for details. Note that, for dynamic resources, type definitions are not allowed to be referenced through property “http://myurc.org/ns/res#eltRef”.
Return value: Array of maps, each containing the requested dynamic resource (in their pertaining type—e.g. string for textual resource), and the complete set of metadata assigned to it. The maps are in the order of the requests (i.e. for every request item in the ‘resProps’ array, there shall be a response item in the returned array). If no match can be found for a request item, the corresponding response item shall be NULL.
   The actual dynamic resource object shall be assigned to the key “content” (in a platform-specific type reflecting the nature of the resource, e.g. string, image), or retrievable by URI reference (e.g. in “file:” format for locally stored files) given as value of the key “contentAt”. Note that it is up to the TA to decide which resources to provide as object, and which to provide as URI reference (this may depend on the MIME type of the resource).
   Caching may apply in an implementation-specific way.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   boolean is ElementAvailable(string targetId, string socketName, string eltId) throws TAFatalException

This function allows the UCH to check whether a given socket element is available or not. NOTE: Socket elements with an attribute optional=“true” may not be available at runtime. Other socket elements are always available.
targetId: Globally unique target instance identifier.
socketName: Name (URI) of a socket.
eltId: element identifier, as specified by the ‘id’ attribute of a socket element in the socket description.
Return value: true=element available, false=element not available.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
   boolean isImplemented(string functionName)

This function allows the UCH to check whether any of the optional functions are implemented by the TA.
functionName: Any of the name of the optional functions below, without parentheses. EXAMPLE: “suspendSessionRequest”.
Return value: true=function implemented, false=function not available.

### Optional Functions

boolean suspendSessionRequest(string sessionId) Throws TAFatalException, TANotImplementedException

The UCH asks for permission to suspend a session. Note that this function asks for permission only, and is not supposed to actually suspend the session.
sessionId: UCH-internal session identifier.
Return value: true=request granted, false=request rejected.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
TANotImplementedException: The TA does not support this function.
   long sessionSuspended(string sessionId, long suggestedTimeout) Throws TAException, TAFatalException, TANotImplementedException

The UCH signals the TA that the client has suspended a session with one of the TA's targets. The TA should do the necessary actions internally and with the target. The session is now suspended until a subsequent call to resumeSessionRequest() or until the TA terminates the session for timing out or other reasons, in which case the TA shall call sessionAborted().

NOTE: A suspended session is in “sleep mode”. During suspension, the TA will not send any updates to the UCH, and the UCH will not request to change the status of the target. The suspension can be terminated by any of the following actions: UCH calls resumeSessionRequest() and sessionResumed() UCH calls sessionClosed() UCH calls unregisterTarget() on the pertaining target; TA terminates session and calls sessionAborted()
sessionId: UCH-internal session identifier.
suggestedTimeout: Timeout (in seconds) the client has suggested indicating a time period for the TA to keep the session for subsequent resume operation.
Return value: Tentative timeout (in seconds) of the TA/0 if the TA rejects the request. The TA intends to hold the session for subsequent resume operation for the timeout period. However, this is not a guaranteed value the TA may terminate the session at any time for any reason.
TAException: If the TA, for any reason, cannot transit the session into suspension mode, it throws a TAException. In this case the session will stay alive until either sessionClosed() or sessionAborted() is called. The exception shall include a text string describing the problem that occurred.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
TANotImplementedException: The TA does not support this function.
   boolean resumeSessionRequest(string sessionId) Throws TAFatalException, TANotImplementedException

The UCH asks for permission to resume a session. Note that this function asks for permission only, and is not supposed to actually resume the session.
sessionId: UCH-internal session identifier.
Return value: true=request granted, false=request rejected.
   NOTE: The TA may reject the resumption for various reasons, e.g. because it has already terminated the session.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
TANotImplementedException: The TA does not support this function.
   void sessionResumed(string sessionId) Throws TAException, TAFatalException, TANotImplementedException

The UCH signals the TA that the session has resumed. A call to this function shall only occur after a resume session request has been granted by the TA (see section boolean resumeSessionRequest(string sessionId)).
sessionId: UCH-internal session identifier.
TAException: If the TA, for any reason, cannot resume the session, it drops the session (without calling sessionAborted() and throws a TAException. In this case the UCH shall remove the session, and shall not call sessionClosed(). The exception shall include a text string describing the problem that occurred.
TAFatalException: The TA has encountered a problem that prevents further operation, and cannot be fixed. In this case the UCH should call no function of the TA anymore, and may unload the TA (without calling finalize). The exception shall include a text string describing the problem that occurred.
TANotImplementedException: The TA does not support this function.
   void targetRequest(Object request, Object response) Throws TAFatalException

NOTE: The targetRequest() function is currently specific to HTTP requests and responses. Future versions of this document may accommodate additional URI schemes. A TA may implement the targetRequest() function. If it does not implement it, it shall not call the UCH's startUriService() function. The UCH calls targetRequest() if it has received a request from a target to a URI that the TA has claimed for itself by a previous call to startUriService(). The UCH is responsible for creating the request and response objects prior to calling targetRequest(). The request and response parameters of targetRequest() have exactly the same meaning as the request and response parameters of controllerRequest() respectively (see section void controllerRequest(Object request, Object response) throws UIPM Fatal Exception).

### Target Adapter Listener Interface (ITAListener)

### Mandatory Functions

void sessionForwardRequest(string sessionId, Map forwardInfo)

The TA requests the client to open a session with a different socket. There are two types of forward requests: A “destructive forward request” asks the client to close the current session. A “spawn forward request” does not affect the current session.

sessionId: UCH-internal session identifier.

forwardInfo: Map (property-value pairs) with at least the following properties:
forwardType: “D”=destructive, “S”=spawn.
   NOTE: After a destructive forward request, the TA may abort the current session by calling sessionAborted()
targetId or targetName (either targetId or targetName shall be present if result=“F”):
   targetId: Globally unique target instance identifier specifying the target instance to which the client is forwarded to (may be the same as for the open session request). If target instance is not available (e.g. because a target of this kind has not been discovered), targetName shall be specified instead.
      NOTE: A TA may know about other targets (that are being managed by other TAs) through the local UCH store (see section Local Data Store).
   targetName: Name (URI) of the target that the session is forwarded to.
   targetName is only specified if the TA does not know the target instance or if
   no target instance of such kind is available.
socketName (shall be present if result=“F”): Socket name (URI) to which the client is forwarded to.
authorizationCode (may be present if result=“F”): Any authorization code for opening
a session with the forward target and socket.
   void abortSession(string sessionId)

The TA has terminated a session (which may be in active or suspended mode). From now on, the TA may have no knowledge about that session any more.

sessionId: UCH-internal session identifier.

void updateValues(string[ ] sessionIds, string[ ] paths, string[ ] operations, string[ ] values, boolean[ ] hasDynRes)

The TA signals a change in the target's status, affecting one or more sessions.

NOTE: The arrays paths, operations, values and hasDynRes shall be of the same size.
sessionIds: Array with UCH-internal session identifiers. The status change applies to all sessions that are included in the array.
paths: Array of paths, each item of any of the forms specified in section Path. This array is cross-indexed with the arrays values, operations and hasDynRes, i.e. they have the same size, and items with the same index are corresponding.
operations: Array of operation codes. The following codes are allowed:
   “S”=set value (this applies to variable values, command states and notification states)
   “A”=add indices (only for path with given indices)
   “R”=remove indices (only for path without indices, or path with given indices)
values: Array of associated values, as strings. Corresponding items for operations “R” (remove indices) shall be NULL.
hasDynRes: Array signaling whether the corresponding path is associated with a dynamic resource.
   NOTE: The UCH may call getDynRes() to retrieve dynamic resources from the TA. In this case it has to extract the element identifier from the path, since resources are common to all element components (index combinations).
      void updateDynRes(string[ ] sessionIds, string[ ] eltIds)

The TA signals that the set of atomic resources pertaining to a specific session and socket element has changed. Note that this function does not provide the new set of resources, but rather waits until the UCH request a specific dynamic resource via a subsequent call to getDynRes() (see section Map[ ] getDynRes(string sessionId, Map[ ] resProps) throws TAFatalException).
sessionIds: Array of UCH-internal session identifiers that the dynamic resource applies to. Through it the UCH can determine the TA to be called in order to retrieve the actual dynamic resource via getDynRes() see section Map[ ] getDynRes(string sessionId, Map[ ] resProps) throws TAFatalException.
   NOTE: A TA shall only specify multiple session Ids if the specified sessions share the dynamic resource that has changed (i.e. they always have the same resource). In this case, the UCH may retrieve the dynamic resource for one session only (via getDynRes), and assume the returned resource for all specified sessions.
   NOTE: A dynamic resource is (automatically) specific to a session, and therefore specific to the target instance of the session. Because of this, dynamic resources shall not use the ‘http://myurc.org/ns/res#forTargetInstance’ property in their descriptions.
eltIds: Array with URIs (in the form URI#eltRef) referencing the elements for which the set of dynamic resources has changed. Elements being referenced include socket sets, variables, commands, and notifications (no type definitions).
   NOTE: The UCH may ignore this message if it opts to not cache dynamic resources (but rather ask for dynamic resources via getDynRes() on demand).
   NOTE: This is an “in-session” function which may only be called if a session is open with the TA.
   IUCHStore getLocalUCHStore()

Get the local UCH store (a map, see section Local Data Store).

Return value: Local UCH Store.

boolean setValidation(ITA ta, boolean activate)

The TA tells the UCH to do validation for the TA or not. Validation means that the UCH will filter out requests for setting variable values, inserting or removing indices, invoking commands, and acknowledging notifications, based on type and dependency information from the socket description. See section Map setValuesRequest(string sessionId, string[ ] paths, string[ ] operations, string[ ] reqValues), setValuesRequest().

TA: TA object (caller) that requests a validation setting.

NOTE: A UCH implementation may or may not support validation. If it doesn't support validation, it shall always return false.

NOTE: By default, the UCH should not do validation.

activate: true=request for validation, false=request for no validation.

Return value: true=UCH set to validate for the calling TA, false=UCH will not validate.

string getIpAddress()

Get the IP address of the UCH. A TA may need this information to set up its own listener for a port that is not serviced by the UCH.

Return value: ip address of UCH as string.

string startUriService(ITA ta, string scheme, int port, boolean portIsFlexible, string basePath, boolean basePathIsFlexible) Throws UCHException

The TA requests the UCH to start servicing a URI which is made up of a given scheme, port, and base path. If successful, the UCH will forward all messages that have this URI as its base, to targetRequest(). If the TA indicates that the base path is flexible, the UCH can modify the base path in case it is not available any more.
ta: TA object (caller) that is requesting service for a URI with the UCH. The targetRequest() function of this object will be called upon a request to the specified URI.
scheme: URI scheme, such as “http”, “ftp”, “urn”, “vnc”, etc.
port: number of port for listening to requests. 0 if no preference for port number.
portIsFlexible: true if the UCH may modify the port number, otherwise false. Must be true if parameter port is 0.
basePath: base path for the URI.
basePathIsFlexible: true indicates that the UCH may modify the base path in case the specified path is already taken. false indicates that the UCH may not modify the base path if the path is already taken the function returns NULL.
Return value: URI for which the UCH has started service for the TA (e.g. “http://192.168.0.10/Target/”). If the URI is based on a hierarchical folder system, the URI shall end with a folder delimiter (‘/’ in case of http and ftp). Note that, if the path is flexible, the path may have been modified by the UCH (e.g. modify “Target” to “Target01”, etc.). Returns NULL if the UCH cannot service the specified URI.
UCHException: Invalid request.
   void stopUriService(string uri) Throws UCHException

The TA requests the UCH to stop servicing a URI that was requested to be serviced in a previous call to startUriService()
uri: URI that the UCH is requested to stop servicing. URI has been returned by the UCH in a previous call to startUriService().
UCHException: Invalid request.
   Map[ ] getResources(string sessionId, Map[ ] resProps)

Same as function IUIPMListener.getResources() see section Map[ ] getResources(string sessionId, Map[ ] resProps).

string getDocument(string uri, string postData) Throws UCHException

Same as function IUIPMListener.getDocument() see section string getDocument(string uri, string postData) Throws UCH Exception.

Map getUCHProps()

Get property map of the UCH.
Return value: Property map for the UCH at runtime. Additional properties may occur. See also section Property Map.
   boolean isImplemented(string functionName)

This function allows the TA to check whether any of the optional functions are implemented by the TAListener.

functionName: Any of the name of the optional functions below, without parentheses.

EXAMPLE: “removeTA”.

Return value: true=function implemented, false=function not available.

### Optional Functions

void removeTA(ITA ta)

The TA requests the UCH to be finalized and unloaded. TAs should call this function if they cannot operate anymore because of external events or other reasons.

The UCH may follow this request. In any case, the UCH shall call finalize() on the TA before it unloads the TA.

ta: TA object (caller) that wants to be removed.

Discovery of the UCH and its Remote User Interfaces

This section specifies how a controller discovers a UCH in a network, and available remote user interfaces implemented by UIPMs. This discovery mechanism applies for remote user interfaces that can be identified through a URI that is resolvable in a local network context. UIPMs may use other mechanisms to make themselves discoverable to controllers, but this is out of the scope of this specification. The mechanism defined in this section is based on [UPnP RUI] and [CEA-2014], and uses target instances as a top-level structuring mechanism of available user interfaces in a local network. NOTE: There may be multiple control hubs in a local network. It is up to the controller how to offer an integrated view, consisting of multiple UCHs and their offered control interfaces to the user.

### RUI Server

In accordance with an embodiment, a UCH shall expose itself as a Remote User Interface Server [CEA-2014] in a local network, through one of the following mechanisms:
RUI Server level-0: UIList XML document available through HTTP GET and HTTPS GET from the RUI Server, port 80, at /UCH/GetCompatibleUIs.
RUI Server level-1: UIList XML document available through HTTP GET and HTTPS GET from the RUI Server, port 80, at /UCH/GetCompatibleUIs; and <uilist> contained in a file with its URL as specified by the <uiListURL> element of the server's device description.
RUI Server level-2: UIList XML document available through HTTP GET and HTTPS GET from the RUI Server, port 80, at /UCH/GetCompatibleUIs; <uilist> contained in a file with its URL as specified by the <uiListURL> element of the server's device description; and returned by the GetCompatibleUIs() UPnP action of the server.

NOTE: See [CEA-2014] for details on how the UIList document (XML block) can be retrieved from an RUI Server. A UCH may opt to use HTTP code 301 (Moved Permanently) for one of the HTTP or HTTPS requests to redirect the client to the other protocol. In this case, the RUI Client may automatically redirect the request.

### UIList

The UIList shall consist of user interfaces and their URIs, as advertised by the UIPMs through the addCompatibleUI() function (see section boolean addCompatibleUI(string targetId, string[ ] socketNames, string protocolShortName, string[ ] uris, Map protocolInfo) throws UCH Exception), in any order, as follows:

```
<uilist xmlns=“urn:schemas-upnp-org:remoteui:uilist-1-0”>
  <ui>
    <uiID>targetId </uiID>
    <name>targetFriendlyName </name>
    <protocol shortName=“protocolShortName”>
      <uri>remoteControlUri </uri>
      <protocolInfo>
        <uipmClientName> uipmClientName </uipmClientName>
        <targetName>targetName </targetName>
        <socketName
friendlyName=“socketFriendlyName ”>socketName
</socketName>
        ... other protocolInfo subelements specific to
        protocolShortName ...
      </protocolInfo>
    </protocol>
  </ui>
</uilist>
```

Whereby:
Restrictions apply as defined for the <uilist> element of namespace “urn:schemas-upnp-org:remoteui:uilist-1-0” [UPnP RUI].
<uilist> may have any number of <ui> subelements. Each <ui> element represents a user interface that has been advertised by a TA through a call to addCompatibleUI (see section boolean addCompatibleUI(string targetId, string[ ] socketNames, string protocolShortName, string[ ] uris, Map protocolInfo) Throws UCHException).

NOTE: [UPnP RUI] uses the concepts of “remote user interfaces” and “applications” in equivalent ways. In a UCH environment, target instances can be construed as “applications”. However, one target instance (“application”) may have multiple sockets which can be individually accessed and controlled. Still, the target instance is a reasonable parameter for top-level structuring of the UIList. But controllers should not assume that all <protocol> elements underneath a <ui> element are representing equivalent user interfaces.
<uiID> shall occur exactly once. It shall contain a global target instance identifier that the application under <ui> is controlling. A value of “all” indicates that the application controls all available targets.
   NOTE: <uiID> reflects the ‘targetId’ parameter of addCompatibleUI (see section boolean addCompatibleUI(string targetId, string[ ] socketNames, string protocolShortName, string[ ] uris, Map protocolInfo) Throws UCHException). Duplicate targetIds shall be merged into one <uiID> element (with multiple <protocol> subelements).
<name> shall occur exactly once, and shall not be empty. It shall contain a human-readable name for the target instance (targetFriendlyName). A name of “All targets” (or a translation into other languages) is appropriate if the target instance identifier is “all”.
   NOTE: targetFriendlyName reflects the value of property “http://myurc.org/ns/res#friendlyName” in the target properties map, as returned by getTargetProps (see section Map getTargetProps(string targetId) throws TAFatalException).
<protocol> may occur any number of times. Each <protocol> element specifies a user interface protocol with pertaining URIs to connect to the remote user interface represented by the nesting <ui> element. See section ‘shortName’ Attribute# for allowed values of the ‘shortName’ attribute of <protocol>.
   NOTE: Each <protocol> element reflects a call to addCompatibleUI (see section boolean addCompatibleUI(string targetId, string[ ] socketNames, string protocolShortName, string[ ] uris, Map protocolInfo) Throws UCHException). The ‘shortName’ attribute reflects the ‘protocolShortName’ parameter in addCompatibleUI (see section boolean addCompatibleUI(string targetId, string[ ] socketNames, string protocolShortName, string[ ] uris, Map protocolInfo) Throws UCHException).
<uri> shall occur one or more times within <protocol>. For each occurrence, remoteControlUri denotes a URI for a remote user interface of the protocol specified on the nesting <protocol> element (see section ‘shortName’ Attribute# ‘shortName’ attribute).
   NOTE: <uri> reflects the ‘uris’ parameter of addCompatibleUI (see section boolean addCompatibleUI(string targetId, string[ ] socketNames, string protocolShortName, string[ ] uris, Map protocolInfo) Throws UCHException).
<protocolInfo> shall occur exactly once within a <protocol> element.
<uipmClientName> may occur. If present, it shall occur exactly once with:
   uipmClientName being the resource name (URI) of the UIPM client software that will be retrieved when sending a request to remoteControlUri.
   NOTE: uipmClientName is useful for the discovery of labels and other atomic resources for the UIPM client software.
<targetName> shall occur exactly once within a <protocolInfo> element. It shall contain (as element content) the name (URI) of the target with identifier targetId. An element content of “all” is appropriate if the target instance identifier is “all”.
   NOTE: targetName reflects the return value of getTargetName (see section string getTargetName(string targetId) Throws TAFatalException).
   NOTE: Strictly, the target's name should be a subelement of <ui>. However, due to existing restrictions of the UIList syntax, it can only be provided as subelement of <protocolInfo>. Multiple <protocol> elements under the same <ui> element will share the same content for <targetName>.
<socketName> may occur zero or more times, with an element content of the name (URI) of a socket the application controls (an application may control multiple sockets). An element content of “all” is allowed to indicate that the application controls all sockets of the target instance. <socketName> may have a ‘socketFriendlyName’ attribute. socketFriendlyName is a human-readable name for the socket. A name of “All sockets” (or a translation into other languages) is appropriate if the <socketName>'s element content is “all”.
   NOTE: <socketName> reflects the ‘socketNames’ parameter of addCompatibleUI (see section boolean addCompatibleUI(string targetId, string[ ] socketNames, string protocolShortName, string[ ] uris, Map protocolInfo) Throws UCHException). An empty array of socket names results in the value “all” for <socketName>. socketFriendlyName reflects the return value of getSocketFriendlyName (see section string getSocketFriendlyName(string targetId, string socketName)).
<protocol> may have other subelements, corresponding to the properties of the ‘protocolInfo’ map parameter of function addCompatibleUI (see section boolean addCompatibleUI(string targetId, string[ ] socketNames, string protocolShortName, string[ ] uris, Map protocolInfo) throws UCHException).

NOTE: As in all XML documents, leading and trailing whitespaces in element content will get lost if not properly escaped. In particular, leading and trailing spaces, occurring in target identifiers and target friendly names, shall be encoded as ‘&#x20;’.

EXAMPLE: The following UIList exposes an “all-in-one” control application, and specific control applications for an “AV System” and a “Telephone”. All applications provide the “HTTP/HTML” UI protocol. In addition, “AV System” and “Telephone” provide access through the “URC-HTTP” UI protocol. See [URC-HTTP] for details on the format of the <protocolInfo> subelement of <protocol shortName=“URC-HTTP”>. Note that some URIs have been split into two lines for presentation purposes they need to be in one line in the actual UIList document.

```
<uilist xmlns=“urn:schemas-upnp-org:remoteui:uilist-1-0”>
  <ui>
    <uiID> all </uiID>
    <name> All targets </name>
    <protocol shortName=“HTTP/HTML”>
      <uri>http://192.168.0.10/UCH/all/html</uri>
      <protocolInfo>
        <uipmClientName> http://res.myurc.org/uipm-client/webclient
</uipmClientName>
        <targetName> all </targetName>
      </protocolInfo>
    </protocol>
  </ui>
  <ui>
    <uiID> ABC001</uiID>
    <name>AV System </name>
    <protocol shortName=“URC-HTTP”>
      <uri> http://192.168.0.10/UCH/av/urc-http/play?ABC001 </uri>
      <protocolInfo>
        <targetName> http://res.myurc.org/upnp/av </targetName>
        <socketName> http://res.myurc.org/upnp/av/play-1.uis </socketName>
        <socketDescriptionAt> http://res.myurc.org/upnp/av/play-1.uis
</socketDescriptionAt>
        <targetDescriptionAt> http://res.myurc.org/upnp/av/entertainment.td
</targetDescriptionAt>
        <conformsTo> http://myurc.org/TR/urc-http-protocol-20080627
</conformsTo>
      </protocolInfo>
    </protocol>
    <protocol shortName=“HTTP/HTML”>
      <uri>http://192.168.0.10/UCH/av/html?http%3A%2F%2F192.168.0.10%2FUCH%2F
av%2Furc-http%2Fplay%3FABC001 </uri>
      <protocolInfo>
        <uipmClientName> http://res.myurc.org/upnp/av/uipm-client/DragIt
</uipmClientName>
        <targetName> http://res.myurc.org/upnp/av</targetName>
        <socketName>http://res.myurc.org/upnp/av/play-1.uis</socketName>
      </protocolInfo>
    </protocol>
  </ui>
  <ui>
    <uiID> RRR0001</uiID>
    <name>Telephone</name>
    <description>Landline-based phone system.</description>
    <lifetime>60</lifetime>
    <protocol shortName=“URC-HTTP”>
      <uri> http://192.168.0.10/UCH/phone/urc-http?RRR0001 </uri>
      <protocolInfo>
        <targetName> http://res.myurc.org/anymodel/phone </targetName>
        <socketName> http://res.myurc.org/anymodel/phone.uis </socketName>
        <socketDescriptionAt> http://res.myurc.org/anymodel/phone.uis
</socketDescriptionAt>
        <targetDescriptionAt> http://res.myurc.org/anymodel/phone.td
</targetDescriptionAt>
        <conformsTo> http://myurc.org/TR/urc-http-protocol-20080627
</conformsTo>
      </protocolInfo>
    </protocol>
    <protocol shortName=“HTTP/HTML”>
      <uri>
http://192.168.0.10/UCH/phone/html?http%3A%2F%2F192.168.0.10%2FUCH%2Fphone%2F
urc-http%3FRRR0001 </uri>
      <protocolInfo>
        <targetName> http://res.myurc.org/anymodel/phone </targetName>
        <socketName> http://res.myurc.org/anymodel/phone.uis </socketName>
      </protocolInfo>
    </protocol>
  </ui>
</uilist>
```

‘shortName’Attribute

Based on the information from the installed TAs, a UCH shall identify the user interface protocols it exposes through its TAs, as attribute values of the ‘shortName’ attribute of the <protocol> elements. The following table summarizes the short names for UI protocols, as defined by [UPnP RUI] and [CEA-2014]. Other UI protocols (and corresponding shortNames) may be defined by other standards, thus extending this document.

| | URI | | |
|---|---|---|---|
| shortName | scheme | Description | Comment |
| HTTP/HTML | HTTP: | The application supports remoting | From [UPnP RUI] |
| | | with HTML using HTTP as transport. | |
| RDP | RDP: | The application supports remoting | From [UPnP RUI] |
| | | with Microsoft RDP protocol. | |
| VNC | VNC: | The application supports remoting | From [UPnP RUI] |
| | | with AT&T VNC protocol. | |
| XRT2 | | The application supports remoting | From [UPnP RUI] |
| | | with Intel XRT2 protocol. | |
| LRDP | | The application supports remoting | From [UPnP RUI] |
| | | with Nokias' LRDP protocol. | |
| XHT | | The application supports remoting | From [UPnP RUI] |
| | | with Samsungs' XHT protocol. | |
| SGXML | | The application supports remoting | From [UPnP RUI] |
| | | with Siemens' Gigaset XML protocol. | |
| UIF | | The application supports remoting | From [UPnP RUI] |
| | | with Philips UI Fragments protocol. | |
| (Vendor-specific | | (Specified by UPnP vendor.) | From [UPnP RUI] |
| protocol name) | | | |
| CE-HTML-1.0 | HTTP: | CE-HTML (extension of HTML), as | The requirement from [CEA-2014] that there shall be at |
| | HTTPS: | defined in [CEA-2014] | least one CE-HTML protocol per UI is not required for a |
| | | | UCH. |
| URC-HTTP | HTTP: | URC-HTTP protocol | See [URC-HTTP] for details on how to implement the |
| | HTTPS: | | URC-HTTP protocol. |
| XRT | XRT: | XRT Self-Contained Remoting | Replaces “XRT2” from [UPnP RUI]. |
| | XRTS: | Protocol | |

### User-Preferred Language

In accordance with an embodiment, the UCH should respect the user's language preferences when responding to a request for the UIList. The user's language preferences are specified in the HTTP request header “Accept-Language”.

### 5. URC HTTP Protocol

This section describes a “Universal Remote Console (URC) on HTTP” protocol (short “URC-HTTP protocol”) in accordance with an embodiment. The URC-HTTP protocol can be implemented by Remote UI servers that are compliant to UPnP RemoteUI or CEA-2014. This protocol is optional for a UCH. However, if a UCH implements this protocol, it shall implement it exactly as described in this specification. The URC protocol can be used by controllers that need a semantic description of the user interface components. Examples for such controllers are controllers and intelligent agents that allow for voice or natural language based interaction mechanisms, including task-oriented user interfaces. The underlying concepts of the URC protocol are specified in ISO/IEC 24752, Universal Remote Console. A UCH conforms to the standard described herein standard if it implements: Support for character encoding; Discovery; all HTTP/HTTPS Request Messages; an Update Channel; and Support for URL rewriting for Session Management. A controller conforms to this standard if it implements: support for character encoding; the following HTTP/HTTPS Requests with pertaining MIME types and status codes: Open Session, Close Session, Get Values; and Support for URL rewriting for Session Management. NOTE: Conformance to this standard does not imply conformance to any part of ISO/IEC 24752.

Messages and their formats are specified in this standard as example code with placeholders. Placeholder meanings are explained after the code template in which they are used, together with other constraints of the specified message format. “[blank line]” denotes a blank line, consisting of a LF (line-feed) character (ASCII 10). EOF is the (end-of-file) character (ASCII 31).

### Coding

### Character Encoding

For all messages defined in this standard, the “UTF-8” character encoding shall be used.

### Character Escaping

7

### Leading and Trailing Whitespaces

As in all XML documents, leading and trailing whitespaces in element content will get lost if not properly escaped. In particular, leading and trailing spaces, occurring in variable values and resource text, shall be encoded as ‘&#x20;’.

### Undefined Value

The undefined value shall be encoded as the tilde character ‘·’. Real (defined) string values consisting of a single tilde character shall be encoded as ‘&#x7E’. NOTE: If a variable's value or command's state is undefined, either the socket element (variable or command) is not available in the session (see ‘optional’ attribute on variables on commands, ISO/IEC 24752-2), or the value/state is temporarily undefined. Controllers should not include socket elements in the user interface whose value/state is undefined (see ISO/IEC 24752-1).

### Namespaces

The XML language defined by this standard does not support multiple namespaces. All elements and attributes belong to the default namespace whose URI shall be “http://myurc.org/ns/urc-http”.

This namespace URI shall be implicitly assumed for all XML fragments defined by this standard, but shall not be included in any message between a controller and UCH and vice versa. Neither UCHs nor controllers need to employ namespace-aware parsers.

### UIList

In accordance with an embodiment, a UCH shall advertise the user interface protocols that it offers through the UIList, either as level-0, level-1 or level-2 RUI Server. The UIList shall comply with [UCH].

Advertising of URC-HTTP protocol

A UCH [UCH] supporting the URC-HTTP protocol shall advertise this in its UIList.

NOTE: A UCH that loads and installs a UIPM with the following properties is defined as “supporting the URC-HTTP protocol”:

http://myurc.org/ns/res#type=“http://myurc.org/restypes#uipm”

http://myurc.org/ns/res#protocolShortName=“URC-HTTP”

The following specific rules apply for URC-HTTP protocol entries in the UIList: For every socket of a target instance (i.e. every combination of target instance and one of its sockets) that the UCH exposes through the URC-HTTP protocol, there shall be a <protocol> subelement (underneath the <ui> element representing the target instance), with shortName=“URC-HTTP”, as follows:

```
<uilist xmlns=“urn:schemas-upnp-org:remoteui:uilist-1-0”>
  <ui>
    <uiID>targetId </uiID>
    <name>targetFriendlyName </name>
    <protocol shortName=“URC-HTTP”>
      <uri>remoteControlUri </uri>
      <protocolInfo>
        <uipmClientName> uipmClientName </uipmClientName>
        <targetName>targetName </targetName>
          <socketName friendlyName=“socketFriendlyName ”>socketName
</socketName>
        <socketDescriptionAt>SocketDescriptionURI </socketDescriptionAt>
        <targetDescriptionAt>TargetDescriptionURI </targetDescriptionAt>
            <conformsTo> http://myurc.org/TR/urc-http-protocol-20080814
</conformsTo>
      </protocolInfo>
    </protocol>
  </ui>
</uilist>
```

NOTE: Of the above 6 <protocol> subelements, <uipmClientName>, <targetName> and <socketName> are defined in [UCH] since they apply to any kind of user interface, as advertised by a UCH. Among them, when applied to URC-HTTP based user interfaces, <targetName> and <socketName> each must occur exactly once, since a <protocol shortName=“URC-HTTP”> element represents exactly one target and exactly one socket.

### Advertising of URC-HTTP Client Wrapper Protocols

URC-HTTP clients are applications and scripts that are interfacing with the UCH via the URC-HTTP protocol provided by a URC-HTTP UIPM [UCH]. Some UIPM clients may be simple web pages (typically HTML pages with embedded scripts or objects running on any web browser) that can be retrieved from the UCH's web server. Such a web page can be understood as “wrapping” the URC-HTTP protocol by offering a different protocol (the “wrapper protocol”) to its clients. A URC-HTTP client specifies its “wrapper protocol” by the property http://myurc.org/ns/res#protocolShortName (e.g. “HTTP/HTML”).

A resource is a URC-HTTP client resource, if all of the following is true regarding its properties:

http://myurc.org/ns/res#type=“http://myurc.org/restypes#uipm-client”

http://myurc.org/ns/res#wrapsProtocolShortName=“URC-HTTP”

http://myurc.org/ns/res#protocolShortName is specified

It is an applicable URC-HTTP client resource, if all of the following is true:
A property http://myurc.org/ns/res#forTargetInstance (if specified) matches a target instance that is available.
A property http://myurc.org/ns/res#forTargetName is either “all”, “*” or matches a target name that is available.
A property http://myurc.org/ns/res#forSocketName (if specified) is either “all”, “*” or matches a socket name of a target that is available.

Other restrictions of the URC-HTTP client resource apply, as expressed by its properties.

A UCH supporting the URC-HTTP protocol should make an applicable URC-HTTP client resource available, if accessible to the UCH, via its web server for retrieval by controllers, as follows:

The UCH should store the client resource in the local network.
NOTE: It is acceptable for a UCH to assign URIs and do advertisements (see below) for remote URC-HTTP client resources, without downloading and storing them locally. In this case the UCH would download, unpack and pass them on to the controller upon a controller's request.
If the client resource is a file package (property http://myurc.org/ns/res#mimeType), it should unpack the package into a separate directory, identify its index file (property http://myurc.org/ns/res#indexFile) and the MIME type of the index file (property http://myurc.org/ns/res#indexFileMimeType).
The UCH should assign resolvable “remote control URIs” for every client resource (or its index file if it is a package), and for each applicable target instance (as specified by the property http://myurc.org/ns/res#forTargetName), and for each of the applicable sockets (as specified by the property http://myurc.org/ns/res#forSocketName, if available). The remote control URIs shall have a list of applicable URC-HTTP remote control URIs (for applicable target instances and socket names) as query component [RFC 3986], delimited from each other by the ‘&’ character. Note that URI component coding restrictions apply as specified in [RFC 3986].
   Exception: If the client resource applies to the set of all targets (i.e. property http://myurc.org/ns/res#forTargetName has the value “all”), the list of applicable URC-HTTP remote control URIs shall be omitted (i.e. the remote control URI has no query component).
   Note that—with the above exception—multiple URC-HTTP remote control URIs occur only if the client resource's http://myurc.org/ns/res#forSocketName property occurs multiple times with different URI values, or if it has the value “all”. Background: Multiple values for property http://myurc.org/ns/res#forTargetName indicates alternative target names rather than a set of targets that the client resource binds to all at once. However, multiple values for property http://myurc.org/ns/res#forSocketName indicate that the client resource binds to all socket names at the same time.
The UCH should expose the resource name (URI) of the URC-HTTP client software under the element <uipmClientName>.
A controller can retrieve the client resource (or its index file) through the assigned remote control URI, and the UCH should serve it with its specific MIME type (property http://myurc.org/ns/res#mimeType or http://myurc.org/ns/res#indexFileMimeType, respectively). If no MIME type is specified for the client resource, the UCH should try to infer a MIME type based on the file extension or other heuristics.

A UCH can have access to URC-HTTP client resources either through implementation-specific means (e.g. local configuration), and/or by querying and retrieving them from a resource server.

A UCH should advertise accessible URC-HTTP client resources that it makes available via its web server, by adding their assigned remote control URIs (see above) in the UIList, as specified in [UCH], and as follows:
The URC-HTTP client resources and their remote control URIs shall be included in the UIList underneath the <ui> element that adheres to the target instance that they control, as specified by the property http://myurc.org/ns/res#forTargetName. If the property has a value of “all”, the client resource shall be included underneath the target instance “all”.
The ‘shortName’ attribute on <protocol> shall be the value of the http://myurc.org/ns/res#protocolShortName property of the URC-HTTP client resource.
The elements <targetName> and <socketName> shall reflect the target name (URI) and socket name (URI) that client resource will connect to when the assigned remote control URI is used (see above on assigning of URIs). An element content of “all” indicates that the assigned URI will connect to all targets (only applicable underneath the <ui> element adhering to the “all” target instance), or to all socket names of a particular target instance, respectively.

NOTE: Since a URC-HTTP client resource provides a wrapper protocol of any kind (other than “URC-HTTP”), its advertising follows the format of the UIList, as specified in [UCH], and not the (stricter) profiled format for URC-HTTP user interface protocol providers.

Example: See [UCH] under “UIList”, in particular those <protocol> entries with shortName=“HTTP/HTML”.

### HTTP/HTTPS Request Messages

### General

### Transport

In general, messages from the controller are sent to the UCH over HTTP or HTTPS. The UCH may opt to use only HTTP or only HTTPS.

However, the UCH shall respond to both HTTP and HTTPS requests for the UIList. The UCH may use HTTP code 301 (Moved Permanently) to redirect one of the requests to the other protocol [UCH].
At a minimum, all out-of-session messages shall be available through the same protocol as the UIList.
MIME type

HTTP/HTTPS responses shall have a MIME type of “application/urc-http+xml”, if applicable. NOTE: This MIME type will be registered with IANA.

### HTTP Status Codes

HTTP status codes apply, as specified in RFC 2616. A specific subset of relevant HTTP status codes will be specified for each HTTP/HTTPS request type below. In addition, a UCH shall respond with error code 400 Bad Request, if it gets an HTTP/HTTPS request that is not defined. However, a UCH shall not respond with error code 400 to indicate any superfluous query arguments in the URL, or any superfluous message body. In these cases, the UCH shall simply ignore the superfluous information.

### Path Forms

The following table lists possible forms of paths that can be used in HTTP/HTTPS request messages and their responses. Subsequent sections with detailed HTTP/HTTPS message descriptions are referencing these path forms.

| Path Form Name | Syntax(es) | Description |
|---|---|---|
| root path | / | all Socket elements (and their components, if any) |
| path without | /set1/set2/id | non-dimensional Socket element or set |
| indices | | |
| shortcut path | id | non-dimensional Socket element or set (shortcut for “path without indices”) |
| path with given | /set1[index1]/set2/ | one component of a dimensional Socket element or set, i.e. that has a ‘dim’ |
| indices | id[index2][index3] | attribute or that is contained (directly or indirectly) in a set that has a ‘dim’ |
| | | attribute |
| path with empty | /set1[ ]/set2/id[ ][ ] | all components of the Socket element or set id. |
| indices | | May be mixed with form “path with given indices”, thus partially specifying a |
| | | set of indices, e.g.: “/set1[index1]/set2/id[index2][ ]”, |
| | | “/set1[ ]/set2/id[index2][index3]”, “/set1[index1]/set2/id[ ][index3]”. |
| path with range of | /set1[index1a | specific components of the Socket element or set id, within a specific range |
| indices | index1b]/set2/id[index2a | of index values (index1a <= index1 <= index1b, index2a <= index2 <= |
| | index2b][index3a index3b] | index2b, index3a <= index3 <= index3b). |
| | | This form can only be applied for indices whose type is totally ordered (i.e. |
| | | the index type must be based on an XSD type with the fundamental facet |
| | | ‘ordered’ having a value of “total” or “partial”; if “partial”, only those index |
| | | values that can be compared with the boundaries will be included in the |
| | | response). |
| | | This form can be mixed with the “path with given indices” form, and the “path |
| | | with empty indices” form. Example: “/set1[index1]/set2/id[index2a |
| | | index2b][ ]”. |
| path for command | /set1/set2/cmdid[state] | “state” field of a command (component) - only applicable for commands of |
| state | id[state] | type “uis:basicCommand” or “uis:timedCommand” - use first or second form |
| | /set1[index1]/set2/ | for non-dimensional commands; and last form for dimensional commands. |
| | cmdid[index2][index3][state] | |
| path for command | /set1/set2/cmdid[ttc] | “timeToComplete” field of a command (component) - only applicable for |
| timeToComplete | cmdid[ttc] | commands of type “uis:timedCommand” - use first or second form for non- |
| | /set1[index1]/set2/ | dimensional commands; and last form for dimensional commands. |
| | cmdid[index2][index3][ttc] | |
| path for local | /set1/set2/cmdid/parid | local parameter of a command (component) - use first or second form for |
| command | parid | non-dimensional commands; and last form for dimensional commands. |
| parameter | /set1[index1]/set2/ | |
| | cmdid[index2][index3]/parid | |
| path for partial | eltPath#xmlPath | partial content of an XML-coded Socket element value (i.e. a Socket element |
| XML content | | with a complex XSD form). |
| | | eltPath references a Socket element, in any of the following path |
| | | forms: “path without indices”, “shortcut path” or “path with given |
| | | indices”. |
| | | xmlPath has any one of the following syntaxes: |
| | | “root” for requesting an XML fragment containing the |
| | | root element only. |
| | | “childrenOf(nodeId)” for requesting an XML fragment |
| | | containing the child nodes of the XML element with |
| | | id = “nodeId”. |
| | | “parentOf(nodeId)” for requesting an XML fragment |
| | | containing the parent node of the XML element with |
| | | id = “nodeId”. |
| | | “id(nodeId)” for requesting an XML fragment containing |
| | | the XML element with id = “nodeId”. The fragment will |
| | | contain the nodeId element including its attributes, but |
| | | not its child nodes. |

### Data Types

Coding for value transmission in HTTP/HTTPS messages shall follow the XML Schema Definition specification. Values are case-sensitive.

In particular, the only values allowed for type boolean shall be “true” and “false”.

### Out-of-Session Messages

This section describes message types that a controller can use with or without an open session with the UCH.

### Get Resources (Out-Of-Session)

A controller may query a list of static atomic resources from a UCH, independent from any session, as follows:

```
POST /UCH/GetResources HTTP/1.1
HOST: hostname
User-Agent: OS/version Browser/version
[blank line]
<getResources>
  <resource
    eltRef=“eltRef ”
    valRef=“value ”
    opRef=“opUri ”
    role=“roleUri ”
    type=“type ”
    format=“mimetype ”
    forLang=“langcode ”
    forTargetInstance=“targetId ”
    creator=“creator ”
    publisher=“publisher ”
    date=“date ”
    audience=“audience ” />
</getResources>
```

Whereby:
hostname is the domain name for the UCH. Note that the port number is omitted and defaults to 80 (for HTTP) or 443 (for HTTPS).
<getResources> shall occur exactly once in the body of the HTTP/HTTPS request, specifying resource queries for atomic resources from the UCH. It shall contain one or more <resource> subelements, each specifying a resource query for the delivery of atomic resources. Note that the order of the <resource> subelements is significant since the UCH will respond with a list of resources in corresponding order.
Each <resource> element may have any of the following attributes (in any order):
   ‘eltRef’ attribute, with eltRef specifying a URI for the element that the resource is pertaining to. This may be a URI with fragment identifier, referencing a socket element that the requested resource shall apply to, but other URI forms and references to other entities are allowed (e.g. reference to a socket to obtain its label). See ISO/IEC 24752-5, section 6.7.3.1 for <eltRef>.
      NOTE: eltRef specifies the whole element reference as specified in an atomic resource description, typically in the form: uri#id.
      NOTE: The use of the element reference (eltRef) in the Get Resources request message is different from the use of element paths (path) in other messages such as Get Values. Since a resource is defined for an element (and not for a specific instance of it) an element path must not be used for a resource query.
   ‘valRef’ attribute, with value specifying the specific value that the requested resource shall apply to. If missing, the requested resource shall not apply to a particular value. See ISO/IEC 24752-5, section 6.7.3.2 for <valRef>.
   ‘opRef’ attribute, with opUri specifying the operation URI that the requested resource shall apply to. See ISO/IEC 24752-5, section 6.7.3.3 for <opRef>. If missing, the requested resource shall not apply to a particular operation. opRef and valRef shall not occur together; i.e. if opRef occurs, no valRef shall occur, and vice versa.
   ‘role’ attribute, indicating the role of the requested resource, with roleUri as defined in ISO/IEC 24752-5, section 6.7.3.4 for <role>.
   ‘type’ attribute, indicating the type of the requested resource, with type as defined in ISO/IEC 24752-5, section 6.5 for <dc:type>.
   ‘format’ attribute, indicating the MIME type of the requested resource, with mimetype as defined in ISO/IEC 24752-5, section 6.6 for <dc:format>.
   ‘forLang’ attribute, indicating the language of the requested resource, with langcode as defined in ISO/IEC 24752-5, section 6.7.3.5 for <forLang>.
   ‘forTargetInstance’ attribute, indicating the target instance for which the atomic resource can be applied, with targetId as defined in ISO/IEC 24752-5, section 6.7.3.6 for <forTargetInstance>.
      NOTE: In the UIList, the available targetIds are specified as element content of <uiID> elements.
   ‘creator’ attribute, indicating the creator of the requested resource, with creator as defined in ISO/IEC 24752-5, section 6.8 for <dc:creator>.
   ‘publisher’ attribute, indicating the publisher of the requested resource, with publisher as defined in ISO/IEC 24752-5, section 6.9 for <dc:publisher>.
   ‘date’ attribute, indicating the date of the requested resource, with date as defined in ISO/IEC 24752-5, section 6.11 for <dc:date>.
   ‘audience’ attribute, indicating the audience for the requested resource, with audience as defined in ISO/IEC 24752-5, section 6.13 for <dcterms:audience>.
Any resource property not included as attribute of a <resource> element shall be unspecified in the resource query, i.e. their values do not matter for matching the query.

NOTE: The Get Resources request can be used for atomic resources that would not be delivered as part of Get Value responses or Update Events. Examples include: labels for the socket itself, for a local input parameter, and for presentational groups. Still, some controllers may require a retrieval mechanism that can accommodate for more complex resource queries. In this case it is recommended that the controller retrieve and parse resource sheets, obtained either from the target (through the target description, see 7) or from a resource server. Upon a processed Get Resources request, the UCH shall respond by transmitting the requested static atomic resources, if available, as follows:

```
HTTP/1.1 200 OK
Accept-Ranges: bytes
Content-Type: application/urc-http+xml; charset=utf-8
  [blank line]
<resources>
  <resource />
  <resource> resource </resource>
  <resource at=“resourceUri ” />
</resources>
```

Whereby:
The response shall include exactly one <resources> element.
The <resources> element shall have one or more <resource> subelements, each specifying an atomic resource, if available.
The list of <resource> subelements shall exactly reflect the list of resource queries (<resource> subelements of <getResources>) in the Get Resource request, in size and order. If no resource is available for a particular resource query of the Open Session request, the corresponding <resource> subelement shall be empty (coded as “<resource I>”). If multiple resources match a resource query, it is up to the UCH to pick one of them (selection criteria are implementation-specific).
An available atomic resource shall be specified either as element content of the <resource> subelement (resource) or as the value (resourceUri) of an ‘at’ attribute of <resource> which may occur. resourceUri shall be a resolvable URI to the resource content.

The following HTTP status codes apply to a Get Resources response:

| HTTP status code | Use Cases |
|---|---|
| 200 OK | The request was successfully processed. If the |
| | request contained invalid path references, |
| | they were ignored by the server. |
| 301 Moved | The requested resource has been assigned a new |
| Permanently | permanent URI and any future references to this |
| | resource SHOULD use one of the returned URIs. |
| | May be used to redirect the client to either |
| | HTTP or HTTPS. |
| 400 Bad Request | The request body is encoded in a format that the |
| | server does not support. The XML body of the |
| | request is not well-formed. |
| 500 Internal Server | The server encountered an unexpected condition |
| Error | which prevented it from fulfilling the request. |
| 503 Service | The server is currently unable to handle the request. |
| Unavailable | |

NOTE: Static resources are not specific to sessions and can therefore be retrieved by any client, even though it may not have a session open with the UCH. Some static resources may be needed by a client before a session has been opened, for example the label for a socket. In contrast, dynamic resources are target instance specific, and can only be obtained through URC-HTTP if a session is open with the corresponding target. Controllers should use the in-session version of Get Resources when requesting resources during a session, in order to have dynamic resources automatically included in the response.

Get Document (HTTP Proxy)

A controller may not be able to retrieve documents from the Internet for security restrictions. In particular, it may want to retrieve target and socket descriptions which may not reside on the UCH itself. The Get Document function of the URC-HTTP protocol is designed to solve this problem.

A UCH should provide an HTTP proxy function to a controller, as follows:

The UCH, when receiving a GET or POST request to /UCH/GetDocument?url=destinationURL&otherQueryParameters, forwards this request (including headers and body) to destinationURL that has been specified by the client as the first URL query parameter named “url” (small letters). The other query parameters (otherQueryParameters) will be forwarded as part of the request to destinationURL.

The UCH will pass the response of the forwarded request back to the RUI client, including HTTP headers and error code.

Example: The controller sends the following GET request to the UCH:

GET /UCH/GetDocument?url=http://res.myurc.org/upnp/av/
socket&other=text
HTTP/1.1
HOST: hostname
User-Agent: ClientOS/clientVersion ClientBrowser/clientVersion
[blank line]

Whereby:
hostname is the domain name for the UCH. Note that the port number is omitted and defaults to 80 (for HTTP) or 443 (for HTTPS).

NOTE: The UCH would handle a POST request in the same fashion, except that it would also forward the body of the request message.

Then the UCH initiates the following forward request:

GET /upnp/av/socket?other=text HTTP/1.1
HOST: res.myurc.org
User-Agent: ClientOS/clientVersion ClientBrowser/clientVersion
[blank line]

After the UCH has received the response from res.myurc.org, it will pass it on to the controller, including HTTP error code, headers, and body.

NOTE: The above example does not encode special characters as part of the destination URL. While this is common practice, it does not strictly comply with the requirements of this specification.

### Invoke Locator

A controller may request to invoke a target's locator at any time, even when no open session exists with the UCH on this target. A controller may request to invoke a target's locator in a message to the UCH, as follows:

POST /UCH/InvokeLocator HTTP/1.1
HOST: hostname
User-Agent: OS/version Browser/version
[blank line]
<invokeLocator targetId=“targetId ” locatorId=“locatorId ” />

Whereby:
hostname is the domain name for the UCH. Note that the port number is omitted and defaults to 80 (for HTTP) or 443 (for HTTPS).
<invokeLocator> shall occur one or more times, with attributes ‘targetId’ and ‘locatorId’ on every occurrence. targetId is a global target instance identifier, as provided by the UCH as element content of the <uiID> element in the UIList.
locatorId is an identifier of a target's locator, as given in a target description as value of the ‘id’ attribute on a <locator> element (see ISO/IEC 24752-4). A controller can find out about a target's locators and their identifiers by parsing the target description.
   Upon receipt of an Invoke Locator request, the UCH shall invoke the target's locator as specified. The UCH shall respond as follows:

HTTP/1.1 200 OK
Accept-Ranges: bytes
Content-Type: application/urc-http+xml; charset=utf-8
[blank line]
<locatorInvoked />

NOTE: This response message should not be construed as a confirmation that the locator was actually invoked on the target, since the UCH does not get a confirmation from the target either. The following HTTP status codes apply to a Invoke Locator response:

| HTTP status code | Use Cases |
|---|---|
| 200 OK | The request was successfully passed to the |
| | corresponding target, and invalid targetIds |
| | are ignored. |
| 301 Moved | The requested resource has been assigned a new |
| Permanently | permanent URI and any future references to this |
| | resource SHOULD use one of the returned URIs. |
| | May be used to redirect the client to either |
| | HTTP or HTTPS. |
| 400 Bad Request | The request body is encoded in a format that the |
| | server does not support. The XML body of the |
| | request is not well-formed. |
| 500 Internal Server | The server encountered an unexpected condition |
| Error | which prevented it from fulfilling the request. |
| 503 Service | The server is currently unable to handle the request. |
| Unavailable | |

### Get User Interface Info

A controller may request to get user interface information on a URC-HTTP based remote control URI, as follows:

GET /RUIAppPath?getInfo HTTP/1.1
HOST: hostname :hostport
User-Agent: OS/version Browser/version
[blank line]

Whereby:
hostname, hostport and RUIAppPath are parts of a remote control URI offering the URC-HTTP protocol (shortName=“URC-HTTP”).

Upon receipt of an Get UI Info request, the UCH shall respond as follows:

```
HTTP/1.1 200 OK
Accept-Ranges: bytes
Content-Type: application/urc-http+xml; charset=utf-8
[blank line]
  <ui>
    <uiID>targetId </uiID>
    <name>targetFriendlyName </name>
    <protocol shortName=“protocolShortName ”>
      <uri>remoteControlUri </uri>
      <protocolInfo>
        <targetName>targetName </targetName>
          <socketName friendlyName=“socketFriendlyName ”>socketName
</socketName>
        <socketDescriptionAt>SocketDescriptionURI </socketDescriptionAt>
        <targetDescriptionAt>TargetDescriptionURI </targetDescriptionAt>
          <conformsTo> http://myurc.org/TR/urc-http-protocol-20080814
</conformsTo>
      </protocolInfo>
    </protocol>
  </ui>
```

Whereby:
Format and placeholder restrictions apply.
Further restricting the format, the <protocol> element shall occur exactly once, providing information on the user interface being provided by IRUIAppPath.

The following HTTP status codes apply to a Get UI Info response:

| HTTP status | |
|---|---|
| code | Use Cases |
| 200 OK | The request was successful. |
| 301 Moved | The requested resource has been assigned a new permanent |
| Permanently | URI and any future references to this resource |
| | SHOULD use one of the returned URIs. |
| | May be used to redirect the client to either HTTP or |
| | HTTPS. |
| 500 Internal | The server encountered an unexpected condition which |
| Server Error | prevented it from fulfilling the request. |
| 503 Service | The server is currently unable to handle the request. |
| Unavailable | |

### In-Session Messages

### Open Session Request

A controller shall open a control session with a URC-HTTP based remote control URI with an Open Session request as POST or GET message:

```
POST /RUIAppPath?openSessionRequest HTTP/1.1
HOST: hostname :hostport
User-Agent: OS/version Browser/version
[blank line]
<openSessionRequest authorizationCode=“code ”>
  <includeResources>
    <resource forVal=“boolean ”
      role=“roleUri ”
      type=“type ”
      format=“mimetype ”
      forLang=“langcode ”
      creator=“creator ”
      publisher=“publisher ”
      date=“date ”
      audience=“audience ” />
  </includeResources>
</openSessionRequest>
Or:
GET /RUIAppPath?openSessionRequest HTTP/1.1
HOST: hostname :hostport
User-Agent: OS/version Browser/version
[blank line]
```

Whereby:
hostname, hostport and RUIAppPath are parts of a remote control URI, offering the URC-HTTP protocol (shortName=“URC-HTTP”).
<openSessionRequest> shall occur exactly once as root element. It may have an ‘authorizationCode’ attribute, with code being an authorization code for the open session request. NOTE: Implementations should employ a suitable encryption mechanism for transport (e.g. HTTPS with sufficient key length). Specific security techniques are out of scope for this standard.
<includeResources> may occur once in the body of the HTTP/HTTPS request. If it occurs, it specifies resource queries for atomic resources that the UCH shall send along together with socket element values in this session. If <includeResources> does not occur, the UCH shall not send resources together with socket element values in this session.
If present, <includeResources> shall contain one or more <resource> subelements, each specifying a resource query for the delivery of atomic resources. Note that the order of the <resource> subelements is significant since the UCH will provide resources in corresponding order.
   NOTE: Generic resources apply to a socket element in general. Value-specific resources apply only to specific values of a socket element.
Each <resource> element may have any of the following attributes (in any order):
   ‘forVal’ attribute, with boolean being “true” or “false” (default). It indicates whether the requested resource is a generic resource (“false”) or a value-specific resource (“true”). If value-specific, the pertaining value is the current value of the pertaining socket element.
   ‘role’ attribute, indicating the role of the requested resource, with roleUri as defined in ISO/IEC 24752-5, section 6.7.3.4 for <role>.
   ‘type’ attribute, indicating the type of the requested resource, with type as defined in ISO/IEC 24752-5, section 6.5 for <dc:type>.
   ‘format’ attribute, indicating the MIME type of the requested resource, with mimetype as defined in ISO/IEC 24752-5, section 6.6 for <dc:format>.
   ‘forLang’ attribute, indicating the language of the requested resource, with langcode as defined in ISO/IEC 24752-5, section 6.7.3.5 for <forLang>.
   ‘creator’ attribute, indicating the creator of the requested resource, with creator as defined in ISO/IEC 24752-5, section 6.8 for <dc:creator>.
   ‘publisher’ attribute, indicating the publisher of the requested resource, with publisher as defined in ISO/IEC 24752-5, section 6.9 for <dc:publisher>.
   ‘date’ attribute, indicating the date of the requested resource, with date as defined in ISO/IEC 24752-5, section 6.11 for <dc:date>.
   ‘audience’ attribute, indicating the audience for the requested resource, with audience as defined in ISO/IEC 24752-5, section 6.13 for <dcterms:audience>.
Any resource property not included as attribute of a <resource> element shall be unspecified in the resource query, i.e. their values do not matter for matching the query.
Exception: If an atomic resource has a target instance identifier attached, it shall only match a resource query if the session is connected to the specified target instance.

NOTE: The delivery of atomic resources through the URC-HTTP protocol provides a light-weight way for controllers to obtain labels and other resources. However, some controllers may require a retrieval mechanism that can accommodate for more complex resource queries. In this case it is recommended that the controller retrieve and parse resource sheets, obtained either from the target (through the target description, see 7) or from a resource server. Upon an Open Session request the UCH shall either accept, forward or reject the request. If accepted, the server shall send information on the opened session as follows:

```
HTTP/1.1 200 OK
Accept-Ranges: bytes
Content-Type: application/urc-http+xml; charset=utf-8
[blank line]
<sessionInfo>
  <session>SessionId</session>
  <updateChannel>
    <ipAddress>Address </ipAddress>
    <portNo>Port </portNo>
  </updateChannel>
</sessionInfo>
```

Whereby:
<sessionInfo> shall occur exactly once. SessionId is a server-generated string identifying the new session. SessionId shall not contain ‘>’ or ‘<’, nor any whitespace character or reserved character in URIs according to section 2.2 of RFC 3986. Character encoding restrictions apply.
   NOTE: The following are defined as “reserved characters” in RFC 3986‘:’, ‘/’, ‘?’, ‘#’, ‘[’, ‘]’, ‘@’, ‘!’, ‘$’, ‘&’, ‘′’, ‘(‘,’)’, ‘*’, ‘+’, ‘,’, ‘;’, ‘=’
A UCH may offer an “Update Channel” service to push updates to the connected controller. In this case, the controller may (after the Open Session Request) open a permanent TCP/IP connection (called “Update Channel”) with the server to receive update messages regarding the values of the UI Socket that it has a session with. The <updateChannel> element, which may be present, provides the client with the necessary information to open such a connection with the server. If present, the <updateChannel> element shall have the following subelements:
   One <ipAddress> element with Address as element content. Address is the IP address for the session-specific Update Channel.
   One <portNo> element with Port as element content. Port is the port number for the session-specific Update Channel.

Example: A UCH which provides an Update Channel service responds to an Open Session Request as follows:

```
HTTP/1.1 200 OK
Accept-Ranges: bytes
Content-Type: application/urc-http+xml; charset=utf-8
[blank line]
<sessionInfo>
  <session> xyz1234 </session>
  <updateChannel>
    <ipAddress>192.168.0.1</ipAddress>
    <portNo>8888</portNo>
  </updateChannel>
</sessionInfo>
```

In this example, the controller could open a session-specific Update Channel with the IP address 192.168.0.1 on port 8888. The controller would send the following string on the Update Channel, upon having established the TCP/IP based Update Channel connection:

```
<session>xyz1234</session>
EOF
The UCH may forward the Open Session request, by sending the
following response message:
HTTP/1.1 200 OK
Accept-Ranges: bytes
Content-Type: application/urc-http+xml; charset=utf-8
[blank line]
    <forward targetName=“targetName ”
    targetId=“targetId ”
socketName=“socketName ”
  authorizationCode=“authorizationCode ” />
```

Whereby:
The <forward> element shall occur as root element. It indicates a request from the target to open a new session with a different socket of the same or a different target. (In this case there has been no session created.)<forward> shall have a ‘targetName’, a ‘targetId’ and a ‘socketName’ attribute, and may have a ‘authorizationCode’ attribute, with the following meanings:
   targetName: Name (URI) of target that the controller is forwarded to. Corresponds to <targetName> element in UIList.
   targetId: global instance identifier of target that the controller is forwarded to. Corresponds to <uiID> element in UIList.
   socketName: Name (URI) of socket that the controller is forwarded to. Corresponds to <socketName> element content in UIList.
   authorizationCode: Any string to be used as authorization code, corresponding to the ‘authorizationCode’ attribute of the <openSessionRequest> element in an open session request.

In case the UCH forwards the Open Session request, the controller should send an Open Session request to the target/socket specified by targetId and socketName, with the authorization code authorizationCode, if available. NOTE: Typically, the new session will be opened through the URC-HTTP protocol. However, the controller may opt to use a different UI protocol, as available in the UIList for the specified target and socket.

If the UCH rejects the Open Session request, it shall respond with an error code as specified below. he following HTTP status codes apply to an Open Session response):

| HTTP status | |
|---|---|
| code | Use Cases |
| 200 OK | The request was successfully processed, by either creating |
| | a new session or forwarding to a different socket. |
| 400 Bad | The request body is encoded in a format that the server |
| Request | does not support. The XML body of the request |
| | is not well-formed. |
| 403 | The client is not authorized to open a new session. This |
| Forbidden | may occur for sockets that can only be opened by |
| | being forwarded from another session. |
| 500 Internal | The server encountered an unexpected condition which |
| Server Error | prevented it from fulfilling the request. |
| 503 Service | The open session request was rejected. |
| Unavailable | |

NOTE: After successful opening a session with a UCH, a controller should send a Get Values request to retrieve the initial values of the UI Socket. It may use the “root path” in this request to retrieve all values in one response. However, a more selective approach may be chosen if the UI Socket contains a great amount of data.

### Close Session Request

Having an open session with a remote control URI, a controller can request to close an existing session with the UCH as follows:

GET /RUIAppPath?closeSessionRequest&session=SessionId HTTP/1.1
HOST: hostname :hostport
User-Agent: OS/version Browser/version
[blank line]

### Whereby:

hostname, hostport and RUIAppPath are parts of a remote control URI offering the URC-HTTP protocol (shortName=“URC-HTTP”) for the UCH.
SessionId is the session identifier as contained in the response on the Open Session request.

NOTE: When using cookies for session management, a controller has to include the server-provided cookie in the above HTTP/HTTPS request. When using URL rewriting, a controller has to append “&session=sessionId” to the path in the first line of the above HTTP/HTTPS request, resulting in a complete path of “IRUIAppPath?closeSessionRequest&session=sessionId”.

If it accepts the request, the UCH shall respond as follows:

HTTP/1.1 200 OK
Accept-Ranges: bytes
[blank line]
<sessionClosed />

The following HTTP status codes apply to a Close Session response:

| HTTP status code | Use Cases |
|---|---|
| 200 OK | The request was successfully processed and |
| | the session closed. |
| 403 Forbidden | The client is not authorized to close the |
| | specified session. |
| 404 Not Found | Invalid session identifier. |
| 500 Internal Server Error | The server encountered an unexpected |
| | condition which prevented it from fulfilling |
| | the request. |
| 503 Service Unavailable | The session could not be closed. |

### Get Values

Having an open session with a remote control URI, a controller can request the values of UI Socket elements (or components thereof) or available index values as follows:

```
POST /RUIAppPath?getValues&session=SessionId HTTP/1.1
HOST: hostname :hostport
User-Agent: OS/version Browser/version
[blank line]
<getValues>
  <get ref=“path ” />
  <getIndex ref=“elementId ” index=“indexNo ” />
</getValues>
```

Whereby:
hostname, hostport and RUIAppPath are parts of a remote control URI offering the URC-HTTP protocol (shortName=“URC-HTTP”).
SessionId is the session identifier as contained in the response on the Open Session request.
The request shall include as body one non-empty <getValues> element.
The <get> element may occur as subelement of <getValues> any number of times, to request the current paths and values of socket elements and, if indicated by the ‘includeSets’ attribute, the current paths of socket sets. There shall be no two <get> elements with identical ‘ref’ attribute values.
   <get> shall have a ‘ref’ attribute, with path referencing a Socket element or set (or a component thereof), in one of the following path forms: root path, path without indices, shortcut path, path with given indices, path with empty indices, path with range of indices, path for command state, path for command timeToComplete, path for local command parameter, path for partial XML content. Character encoding restrictions apply.
The <getIndex> element may occur as subelement of <getValues> any number of times, to request the available values for a particular index of a dimensional socket element or set, as specified by the ‘ref’ and ‘index’ attributes. There shall be no two <getIndex> elements with identical values for both ‘ref and ‘index’ attributes.
   <getIndex> shall have a ‘ref’ attribute, with elementId bearing the XML identifier ('id’ attribute) of a dimensional Socket element or set.
   <getIndex> shall have a ‘index’ attribute, with indexNo specifying the O-based index number (i.e. “0” denotes the first index, “1” the second, etc.). Note that this number refers to the dimensions of a single Socket element or set, not to its path (i.e. indices of dimensional ancestor sets do not count here).
   Example: A set with id=“set” and dim=“xsd:integer xsd:string” has two indices.
   <getIndex ref=“set” index=“1” I> would request the available values for the second index (which is of type xsd:string).

Upon a processed Get Values request, the UCH shall respond by transmitting the values of all Socket elements (and components thereof) that were specified in the client's request. If the request contains a reference to the UI Socket itself (root path), subordinate socket elements and components thereof shall be included in the server's response. If the request contains a set or set component, the values of all current socket elements and element components underneath the specified set (or set component) shall be included in the response.

### The UCH Shall Respond as Follows:

```
HTTP/1.1 200 OK
Accept-Ranges: bytes
Content-Type: application/urc-http+xml; charset=utf-8
  [blank line]
<values>
  <value ref=“path ”>value
    <resource />
    <resource>resource </resource>
    <resource at=“resourceUri ” />
  </value>
  <index ref=“elementId ” indexNo=“indexNo ”>
    <indexValue>indexValue
      <resource />
      <resource>resource </resource>
      <resource at=“resourceUri ” />
    </indexValue>
  </index>
</values>
```

Whereby:
The <values> element shall occur exactly once.
A <value> element may occur multiple times within <values> for transmitting the values of multiple UI Socket elements. However, there shall be no two instances referencing the same path.
   A <value> element shall have a ‘ref’ attribute, with path being a reference to a Socket element/set (or a component thereof), in any of the following forms: path without indices, path with given indices, path for command state, path for command timeToComplete, path for local command parameter, path for partial XML content. Character encoding restrictions apply.
NOTE: If a Get Values Request contains an invalid path, the UCH should ignore the corresponding <get> element (return with code 200).
value is the value of the UI Socket element (or a component thereof), as string representation. For variables, this is their value, as string representation. For commands, this is their state (e.g. “ready”, “done”) or timeToComplete field (only for commands of type timedCommand). For notifications, this is their state (“active”, “inactive”). Character encoding restrictions apply.
If the controller requested resource delivery upon opening the session, a <value> element shall have one or more <resource> subelements, each specifying a matching atomic resource (if available), pertaining to the socket element referenced by the containing <value> element.
   The list of <resource> subelements shall exactly reflect the list of resource queries (<resource> subelements of <includeResources>) submitted by the controller as part of the Open Session request, in size and order. If no resource is available for a particular resource query of the Open Session request, this shall be specified as an empty <resource> element (coded as “<resource />”).
   An available atomic resource shall be specified either as element content of the <resource> subelement (resource) or as the value (resourceUri) of an ‘at’ attribute of <resource> which may occur. resourceUri shall be a resolvable URI to the resource content.
      NOTE: The ‘at’ attribute is especially useful for binary resources.
An <index> element may occur multiple times within <values>, each one for one <getIndex> request from the client. Each <index> element shall have a ‘ref’ attribute, with elementId and indexNo as specified in the client's request.
   Each <index> element may have any number of <indexValue> subelements, each specifying one available index value as element content indexValue. Character encoding restrictions apply.
   If the controller requested resource delivery upon opening the session, each <indexValue> element shall have one or more <resource> subelements, each specifying a matching atomic resource (if available), pertaining to the index value specified by the containing <indexValue> element. The same restrictions apply as for the <resource> subelements of <value>, see above.
      NOTE: Resources that apply to Socket-defined types have an element reference (property http://myurc.org/ns/res#eltRef) of the following format: socketName#typeld, withsocketName being the name (URI) of the socket, andtypeld being the value of the ‘id’ attribute on the type definition. For resources that apply to Socket-external types, the format is: namespaceUri#typeName, with namespaceUri being the identifier (not prefix) of the namespace, and typeName being the value of the ‘name’ attribute on the type definition.

Unavailable socket elements: There is no special message for inquiring about the availability of socket elements (see ‘optional’ attribute on variables and commands in ISO/IEC 24752-2). The UCH shall send the “undefined value” for any variable or command that is not available in the session. NOTE: If a variable's value or command's state is undefined, either the socket element (variable or command) is not available in the session (see ‘optional’ attribute on variables on commands, ISO/IEC 24752-2), or the value/state is temporarily undefined. Controllers should not include socket elements in the user interface whose value/state is undefined (see ISO/IEC 24752-1). The following HTTP status codes apply to a Get Values response:

| HTTP status code | Use Cases |
|---|---|
| 200 OK | The request was successfully processed. If the request |
| | contained invalid path references, they were |
| | ignored by the server. |
| 400 Bad Request | The request body is encoded in a format that the |
| | server does not support. The XML body of |
| | the request is not well-formed. |
| 403 Forbidden | The client is not authorized to get values |
| | pertaining to the specified session. |
| 404 Not Found | Invalid session identifier. |
| 500 Internal | The server encountered an unexpected condition which |
| Server Error | prevented it from fulfilling the request. |
| 503 Service | The server is currently unable to handle the request. |
| Unavailable | |

### Get Updates

Having an open session with a remote control URI, a controller can request an update of selected UI Socket values, as follows:

```
GET /RUIAppPath?getUpdates&session=SessionId HTTP/1.1
HOST: hostname :hostport
User-Agent: OS/version Browser/version
  [blank line]
<getUpdates>
  <get ref=“path ” />
</getUpdates>
```

Whereby:
hostname, hostport and RUIAppPath are parts of a remote control URI offering the URC-HTTP protocol (shortName=“URC-HTTP”).
SessionId is the session identifier as contained in the response on the Open Session request.
The request shall include as body one <getUpdates> element, containing one or multiple <get> elements, each with a mandatory ‘ref’ attribute. However, there shall be no two <get> elements with the same path.
path shall reference a UI Socket element or set, in any of the following forms: root path, path without indices, shortcut path, path with given indices, path with empty indices, path with range of indices, path for command state, path for command timeToComplete, path for local command parameter, path for partial XML content. Character encoding restrictions apply.

If a Get Updates Request contains an invalid path, the UCH should ignore the corresponding <get> element (still return with code 200).

Upon a processed Get Updates request, the UCH shall respond by transmitting the values of the specified subset of UI Socket elements, as follows. The response shall contain the values of those UI Socket elements that were specified in the client's Get Updates request body, and have changed since the last Get Element Updates request (or since the Open Session request if no Get Element Updates request has occurred yet) for the pertaining session. If the request contained a reference to the UI Socket itself (root path), all socket elements and element components of the UI Socket shall be deemed as specified. If the request contained a set or set component, the values of all current socket elements and element components underneath the specified set (or set component) shall be deemed as specified. The server's Get Updates response shall not include those UI Socket elements whose updated value has already been propagated to the controller by the response to a previous Set Values request.

```
HTTP/1.1 200 OK
Accept-Ranges: bytes
Content-Type: application/urc-http+xml; charset=utf-8
[blank line]
<updates>
  <add ref=“addPath”>value
    <resource />
    <resource> resource </resource>
    <resource at=“resourceUri ” />
  </add>
  <remove ref=“removePath” />
  <value ref=“path ”>value
    <resource />
    <resource> resource </resource>
    <resource at=“resourceUri” />
  </value>
  <forward type=“forwardType ”
    targetName=“targetName” targetId=“targetId”
    socketName=“socketName”
    authorizationCode=“authorizationCode” />
  <abortSession> message </abortSession>
</updates>
```

Whereby:
The <updates> element shall occur exactly once (and may be empty).
The <add> element may occur any number of times (however, instances shall differ in their attribute values). Each occurrence indicates that the target has added an actual index combination for a dimensional element or set. It shall have a ‘ref’ attribute, and addPath shall reference a socket element's or set's component, and shall be of the following form: path with given indices. If it references an element component (not set component), an initial value of the socket element's component shall be provided as element content (value).
   NOTE: It is recommended (but not required) that a response message with an <add> element also contain (subsequently) the actual value(s) of the element component(s) that were created as a result of the new index combination.
The <remove> element may occur any number of times (however, instances shall differ in their attribute values). Each occurrence indicates that the target has removed an actual index combination for a dimensional element or set. It shall have a ‘ref attribute, and removePath shall reference a dimensional set or element be of one of the following forms: path with given indices, path with empty indices, path with range of indices.
The <value> element may occur any number of times (however, instances shall differ in their attribute values). Each occurrence indicates that an element has been assigned a new value. It shall have a ‘ref’ attribute; path is a reference to a Socket element (or component thereof), which may take one of the following forms: path without indices, path with given indices, path for command state, path for command timeToComplete, path for local command parameter, path for partial XML content. Character encoding restrictions apply.
value is the value of the UI Socket element (or a component thereof), as string representation. For variables, this is their value, as string representation. For commands, this is their state (e.g. “ready”, “done”) or timeToComplete field (only for commands of type timedCommand). For notifications, this is their state (“active”, “inactive”). Character encoding restrictions apply.
If the controller requested resource delivery upon opening the session, a <value> element shall have one or more <resource> subelements, each specifying a matching atomic resource (if available), pertaining to the socket element referenced by the containing <value> element.
   The list of <resource> subelements shall exactly reflect the list of resource queries (<resource> subelements of <includeResources>) submitted by the controller as part of the Open Session request, in size and order. If no resource is available for a particular resource query of the Open Session request, this shall be specified as an empty <resource> element (coded as “<resource I>”).
   An available atomic resource shall be specified either as element content of the <resource> subelement (resource) or as the value (resourceUri) of an ‘at’ attribute of <resource> which may occur. resourceUri shall be a resolvable URI to the resource content.
A <forward> element may occur any number of times, with the following additional requirements: (1) instances shall differ in their attribute values, and (2) no <add>, <remove> or <value> elements shall follow a <forward> element with type=“D” within <updates>. Each occurrence of <forward> indicates a request from the target to open another session with a different socket of the same or a different target. It shall have a ‘type’, a ‘targetName’, a ‘targetId’ and a ‘socketName’ attribute, and may have an ‘authorizationCode’ attribute, with the following meanings:
   type: Type of forward request. “D”=destructive forward request, “S”=spawn request.
   targetName: Name (URI) of target that the controller is forwarded to. Corresponds to <targetName> element in UIList.
   targetId: global instance identifier of target that the controller is forwarded to. Corresponds to <uiID> element in UIList.
   socketName: Name (URI) of socket that the controller is forwarded to. Corresponds to <socketName> element content in UIList.
   authorizationCode: Any string to be used as authorization code, corresponding to the ‘authorizationCode’ attribute of the <openSessionRequest> element in an open session request.
An <abortSession> element may occur once as the last element of <updates>. It indicates that the session has been aborted by the target. <abortSession> may have an element content message, providing a free-text description of the problem that occurred.
   The UCH shall respond with an empty <updates> element if no update item is available, as in the following example:

HTTP/1.1 200 OK
Accept-Ranges: bytes
Content-Type: application/urc-http+xml; charset=utf-8
[blank line]
<updates />

Commands of type basicCommand or timedCommand: A UCH indicates the continuing execution or return of a command invocation by propagating a state (value) change for a “path for command state”. Possible values for state are:

“initial”: initial command state before any execution.

“rejected”: command execution has been rejected

“in Progress”: command is still running

“done”: command concluded

“succeeded”: command concluded successfully

“failed”: command concluded, but there was a failure

In the case of the conclusion of a command, the command's new state, and its local and global output parameters shall be included in one and the same “Get Updates” response; the values of its output parameters shall immediately follow the <value> element with the command's path.

Notifications: A UCH indicates the throwing of a notification by propagating a value change of the corresponding notification element from “inactive” to “active”. It indicates a removal of a notification by propagating a change from “active” to “inactive”.

Undefined value: If a variable's value or command's state changes from a defined value to the “undefined value”, the UCH shall send a Get Updates response with the “undefined value” of the variable/command. The UCH shall not include socket elements in a Get Updates response that are unavailable (see ‘optional’ attribute on socket elements in ISO/IEC 24752-2).

Session forwarding: In case of a spawn forward request, the controller should open a new session (8.3.1) with the target specified by targetId, and the socket specified by socketName, with the authorization code authorizationCode, if available. In case of a destructive forward request, the controller shall close the current session prior to opening the new session.

NOTE: Typically, the new session will be opened through the URC-HTTP protocol. However, the controller may opt to use a different UI protocol, as available in the UIList for the specified target and socket.

Session abortion: In case of a session abort event by the target, the controller shall not send any additional requests to the UCH pertaining to this session. In particular, it shall not send a Close Session request.

NOTE: A target that wants to close the session with a client, and forward it to a different socket, could use <forward type=“D” . . . > and <abortSession> (in this order) in one Get Updates response.

Update mechanism: A controller can choose whether it wants to receive updates through repeated Get Update requests (i.e. polling) or by opening a TCP/IP Update Channel and subsequently receiving updates through that channel. However, once a client has opened a TCP/IP connection for receiving updates, the UCH shall send updates (including all that have accumulated before the Update Channel was opened) through the Update Channel only, and may not provide update information through Get Update requests any more.

Session expiration: A controller shall send a Get Updates request to the server at least every 5 minutes, unless it has opened an Update Channel connection with the server. A UCH may dispose a session with a client if it has not received a Get Updates message for more than 10 minutes and has no Update Channel connection with the client. The following HTTP status codes apply to a Get Updates response:

| HTTP status code | Use Cases |
|---|---|
| 200 OK | The request was successfully processed. If the |
| | request contained invalid path references, |
| | they were ignored by the server. |
| 400 Bad Request | The request body is encoded in a format that |
| | the server does not support. The XML body of |
| | the request is not well-formed. |
| 403 Forbidden | The client is not authorized to get updates |
| | pertaining to the specified session. |
| 404 Not Found | Invalid session identifier. |
| 500 Internal Server | The server encountered an unexpected condition |
| Error | which prevented it from fulfilling the request. |
| 503 Service | The server is currently unable to handle the request. |
| Unavailable | |

### Set Values

Having an open session with a remote control URI, a controller can request to change the target's state by setting the values of one or multiple variables (or components thereof), invoking commands (or components thereof), acknowledging notifications (or components thereof), and/or adding or removing actual indices of dimensional elements or sets, as follows:

POST /RUIAppPath?setValues&session=SessionId HTTP/1.1
HOST: hostname :hostport
User-Agent: OS/version Browser/version
[blank line]
<setValues>
<set ref=“varPath ”>value </set>
<set ref=“parPath ”>value </set>
<invoke ref=“cmdPath ”>invokeMode </invoke>
<ack ref=“notifyPath ” />
<add ref=“addPath ”>initValue </add>
<remove ref=“removePath ” />
</setValues>

Whereby:
hostname, hostport and RUIAppPath are parts of a remote control URI offering the URC-HTTP protocol (shortName=“URC-HTTP”), see 7.1.
SessionId is the session identifier as contained in the response on the Open Session request.

The <set> element may occur multiple times within <setValues> for requesting changes of multiple UI Socket elements. There may be multiple <set>, <invoke>, <ack>, <add> or <remove> subelements under <setValues>.
A <set> subelement may occur any number of times under <setValues>, indicating a request for setting the value of a UI Socket variable or local command parameter (or a component thereof), with value being the requested new value. varPath shall reference a UI Socket variable (or a component thereof), parPath a local command parameter (or a component thereof). varPath may take any of the following forms: path without indices, shortcut path, path with given indices, path for partial XML content (only with an xmlPath of “id(nodeId)”). parPath may take any of the following forms: path for local command parameter. Character encoding restrictions apply for varPath, parPath and value.
   NOTE: The request for setting the value of a Socket element is deemed successful (return code 200) if processed by the server, even if it rejects the new value. In this case the response message does not include the path of the element (since its value did not change).
   NOTE: A controller shall not request to change the value of a variable whose current value is “undefined” (see ISO/IEC 24752-1).
   NOTE: A controller is not allowed to change the content of atomic resources for a socket element, not even for socket elements with dynamic resources.
An <invoke> subelement may occur any number of times under <setValues>, indicating a request for invoking a UI Socket command (or a component thereof), with invokeMode being either “syn” (for synchronous call mode, i.e. the request will return when the execution has finished) or “asyn” (for asynchronous call mode, i.e. the request may immediately return). cmdPath shall reference a UI Socket command (or component thereof), and may take one of the following forms: path without indices, shortcut path, path with given indices. Character encoding restrictions apply for cmdPath and invokeMode. See also paragraph on “Command invocation” below.
   NOTE: The request for invoking a Socket command is deemed successful (return code 200) if processed by the server, even if it rejects the actual invocation. In this case the response message does not include the path of the command's state (since it did not change).
An <ack> subelement may occur any number of times under <setValues>, indicating an acknowledgment of a UI Socket notification (or a component thereof). A target interprets an acknowledgment as request for withdrawal of the notification. notifyPath shall reference a UI Socket notification (or component thereof), and may take one of the following forms: path without indices, shortcut path, path with given indices. Character encoding restrictions apply for notifyPath. See also paragraph on “Notification acknowledgment” below.
   NOTE: The request for acknowledging a Socket notification is deemed successful (return code 200) if processed by the server, even if it does not retract the notification. In this case the response message does not include the path of the notification (since its state did not change).
An <add> subelement may occur any number of times under <setValues>, indicating a request for adding a new actual index combination for a dimensional UI Socket element or set. addPath shall reference a UI Socket element or set, in the following form: path with given indices. If addPath specifies a socket element, initValue shall be provided as the proposed initial value of the resulting new element component. For a variable (component), this is its requested new value as string representation. For command and notification components initValue shall be empty. If path specifies a socket set, initValue shall be empty. Character encoding restrictions apply.
A <remove> subelement may occur any number of times under <setValues>, indicating a request for removal of one or multiple actual indices for a dimensional UI Socket element or set. removePath shall reference a UI Socket element or set, in one of the following forms: path with given indices, path with empty indices, path with range of indices. Character encoding restrictions apply.
   NOTE: The “path with empty indices” and “path with range of indices” forms can be used to request pruning of multiple components (i.e. request removal of a “slice” of the overall components).

The UCH shall process the individual requests (i.e. <set> elements) in the order as submitted. NOTE: If a Set Value Request contains an invalid path, the UCH should ignore the corresponding <set> element (still return with code 200). Upon a processed Set Values request, the UCH shall respond by transmitting those values (and indices) that have changed based on the Set Values request. Note that the UCH may or may not set the value of a UI Socket element (component) as requested, or may even set it to a different value because of side effects.

```
HTTP/1.1 200 OK
Accept-Ranges: bytes
Content-Type: application/urc-http+xml; charset=utf-8
[blank line]
<updates>
  <add ref=“addPath ”>value
    <resource />
    <resource> resource </resource>
    <resource at=“resourceUri ” />
  </add>
  <remove ref=“removePath ” />
  <value ref=“eltPath ” >value
    <resource />
    <resource> resource </resource>
    <resource at=“resourceUri ” />
  </value>
</updates>
```

Whereby:
The response body shall contain exactly one <updates> element (which may be empty).
One or multiple <add> elements may occur, with restrictions as specified for the <add> element in a Get Updates response.
One or multiple <remove> elements may occur, with restrictions as specified for the <remove> element in a Get Updates response.
A <value> element may occur multiple times within <updates> for transmitting the values of multiple UI Socket elements (or components thereof) that have changed based on the Set Values request. Note that, in order to avoid duplicate update messages, the UCH shall not send Update Events for those UI Socket elements (or components thereof). eltPath shall reference a UI Socket element (or a component thereof), and may take one of the following forms: path without indices, path with given indices, path for command state, path for command timeToComplete, path for local command parameter, path for partial XML content (only with an xmlPath of “id(nodeId)”). Character encoding restrictions apply for eltPath and value.

Command invocation: If the command has local parameters, these shall be included (in the path form “path for local command parameter”) as separate <set> elements inside <setValues> that immediately precede the <set> element for the invoke command request. Global parameters may be included as preceding <set> elements—if their values is requested to change. Also, this request may contain new value requests for other variables. The response message to a synchronous command invocation request shall contain updated values of the local and global output parameters of the command, if any. For asynchronous command invocation, the Set Values response message shall have an empty <updates> element (since the request returns before the execution of the command has finished). The UCH shall notify the controller about any updated values of the command's local and global output parameters by a subsequent Update Event or Get Updates request.

Notification acknowledgment: The controller acknowledges a notification by sending a Set Values request to the UCH, containing the element id of the corresponding notification element (component), and a new requested value of “inactive”. This request may contain new value request for other variables, but shall not reference other notification elements (or components thereof). In other words, no two notifications can be acknowledged within one HTTP/HTTPS request. The following HTTP status codes apply to a Set Values response:

| HTTP status | |
|---|---|
| code | Use Cases |
| 200 OK | The request was successfully processed. If the request |
| | contained invalid path references, they were ignored |
| | by the server. Also, the target may have rejected some |
| | or all of the requested values. |
| 400 Bad Request | The request body is encoded in a format that the |
| | server does not support. The XML body of the |
| | request is not well-formed. |
| 403 Forbidden | The client is not authorized to set values pertaining |
| | to the specified session. |
| 404 Not Found | Invalid session identifier. |
| 500 Internal | The server encountered an unexpected condition |
| Server Error | which prevented it from fulfilling the request. |
| 503 Service | The server is currently unable to handle the request. |
| Unavailable | |

Get Resources (In-Session)

Having an open session with a remote control URI, a controller may query a list of static or dynamic atomic resources from a UCH, while in a session, as follows:

```
POST RUIAppPath?GetResources&session=SessionId HTTP/1.1
HOST: hostname:hostport
User-Agent: OS/version Browser/version
[blank line]
<getResources>
  <resource
      eltRef=“eltRef ”
      valRef=“value ”
      opRef=“opUri ”
      role=“roleUri ”
      type=“type ”
      format=“mimetype ”
      forLang=“langcode ”
      forTargetInstance=“targetId ”
      creator=“creator ”
      publisher=“publisher ”
      date=“date ”
      audience=“audience ” />
</getResources>
```

Whereby:
hostname, hostport and RUIAppPath are parts of a remote control URI offering the URC-HTTP protocol (shortName=“URC-HTTP”).
SessionId is the session identifier as contained in the response on the Open Session request.

Other parameters as specified for the out-of-session message Get Resources.

NOTE: The difference between the out-of-session and in-session versions of Get Resources is that the in-session version includes dynamic resources, if provided by the target. Dynamic resources are session specific, and can only be obtained through URC-HTTP if a session is open with the corresponding target. Controllers should use the in-session version when requesting resources during a session, in order to have dynamic resources automatically included in the response, Upon a processed Get Resources request, the UCH shall respond by transmitting the requested static and dynamic atomic resources, if available.

### Update Channel

A UCH shall implement a “push mechanism” to send Update Events to the controller through a permanent TCP/IP socket connection (called “Update Channel”). A controller may open such a TCP/IP connection after it has received the connection specific parameters in an Open Session Request response. Note that a controller is not obliged to open the Update Channel. It may opt to get updates through repeated Get Updates requests (polling) instead.

### Opening the Update Channel

A controller may open an Update Channel to the UCH, using the given IP address and port number contained in the Open Session Request response from the UCH. Upon successful opening of the Update Channel, the controller shall send the following to the UCH through the Update Channel.

<session>sessionId </session>
EOF

Whereby:
sessionId is the sessionId contained in the Open Session Request response from the UCH.
If sessionId is empty, the client shall still send the EOF character.

### Update Events

If a controller has opened an Update Channel with a UCH, the UCH shall send Update Events for one or multiple UI Socket elements (or components thereof) that have changed, through the Update Channel in the following format:

```
<updates>
  <add ref=“addPath ”>value
    <resource />
    <resource> resource </resource>
    <resource at=“resourceUri ” />
  </add>
  <remove ref=“removePath ” />
  <value ref=“path ”>value
    <resource />
    <resource> resource </resource>
    <resource at=“resourceUri ” />
  </value>
  <forward type=“forwardType ”
    targetId=“targetId ” socketName=“socketName ”
    authorizationCode=“authorizationCode ” />
  <abortSession> message </abortSession>
</updates>
EOF
```

Whereby the same rules and restrictions (except for session expiration) apply as for the Get Updates response message.

The UCH may send an empty Update Event as follows:

<updates />
EOF

Session expiration: The controller shall acknowledge Update Events at most 30 seconds after an Update Event was sent, with the following message through the Update Channel:

<ackUpdates />
EOF

The UCH may send empty Update Events on the Update channel to check if the client is still connected. At any time during a session, if the client does not acknowledge an Update Event nor any subsequent Update Event 30 seconds from the first Update Event, the UCH may dispose the session with the controller, and close the Update Channel with it.

### Session Management

A UCH shall support URL rewriting for session management. It may support Cookies as an alternate means for session management. The controller shall use URL rewriting (as specified in this document) when making session-specific HTTP/HTTPS requests (i.e. all HTTP/HTTPS requests except the Open Session request). The UCH may dispose existing sessions at any time, based on timeout or resource usage limits. If a message from the client pertains to an expired session, the Server shall respond with HTTP status code 404 Not Found, as follows:

HTTP/1.1 404 Not Found
Accept-Ranges: bytes

### URL Rewriting

A controller shall use URL rewriting in all HTTP/HTTPS requests following an Open Session request. the controller shall append “&session=SessionId” to the path of every HTTP/HTTPS request to the UCH, following a successful Open Session request. Whereby sessionId is the session identifier given by the UCH as content of <session> in its response to an Open Session request. For example, the controller would make a subsequent Get Element Values request as follows, given a sessionId of “xyz1234”:

POST /RUIAppPath?getElementValues&session=xyz1234 HTTP/1.1
HOST: 192.168.0.1:8888
User-Agent: OS/version Browser/version
[blank line]
<getValues refs=“pathList” />

### Cookies

Cookies may be used in any of the HTTP/HTTPS requests to maintain state information between the UCH and controller. A UCH may respond to a controller's Open Session request with a response including cookie information, if accepted. See IETF RFC 2109. For example, a UCH's response to an Open Session request may be as follows:

```
HTTP/1.1 200 OK
Accept-Ranges: bytes
Content-Type: application/urc-http+xml; charset=utf-8
Set-Cookie: session=xyz1234
[blank line]
<sessionInfo>
  <session>xyz1234</session>
  <updateChannel>
    <ipAddress>192.168.0.1</ipAddress>
    <portNo>8888</portNo>
  </updateChannel>
</sessionInfo>
```

NOTE: This is just an example and is not intended to constrain the format of the Set-Cookie header used by the UCH. A controller that has received a Set-Cookie header, may include its value with the Cookie header for any subsequent HTTP/HTTPS request to the same UCH, as specified in IETF RFC 2109 [REF]. For example, the controller could make a subsequent Get Values request as follows:

POST /RUIAppPath?getElementValues&session=xyz1234 HTTP/1.1
HOST: 192.168.0.1:8888
User-Agent: OS/version Browser/version
Cookie: session=xyz1234
[blank line]
<getValues refs=“pathList” />

NOTE: The controller is still required to use URL rewriting in any request, i.e. include the session identifier in the URL of the request.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for allowing device control and access to digital content through pluggable user interfaces, comprising:
a resource server that includes
a database of resource and user information; and
logic for matching an individual with a pluggable user interface that the individual can then use as their personal interface to control one or more devices.

2. The system of claim 1, wherein
the database includes pre-defined property names and corresponding descriptor names stored in the database as records, and wherein
each record identifies whether a property and pertaining descriptors are mandatory, recommended, or optional, for a certain resource type.

3. The system of claim 2, wherein the database stored information according to a resource property vocabulary.

4. The system of claim 1, wherein changes on resources with their versions, access rights and properties can be stored in the database, with a timestamp of the change and the user making the change.

5. The system of claim 1, wherein each user can have exactly associated publisher URL.

6. The system of claim 1, wherein the resource server automatically generates the resource name upon creation of a resource.

7. The system of claim 6, wherein the resource server uses the timestamp of upload as the version name.

8. The system of claim 1, wherein the resource server automatically assigns the publisher URI of the uploader.

9. The system of claim 1, wherein a resource is immediately created and edited on the resource server with no need to store the resource locally on the author's computer.

10. The system of claim 1, wherein the system includes a resource development environment.

11. The system of claim 10, wherein based on a resource matching algorithm, the resource server guides the author in assigning an appropriate set of properties and descriptors for the resource, including alerting the author to other resources that have a similar set of values for properties and descriptors, and suggest additional properties and descriptors to differentiate that resource from others.

12. The system of claim 10, wherein the resource development environment provides a graphical editor for socket descriptions and pertaining resource sheets, and while editing, the resource server check against syntactical and semantic rules for socket descriptions and resource sheets, and alerts the user in case of any violation.

13. The system of claim 10, wherein when designing a UIPM or UIPM client based on an existing UI socket description, the resource development environment can support the user in generating an initial simple design draft, and can allow the author to pick from a list of available UI socket elements when connecting the UI elements to socket elements.

14. The system of claim 10, wherein when designing a UIPM or UIPM client for a socket description that does not exist yet, the resource development environment automatically generates an initial UI socket description based on the UI elements the author has created.

15. A method for allowing device control and access to digital content through pluggable user interfaces, comprising the steps of:
providing a resource server that includes
a database of resource and user information; and
logic for matching an individual with a pluggable user interface that the individual can then use as their personal interface to control one or more devices.
